(19) United States
(12) Patent Application Publication
(10) Pub. No.: US 2009/0282663 A1
(43) Pub. Date: Nov. 19, 2009

(54) Furniture Assembly

(76) Inventors: Kirt Martin, Alto, MI (US); David C. Eberlein, Hudsonville, MI (US); Daniel Edward Waugh, Grand Rapids, MI (US)

Correspondence Address: QUARLES & BRADY LLP, 411 E. WISCONSIN AVENUE, SUITE 2040, MILWAUKEE, WI, 53202-4497, US

(21) Appl. No.: 12/128,217

(22) Filed: May 28, 2008

Related U.S. Application Data
(60) Provisional application No. 60/941,525, filed on Jun. 1, 2007.
(60) Provisional application No. 60/941,535, filed on Jun. 1, 2007.

(51) Int. Cl. B25B 27/14

(52) U.S. Cl. 29/281.5

(57) ABSTRACT

A furniture assembly kit including at least a first support structure, a plurality of furniture components, each component including a base structure having a component width dimension and a component length dimension, a sub-structure supported by the support structure and having a substantially flat support surface defined by a circumferential edge including first and second lateral edges, the sub-structure forming a lip member along at least portions of the first and second lateral edges, the lip member having a distal upper edge, the space adjacent the support surface and between the lip members being a furniture receiving space and wherein different subsets of the plurality of components can optionally be positioned with the base structures supported by the support surface and with the base structures of the component subsets substantially covering the sub-structure support surface, each different subset including at least two of the plurality of components where at least one of the furniture components includes a storage unit that defines a storage space where the storage space resides at least in part above the furniture receiving space when the storage unit is supported on the support surface.

### CROSS-REFERENCE TO RELATED APPLICATIONS

This patent application is related to and claims priority to U.S. provisional patent application No. 60/941,525 that was filed on Jun. 1, 2007 and that is titled “Work Space Arrangements Including Counter Assembly”. This patent is also related to and claims priority to U.S. provisional patent application No. 60/941,535 that was filed on Jun. 1, 2007 and that is titled “Storage Unit With Sliding Doors”.

### STATEMENT REGARDING FEDERALLY SPONSORED RESEARCH OR DEVELOPMENT

Not applicable.

### BACKGROUND OF THE INVENTION

The present invention relates to furniture assemblies and more specifically to a furniture assembly kit that include components that can be combined in different subsets to provide different useful furniture arrangements as well as special grommets, receptacle clip assemblies and door mounting assemblies that are particularly useful for assembling furniture configurations.

Many different types of office space dividing systems have been developed that, as the label implies, divide up large office spaces into smaller spaces for individual or small group use. For instance, some exemplary systems include wall panel assemblies that form wall structures to divide spaces. Wall structure size can be changed by adding or taking away frame and panel modules. Where a panel wall assembly is provided, in many cases the panel assembly includes couplers so that work surfaces, storage units (e.g., cabinets, shelving units, closets, etc.) and other accessory can be mounted thereto. In addition, panel assemblies often form internal wire management channels for distributing power and data cables throughout a work space. As another instance, other exemplary systems may include a counter height table assembly or bookcase unit that can be positioned between two spaces to separate one space from the other. Here, storage units, work surfaces, cable troughs and other accessories are often provided that can be mounted directly to the table assemblies to provide other useful features.

While existing space dividing systems have proven useful, known dividing systems have several shortcomings. First, many known space dividing systems have relatively complex and expensive accessory mounting fasteners or couplers. In the case of a storage cabinet mounted to a panel wall assembly, the storage cabinets are often mounted to a side surface of the panel wall or along a top edge of the panel wall. Here, storage units are often heavy (especially when loaded with materials—e.g., papers, books, etc.) and therefore robust mechanical couplers/fasteners are often required to ensure that the storage units are stably supported at elevated locations. In addition, to ensure that storage units do not become inadvertently disconnected from the wall assemblies, couplers are often equipped with locking mechanisms which further complicate the components. Similarly, in the case of a counter height table assembly or the like, mounting subassemblies for storage units, work surfaces and other accessories are often complex and therefore costly.

Second, many space dividing systems require a large number of components (e.g., hundreds) to optionally build many different configurations. For example, in the case of a cabinet including sliding doors that can optionally close off an open side, in addition to the door members, configurations often require upper and lower tracks and track fasteners where the tracks each form guide slots. In many configurations the upper guide slots are deeper than the lower guide slots to facilitate door mounting by placing an upper door edge in an upper slot and rotating the lower door end into a position above a lower guide slot and then lowering the lower door end into the lower slot. In these cases, while the slots generally retain the received door, when the door is moved along the slots, door movement is often hampered by friction between the lower door edge and the lower track slot. In addition, when sliding the door between slot positions, the sliding action often has a cheap feel as the door rattles within the slots and can move up and down within the space allowed by the deep upper track slot. In some cases doors mounted in this fashion can become dislodged and fall out of the tracks or become damaged.

To overcome the door mounting problems described above, many door mounting structures include roller assemblies that mount to the lower and upper door edges. In some cases these roller assemblies are spring loaded so that the roller assemblies can be forced into a compressed state during installation and, once aligned with a track, can be expanded to fill the space between the upper and lower tracks. Other sliding door mounting configurations include doors hung by rollers assemblies by upper track members. Exemplary known door mounting structures are shown in U.S. Pat. Nos. 3,636,661 and 3,852,916. Where a dividing system includes a large number of components, overall cost to manufacture the system increases as each separate component has to be designed and manufactured separately and stocked by distributors and maintenance personnel.

Third, while many space dividing systems work well after they are constructed, the components of many systems are difficult to assemble into final configurations. For instance, in the case of systems that include several hundred different components that have to be assembled, the systems often come with detailed instruction manuals for how system components link and connect. Here, in many cases, only specially trained personnel have the skills needed to build a space dividing system. As another instance, many space dividing systems are configured such that two or more people and/or special tools are needed at times to assemble components into finished configurations.

Fourth, because many systems include components that are difficult to assemble, not surprisingly, many space dividing systems include components that, once assembled, are difficult to take apart and that are difficult to reconfigure into different configurations. To this end, persons and small groups of persons often prefer to use space differently and therefore, while a first person may want a space dividing configuration configured in a first way, a second person may want the configuration configured in a second way. For instance, a first person may want a large counter top height work surface while a second person may want a smaller counter top height work surface and first and second shelving units on opposite sides of the smaller work surface. Similarly, while a first person may want a dividing configuration configured in a first way at a first time, the first person may want the dividing configuration configured in a second way at a second time.

Where assembled components are difficult to disassemble, optimal use of a dividing configuration is discouraged and in many cases space users simply use the configuration in whatever form it embodies when the space is initially needed.

Fifth, in many industries, despite the fact that space dividing system components may be completely functional for longer periods, space dividing systems are replaced every eight to ten years to take advantage of new styles and added/new functionality. In these cases many dividing systems or at least components thereof (e.g., storage units) are simply trashed as the old system is reconfigured in a new space for a new use. Here, the primary reason components are trashed is because the components were initially designed to be used as parts of the larger system and therefore the components have features that render the components awkward for use independent of the overall system. For instance, where a cabinet unit is mounted on a panel wall system, the unit is typically equipped with integral mounting fasteners that extend from a rear surface for coupling to slots formed by the panel wall structure. Once the cabinet unit is removed from the wall structure, the extending mounting fasteners make the unit awkward for independent use. In short, while existing system components work well for their intended use, once the use changes, the components become obsolete.

Sixth, power and data cable routing and receptacle placement often complicate the space dividing design process. To this end, in addition to performing many other functions, many work space arrangements provide for power and data distribution with systems that include power and data cables and receptacles or outlet ports. In most cases it is desirable to conceal power and data cables within work space components and to provide power and data receptacles at various locations within the configuration.

Several solutions have been developed for concealing cables and locating receptacles. In many cases work space furniture components are provided that form cable channels for routing power/data cables about from one or more power sources to the receptacles. For instance, in the case of a partition wall system, wall structures typically include rigid rectangular frame subassemblies and panels that mount to the frame assemblies to form wall members. Here, frame components have been configured to provide internal and, in some cases, external cable passing channels. As another instance, in many cases separate cable trough forming structure is configured that mounts along the bottom of a partition wall system or that is mounted to the undersurface of a table or countertop member. In some cases a separate removable cover member(s) is provided that can be removed or opened to gain access to the cable trough. Where one or more separate trough forming members are required along with fasteners and, in some cases, covers, overall configuration costs increase appreciably.

For aesthetic reasons, many arrangements provide receptacles that appear to be flush mounted within arrangement components. For instance, in many cases receptacles can be mounted within a cable channel or trough using mechanical fasteners such as screws, bolts, etc. Here, in some cases the bolts or screws mount directly to the trough components and therefore are visible after receptacle installation. In other cases the screws or other fasteners mount the receptacles to structure internal to the trough and panel covers or trough covers that form openings for passing receptacle faceplates are mounted to the troughs with the receptacles accessible there through. While these solutions are aesthetically pleasing, each of these solutions has several short comings.

In cases where bolts/screws are visible after installation, the final arrangement does not have a particularly finished appearance and therefore is not aesthetically pleasing. In addition, these solutions require tools for installation and to take the arrangements apart.

In the case of arrangements where receptacles are mounted to internal trough structure and covers are then installed there around, the trough structure itself is often relatively complex and therefore costly to manufacture. To this end, in many of these cases, in addition to including the wall and other members that form the external surface of the trough, the trough also must include internal structure for mounting the receptacles. In addition, these solutions also require tools for installation and to take the arrangements apart. Moreover, these solutions require couplers or mechanical mounting mechanisms for separately mounting the receptacles and the covers or surrounding panels and therefore often have a relatively high parts count which can translate into higher overall arrangement costs. Furthermore, in at least some cases there can be alignment problems with these solutions where, after installation, receptacles do not precisely align with the openings formed by the covers/panels. Where alignment is not accurate, parts sometimes have to be disassembled and moved to different relative positions until alignment is more precise. Thus, the installation process with these arrangements can be particularly tedious. Moreover, in at least some cases where tolerances are not very rigidly maintained during manufacturing, even after proper installation, receptacles may not be precisely or well seated within cover/panel openings and poor finish results.

Thus, it would be advantageous to have a space dividing system that includes a small number of relatively inexpensive components that can be assembled in many different ways to provide space dividing structure where assembly does not require special tools and where the components, after assembly, can easily and quickly be disassembled and reassembled to configure a different furniture configuration. It would also be advantageous to have a dividing system of the above kind where system components and subassemblies are usable independent of the overall system so that many if not all system subassemblies can be recycled for a second useful life (e.g., within a house, a second office setting, etc.).

These and other objects and advantages of the invention will be apparent from the description that follows and from the drawings which illustrate embodiments of the invention, and which are incorporated herein by reference.

### BRIEF SUMMARY OF THE INVENTION

It has been recognized that a kit of furniture components can be provided that includes a table/counter assembly as a main structure and a plurality of other furniture components that can be supported by the main structure in different configurations to meet needs of different users and needs of a single user at different times. Here, the main structure can be provided with a lip member that defines a support surface and a furniture receiving space there above that has dimensions that are related to the dimensions of base structures of the furniture units such that, when suitable subsets of the furniture units are supported in the receiving space, the entire support surface is completely covered and a relatively finished configuration results.

Because the furniture components are only set into the receiving space and are not fastened in place, the components can be easily configured and reconfigured by simply lifting the units out of the receiving space and rearranging the components or swapping a different subset of furniture components into the receiving space. In addition, because the furniture component do not have to include couplers or other mechanical fastening components, the furniture components can be used independent of the furniture system and therefore can be recycled for different uses when no longer needed.

It has also been recognized that the main structure that forms the lip member may be formed of rigid sheet metal bent to form substantially horizontal support surfaces for the furniture units. In addition, in at least some embodiments the main structure of sheet metal may be bent to form a cable trough or channel that extends the length of the structure. Here, receptacle openings and other options for passing cables downward below the main structure may be formed in the trough. Where a receptacle is to be mounted in the trough, a receptacle clip may be provided for retaining the receptacle in the trough. In some embodiments a panel retaining clip may be mounted in the trough with one or more arm members extending down therefrom for retaining a panel member therebelow. In some embodiments the panel retaining clip may be included as part of a grommet received in a trough opening where the grommet forms one or more openings for passing cables into the trough.

Consistent with the above, some inventive embodiments include a furniture assembly kit comprising at least a first support structure having top and bottom ends, a plurality of furniture components, each component including a base structure having a component width dimension and a component length dimension and a sub-structure supported by the support structure and having a substantially flat support surface defined by a circumferential edge including first and second lateral edges and first and second oppositely facing end edges, the sub-structure also forming a lip member along at least a portion of the first lateral edge and at least a portion of the second lateral edge, the lip member having a distal upper edge, the space adjacent the support surface and between the lip members being a furniture receiving space, wherein different subsets of the plurality of components can optionally be positioned with the base structures of the component subsets supported by the support surface and with the base structures of the component subsets substantially covering the sub-structure support surface, each different subset including at least two of the plurality of components where at least one of the furniture components includes a storage unit that defines a storage space where the storage space resides at least in part above the furniture receiving space when the storage unit is supported on the support surface.

In some embodiments the support surface is substantially rectilinear, each of the base structures has a first component width dimension and a first component length dimension, the receiving space has a structure width dimension between the first and second lateral edges and a structure length dimension between the first and second end edges, the structure width dimension being a multiple of the first component width dimension and the structure length dimension being a multiple of the first component length dimension. In some cases the first component width dimension is substantially equal to the first component length dimension. In some cases the structure width dimension is substantially equal to the first component width dimension.

In some embodiments the plurality of components includes at least a subset of counter top tiles, each counter top tile including a top work surface. In some cases each of the storage units includes at least one side wall surface having a storage unit height dimension that is a multiple of the component length dimension and, wherein, each of the storage units is positionable with the side wall surface supported by the support surface and at least one subset of the plurality of components positioned with the base structures of the at least one subset of components simultaneously supported by the support surface so that the support surface is substantially covered. In some cases the first component width dimension is substantially equal to the first component length dimension and wherein the storage unit height dimension is substantially twice the first component width dimension. In some embodiments the plurality of components further includes at least a first component that includes a first base structure, the first base structure having the first component length dimension and a second component width dimension that is substantially half the first component width dimension, the first component positionable with the first base structure supported by the support surface and at least one subset of the plurality of components positioned with the base structures of the at least one subset of components simultaneously supported by the support surface so that the support surface is substantially covered.

Some cases further include at least a second component that includes a second base structure, the second base structure having the first component length dimension and the second component width dimension, the first and second components positionable with the first and second base structures supported by the support surface and another subset of the plurality of components positioned with the base structures of components simultaneously supported by the support surface so that the support surface is substantially covered. In some embodiments the first and second components each include a rear wall and wherein the first and second components are positionable with the rear walls adjacent each other and traversing the distance between the first and second lateral edges.

In some embodiments the lip members extend from the support surface along a lip length dimension to the distal ends, the lip length dimension between one quarter inch and one inch. In some cases the lip members extend along substantially the entire lengths of the lateral edges of the sub-structure and along the end edges of the sub-structure. In some cases the support structure includes first and second leg members linked to the sub-structure adjacent the first and second end edges, respectively, and, wherein, facing surfaces of the first and second leg members form end boundaries of the receiving space.

Some embodiments further include at least first and second pairs of leg members that have first and second heights, respectively, the support structure optionally including at least one of the first and second pairs of leg members such that the sub-structure member is supported at one of the first and second heights.

In some cases the sub-structure forms a channel that is recessed from the support surface and that extends between the first and second end edges. In some cases the sub-structure is formed of bent sheet metal. In some cases the sub-structure forms at least one opening from the channel to a space below the sub-structure for passing cables from the channel to the space below the sub-structure. In some cases the sub-structure forms at least one opening from the channel to a space below the sub-structure and wherein at least one of a power and a data receptacle is mounted in the at least one opening.

In some embodiments the receptacle is accessible from below the sub-structure. In some cases the sub-structure is formed of bent sheet metal. In some cases the first support structure has a first height dimension, the assembly further including at least a second support structure that has a second height dimension that is different than the first height dimension where the sub-structure is supportable by the either of the first and second support structures.

Other embodiments include a furniture assembly comprising a support structure having top and bottom ends, a sub-structure supported adjacent the top ends of the support structure and having a substantially flat rectilinear support surface defined by a circumferential edge including first and second lateral edges and first and second oppositely facing end edges, the sub-structure also forming a lip member along at least a portion of the first lateral edge and at least a portion of the second lateral edge, the space adjacent the support surface being a furniture receiving space and having a structure width dimension between the first and second lateral edges and a structure length dimension between the first and second end edges and a plurality of furniture components, each component including a base structure having a component width dimension and a component length dimension wherein the component width dimension and length dimension are substantially equal and the component width dimension is substantially equal to the structure width dimension, at least a first of the furniture components further including a side wall member that has a component height dimension that is a multiple of the component width dimension, wherein A at least a first subset of the plurality of furniture components including the first furniture component is simultaneously positionable with the base structures on and supported by the support surface and so that the base structures substantially cover the support surface and B at least a second subset of the plurality of furniture components including the first furniture component is simultaneously positionable with the side surface of the first component and other components on and supported by the support surface and so that the side surface and the other components substantially cover the support surface

In some cases the first furniture component is a storage unit that opens to one side and is positionable as part of the first plurality of components so that the first component optionally opens to face one of the first lateral edge, the second lateral edge, the first end edge and the second end edge. In some cases the structure length dimension is a multiple of the component length dimension. In some cases at least a subset of the plurality of components includes counter top tiles that form top surfaces, the top tiles having a tile thickness dimension, the lip members having a lip height dimension that is substantially similar to the tile thickness dimension such that when the tiles are placed in the receiving space, the top surfaces of the tiles are substantially flush with distal edges of the lip members.

Some embodiments include a furniture assembly comprising a support structure having top and bottom ends, a sub-structure supported by the support structure and having a substantially flat rectilinear support surface defined by a circumferential edge including first and second lateral edges and first and second oppositely facing end edges, the sub-structure also forming a lip member along at least a portion of the first lateral edge and at least a portion of the second lateral edge, the space adjacent the support surface being a furniture receiving space and having a structure width dimension between the first and second lateral edges and a structure length dimension between the first and second end edges and a first plurality of furniture components, each component in the first plurality including a base structure having a first component width dimension and a first component length dimension, the first component width dimension substantially equal to the first component length dimension and substantially equal to the structure width dimension, a second plurality of furniture components, each component in the second plurality including a base structure having a second component length dimension substantially equal to the first component length dimension and a second component width dimension that is substantially half the first component width dimension wherein, different subsets of the first and second pluralities of components can optionally be positioned with the base structures of the component subsets supported by the support surface and with the base structures of the component subsets substantially covering the sub-structure support surface, each different subset including at least two components.

In some cases the structure length dimension is a multiple of the first component length dimension. In some cases the second plurality of components include storage units that open to one side and wherein the storage components are each positionable on the support surface so that the unit opening faces one of a lateral edge and an end edge of the sub-structure. In some cases the lip members extend along the entire lengths of the first and second lateral edges and at least portions of the first and second end edges.

Still other embodiments include a furniture assembly comprising first and second leg members, each of the first and second leg members having top and bottom ends and forming at least one side surface, a sub-structure having a substantially flat support surface defined by a circumferential edge including first and second lateral edges and first and second oppositely facing end edges, the sub-structure forming a lip member along the first lateral edge and the second lateral edge, the space adjacent the support surface and between the lip members being a furniture receiving space and wherein, the first end edge of the sub-structure is mounted to the one side surface of the first leg member and the second end edge of the sub-structure is mounted to the one side surface of the second leg member so that the leg members support the sub-structure in an elevated position and so that the facing side surfaces of the first and second leg members form end boundaries of the receiving space.

Some cases further include a plurality of furniture components, each component including a base structure having a component width dimension and a component length dimension wherein the component width dimension is substantially similar to a structure width dimension between the lip members and the component length dimensions are multiples of the component width dimension.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

FIG. 1A shows top, front and end views of an exemplary counter assembly;

FIG. 1B is an exploded view showing the counter assembly of FIG. 1A along with other components;

FIG. 1C is a drawing showing a portion of a counter assembly with a counter infill component supported on a portion of the spine member;

FIG. 2 is a perspective view of an embodiment of a workstation furniture unit with a storage bin according to the present invention;

FIGS. 3-8 are perspective views of various work space arrangements that may be configured using an inventive kit of parts, each including at least one counter assembly;

FIG. 9A is a drawing showing the components of a frame member;

FIG. 9B is a drawing showing the components of a frame member with a infill panel for forming a framed privacy screen;

FIG. 9C is a drawing showing an assembled frame member;

FIG. 10 is a drawing showing a cross sectional view of an extruded piece used to form a frame member;

FIG. 11 is a perspective view of an extruded piece showing bolts insertable in the C-shaped portions;

FIG. 12 is a drawing showing how two extruded pieces are connected together;

FIG. 13 is a drawing showing a plastic cap at a corner of a frame member;

FIG. 14 is a drawing showing various views of a spine member;

FIG. 15 is a perspective view showing the underside of the spine member and an attached end support bracket;

FIG. 16A is a top plan view of a grommet that is consistent with at least some aspects of the present invention;

FIG. 16B is a side plan view of the grommet of FIG. 16A;

FIG. 16C is an end plan view of the grommet of FIG. 16A;

FIG. 16D is a top perspective view of the grommet of FIG. 16A installed in a channel formed by the sub-structure shown in FIG. 67;

FIG. 17A is a perspective view from a low vantage point showing the grommet of FIG. 16A after installation;

FIG. 18 illustrates an end cap at the end of the channel which is insertable into the trough portion to cover the channel;

FIG. 19 is a partial perspective view of the grommet of FIG. 16A installed in a use position from a top vantage point;

FIG. 20A is a front plan view of the clip shown in FIG. 58;

FIG. 20B is a top plan view of the clip member shown in FIG. 58;

FIG. 20C is an end plan view of the clip shown in FIG. 58;

FIGS. 21 and 22 illustrate a support bracket for attaching a work surface panel to the counter assembly;

FIGS. 23-32 illustrate various embodiments of connection pieces for connecting frame members to each other;

FIG. 33 illustrates a work space arrangement which would utilize many of the connection pieces shown in FIGS. 23-32;

FIGS. 34 and 35 illustrate arrangements of the counter assembly and other components illustrating various heights;

FIGS. 36A and 36B illustrate the counter assembly and show a cover piece for concealment of utility lines extending to or from the floor;

FIG. 37 is a perspective view of an exemplary furniture assembly that is consistent with at least some aspects of the present invention;

FIG. 38 is an exploded view the components shown in FIG. 37;

FIG. 39 is a partial cross-sectional view taken along the line 39-39 in FIG. 38;

FIG. 40 is a partial cross-sectional view taken along the line 40-40 in FIG. 38;

FIG. 41 is a perspective view of one of the tile members of FIG. 38 that is consistent with at least some aspects of the present invention;

FIG. 42 is a perspective view of the cabinet unit of FIG. 38, albeit in a horizontal orientation;

FIG. 43 is a perspective view of a half depth shelf unit that is consistent with at least some aspects of the present invention;

FIG. 44 is a perspective view of a full depth shelf unit consistent with at least some aspects of the present invention;

FIG. 44A is a perspective view similar to FIG. 44, albeit showing a shelf unit with a recessed side surface and an exemplary insert component;

FIG. 44B is a partial cross-section view showing a portion of an insert 157 installed in the recessed surface of a shelf unit;

FIG. 44C is similar to FIG. 44B, albeit showing a recessed surface unit with a chamfered lip and an associated installed insert;

FIG. 45 is a perspective view similar to FIG. 37, albeit showing a second furniture assembly;

FIG. 46 is similar to FIG. 37, albeit showing a third furniture assembly;

FIG. 47 is similar to FIG. 37, albeit showing a fourth furniture assembly;

FIG. 48 is similar to FIG. 37, albeit showing a fifth furniture assembly;

FIG. 49 is a perspective view of a bracket used to mount the table shown in FIG. 48 to the table/counter assembly;

FIG. 50 is a partial perspective view showing the bracket of FIG. 49 mounted to an undersurface of the sub-structure member shown in FIG. 48;

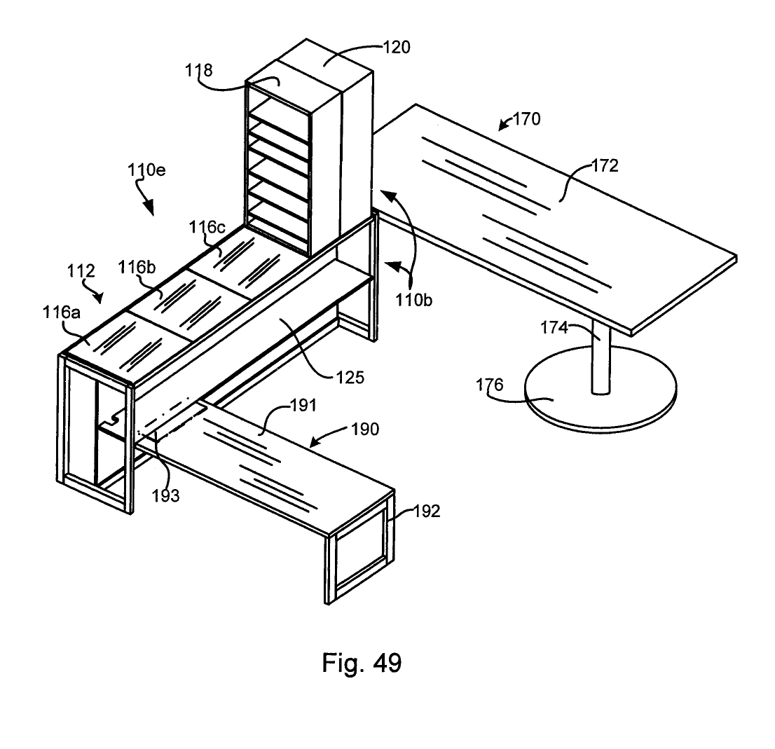

FIG. 49 is a perspective view similar to FIG. 37, albeit showing a sixth furniture assembly;

FIG. 52 is a perspective view that illustrates a seventh furniture assembly that is consistent with at least some aspects of the present invention;

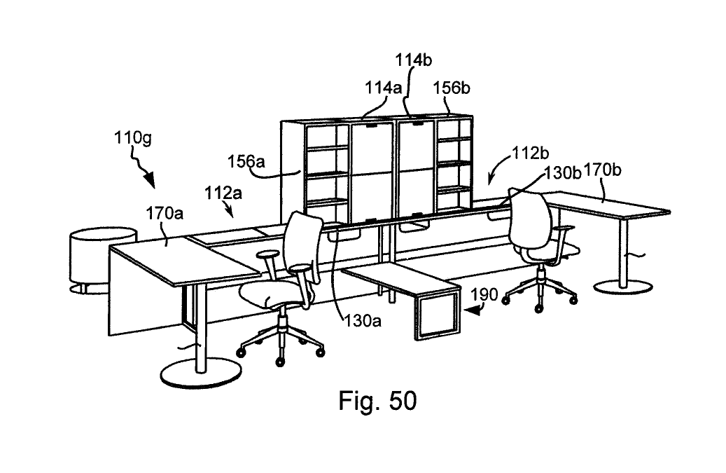

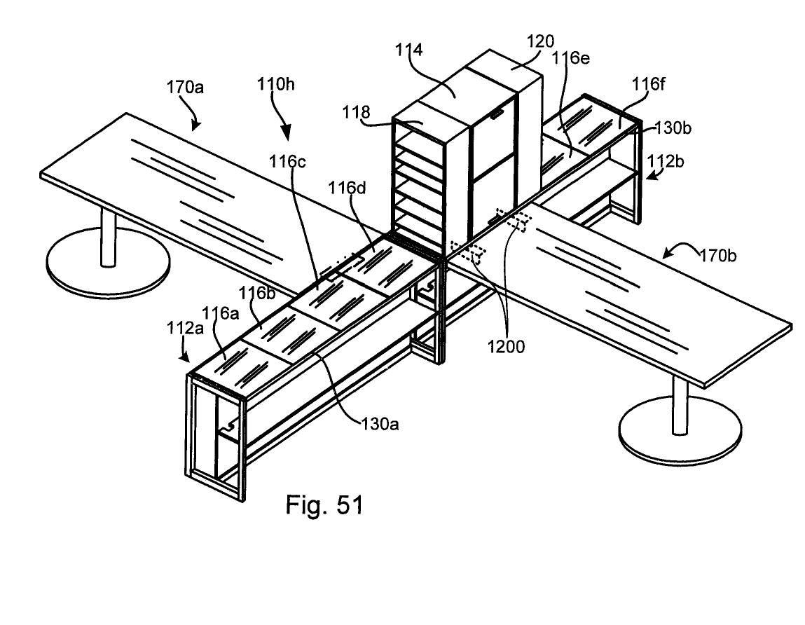

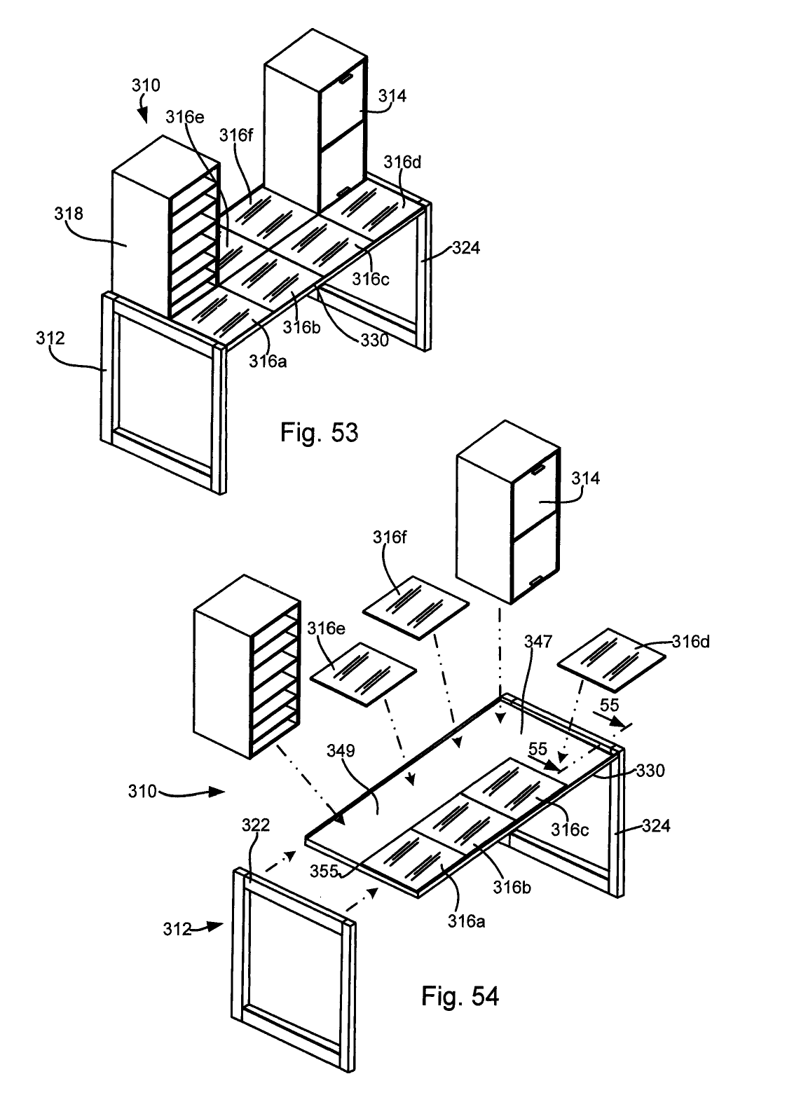

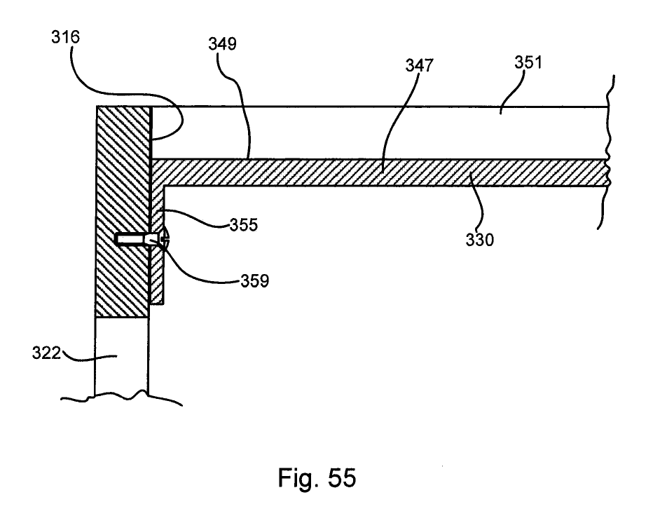

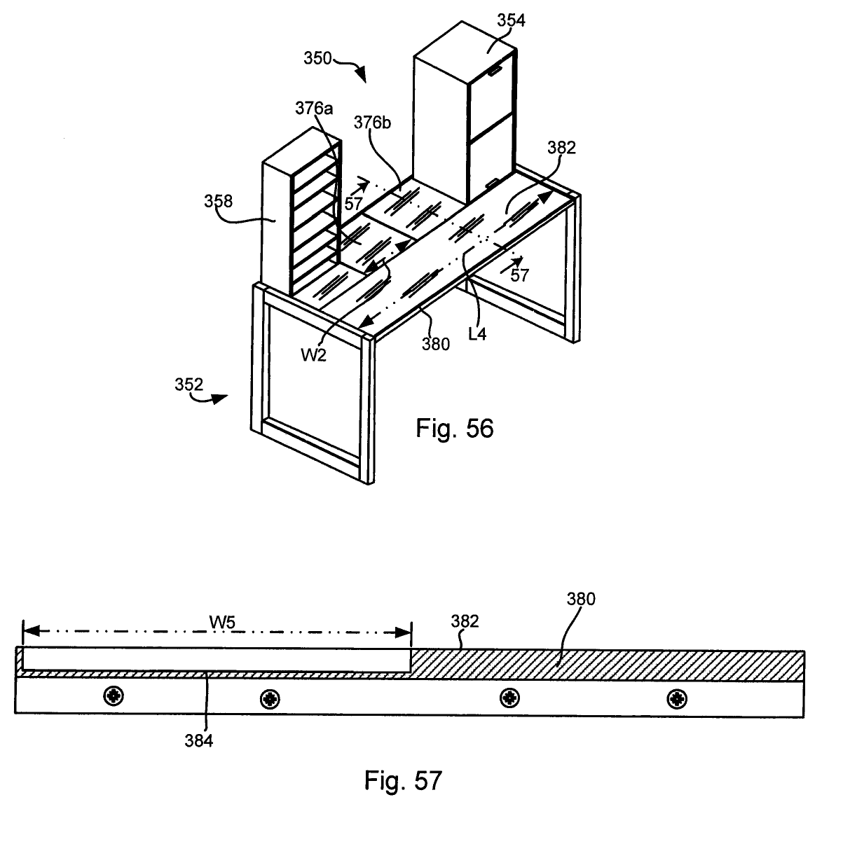

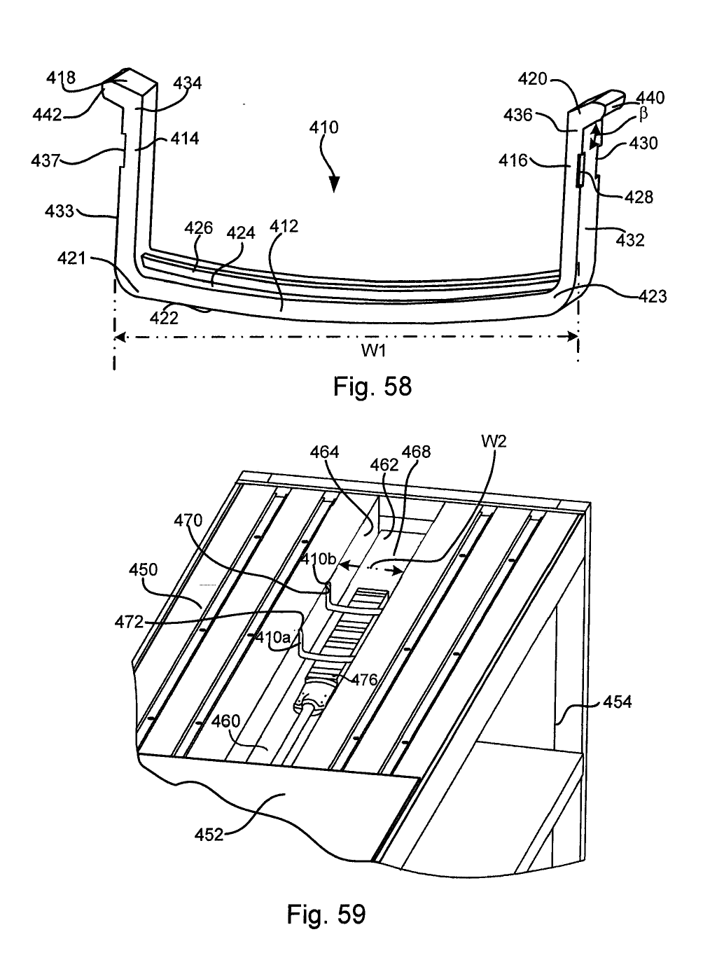

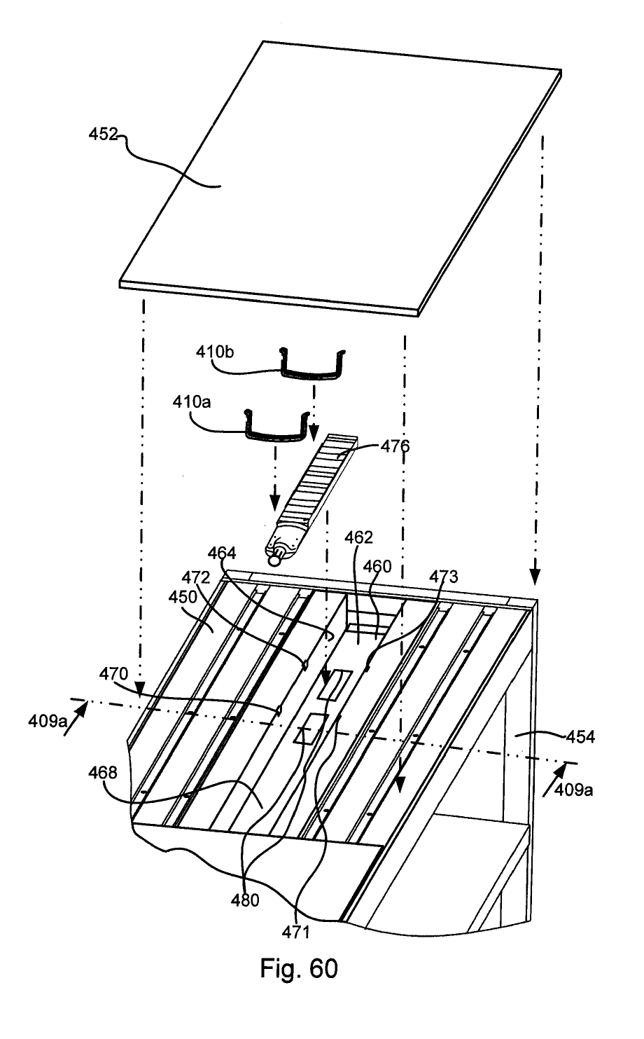

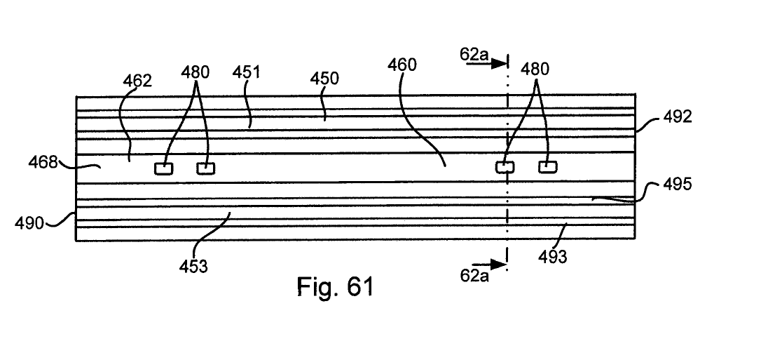

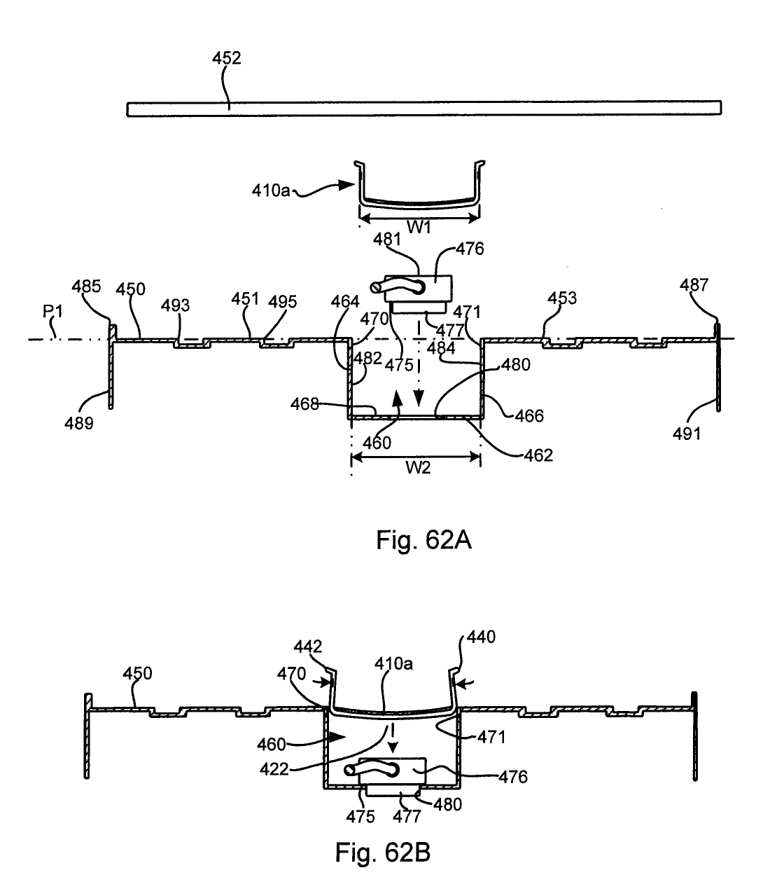

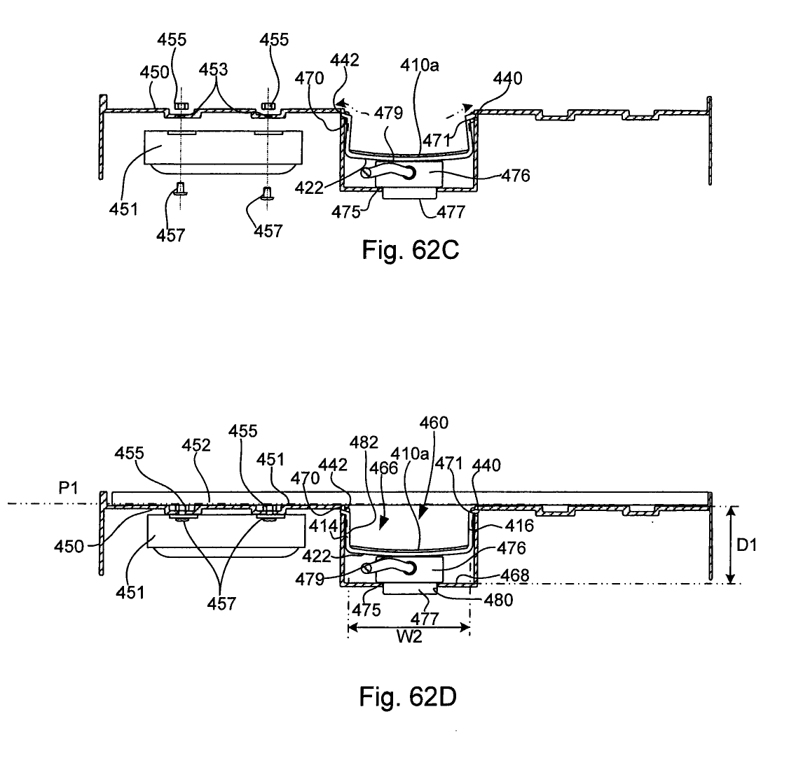

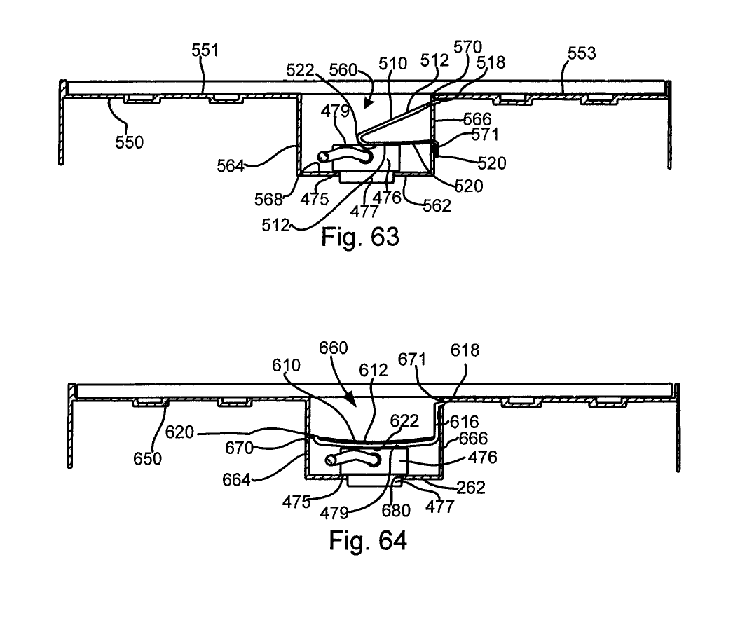

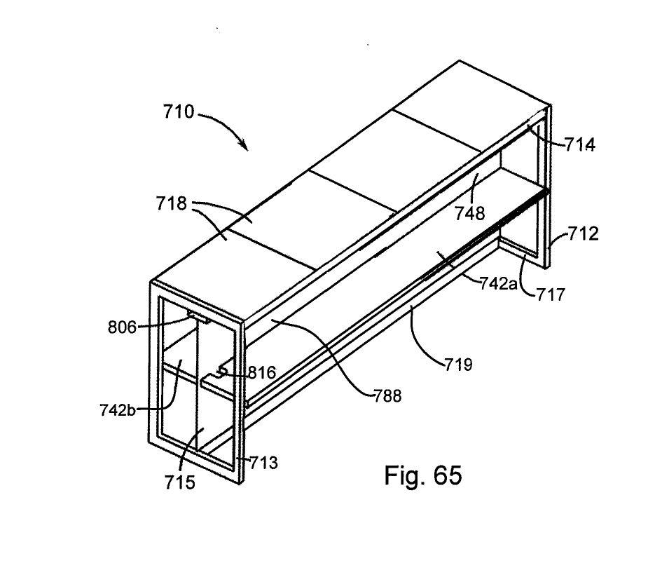

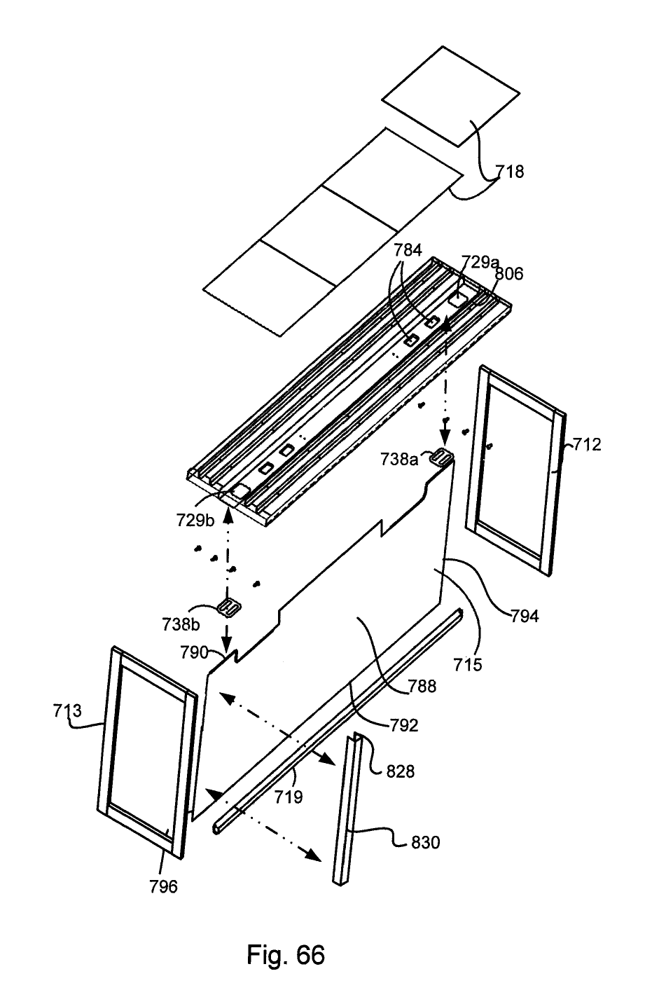

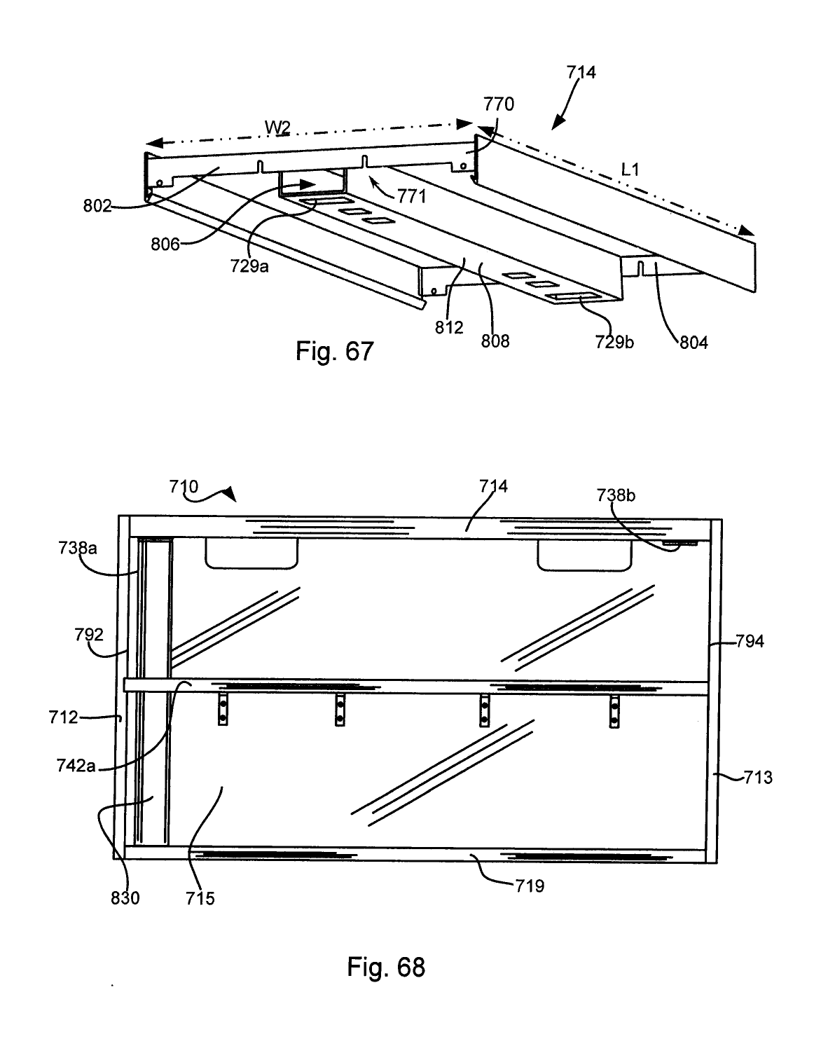

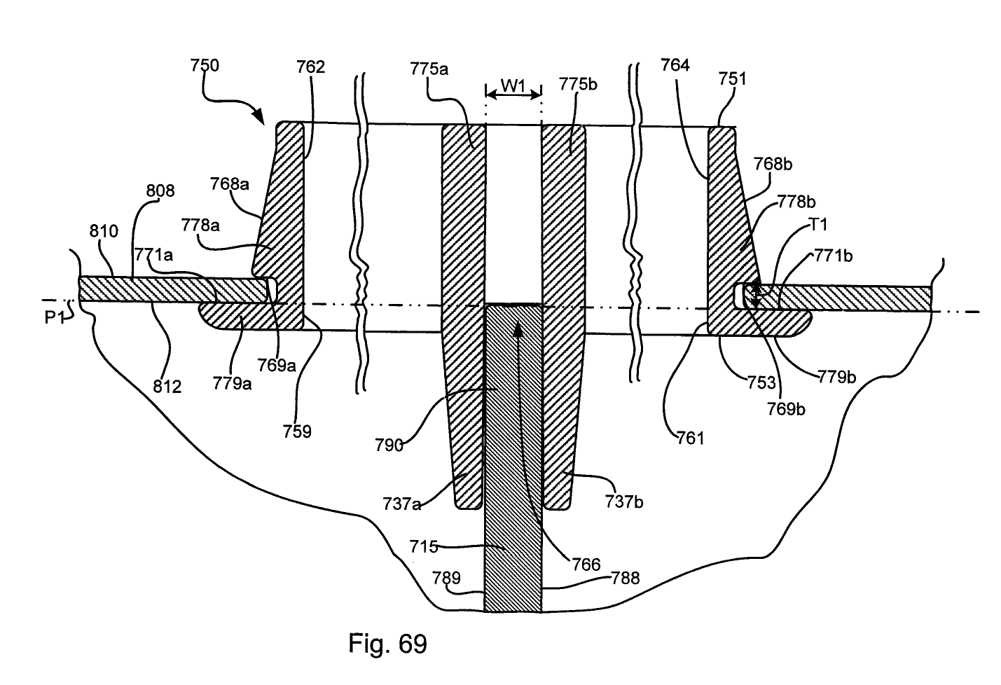

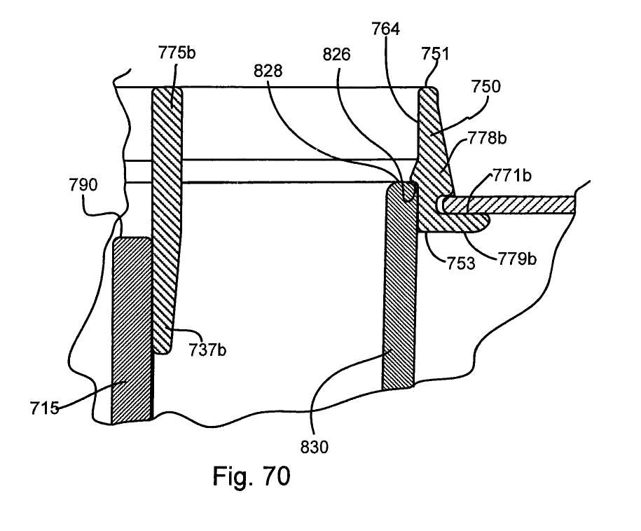

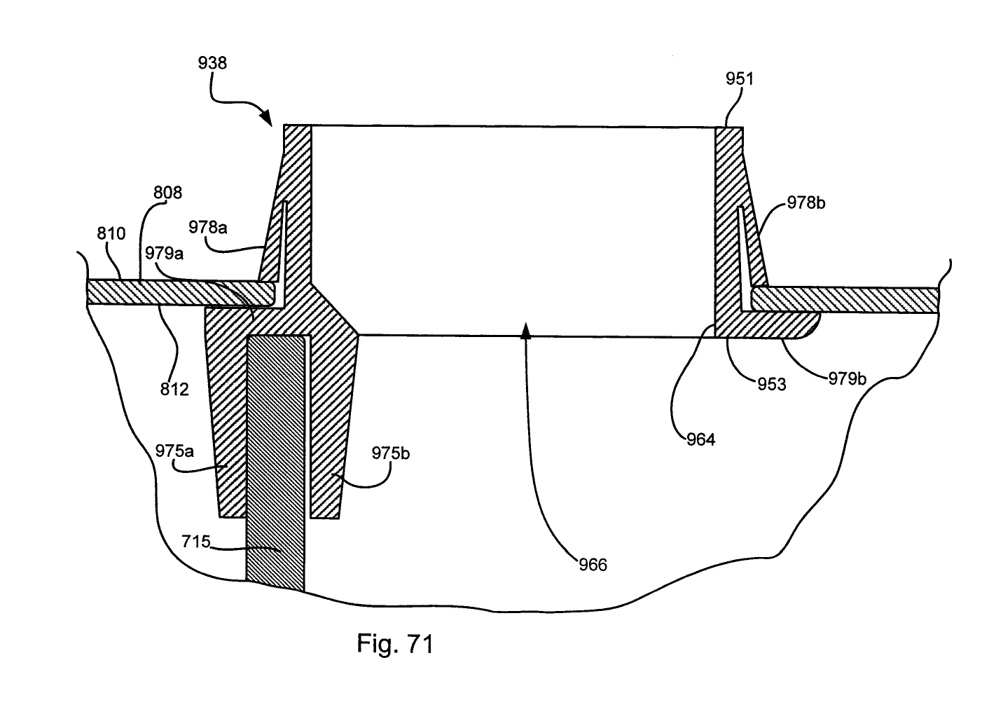

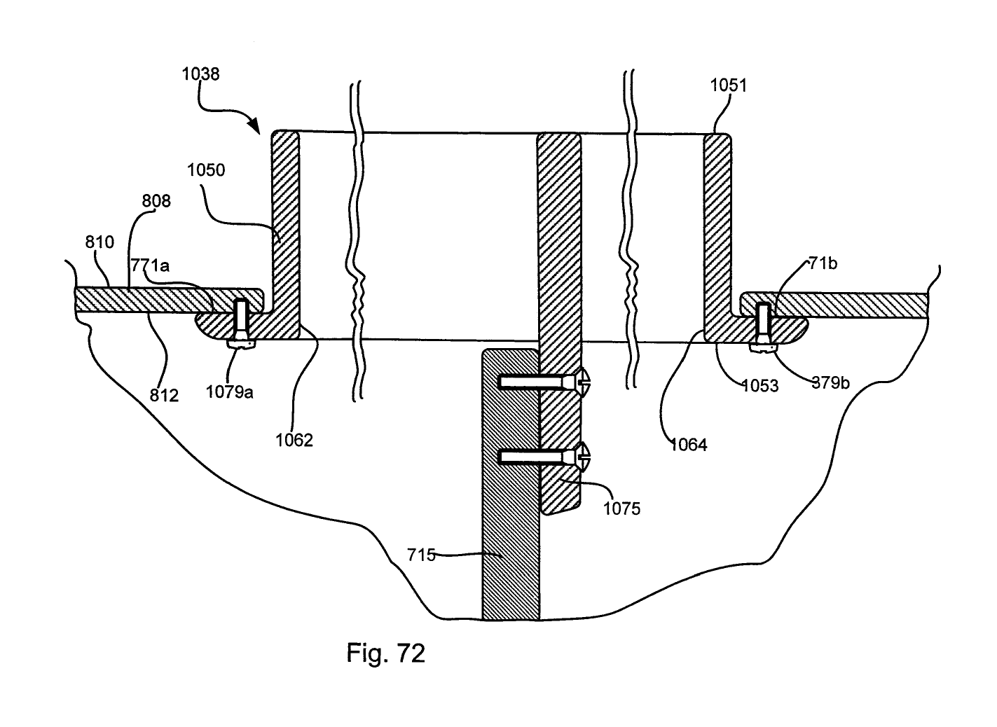

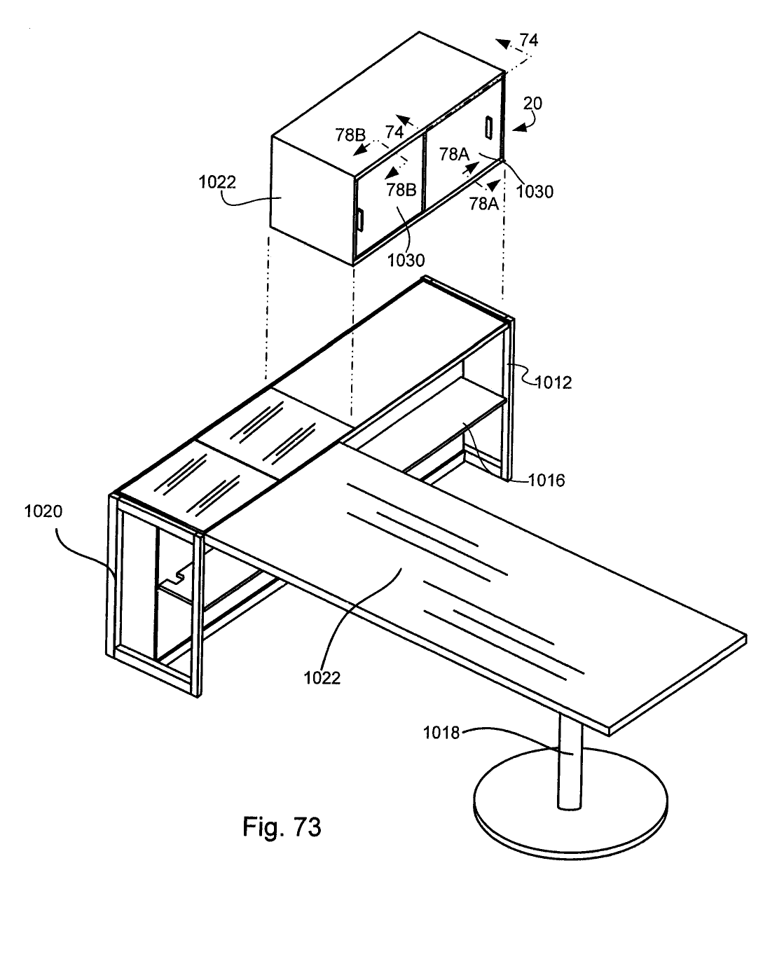

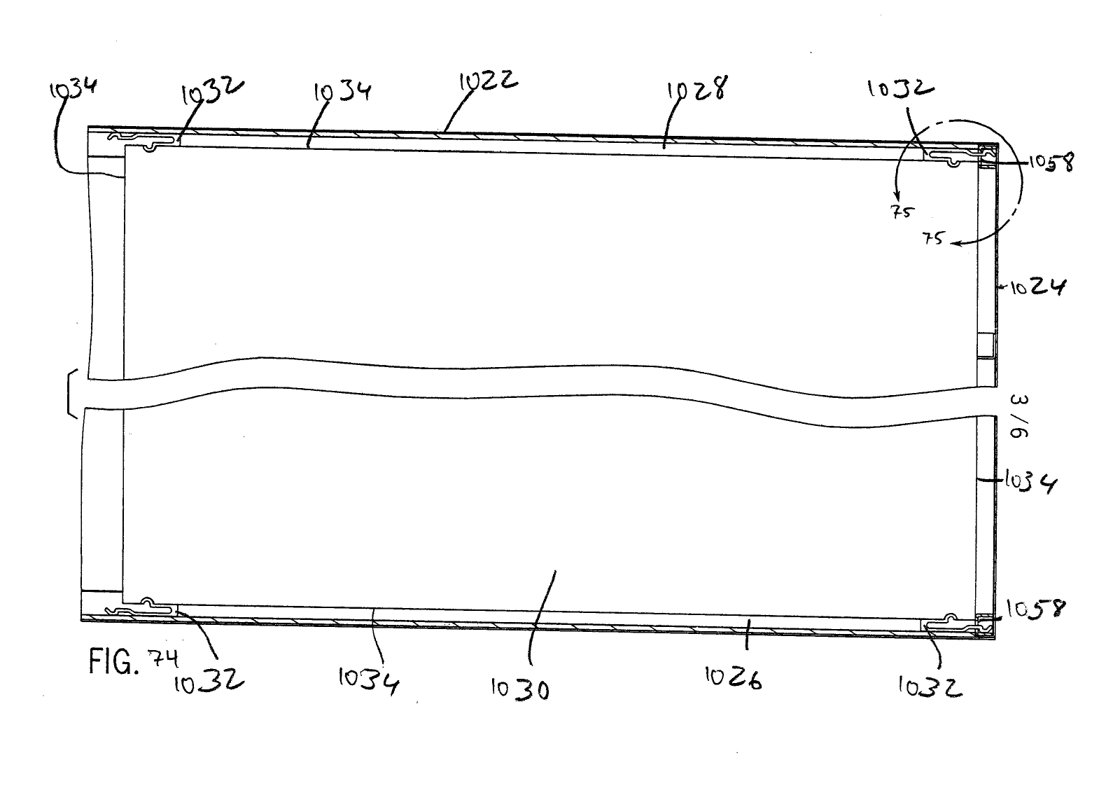

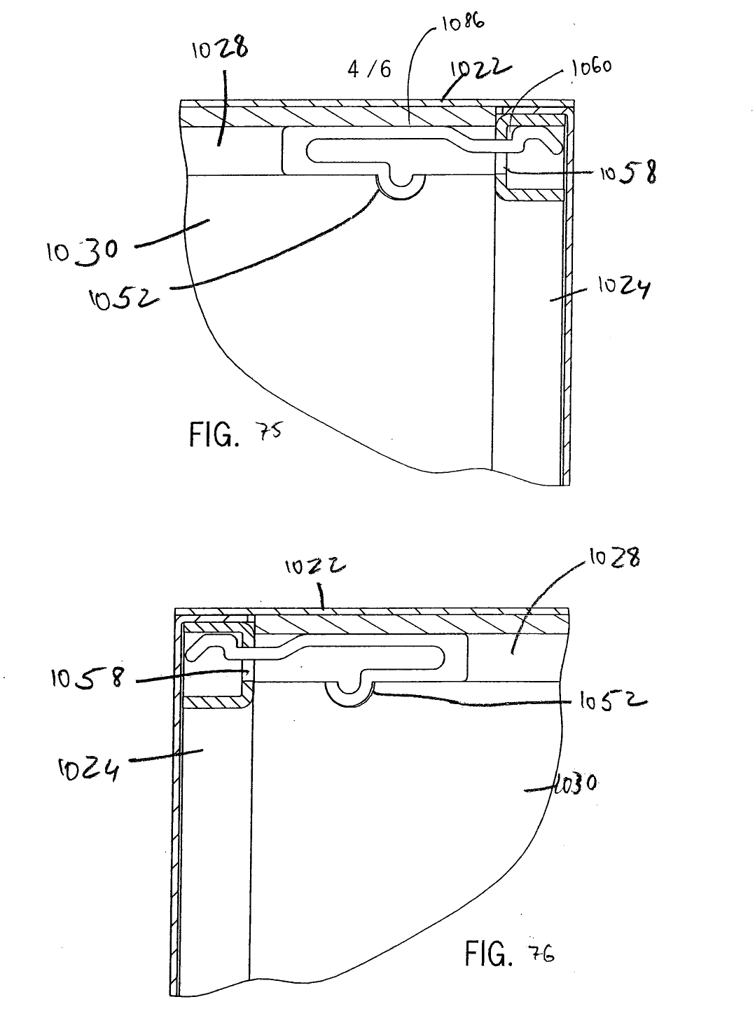

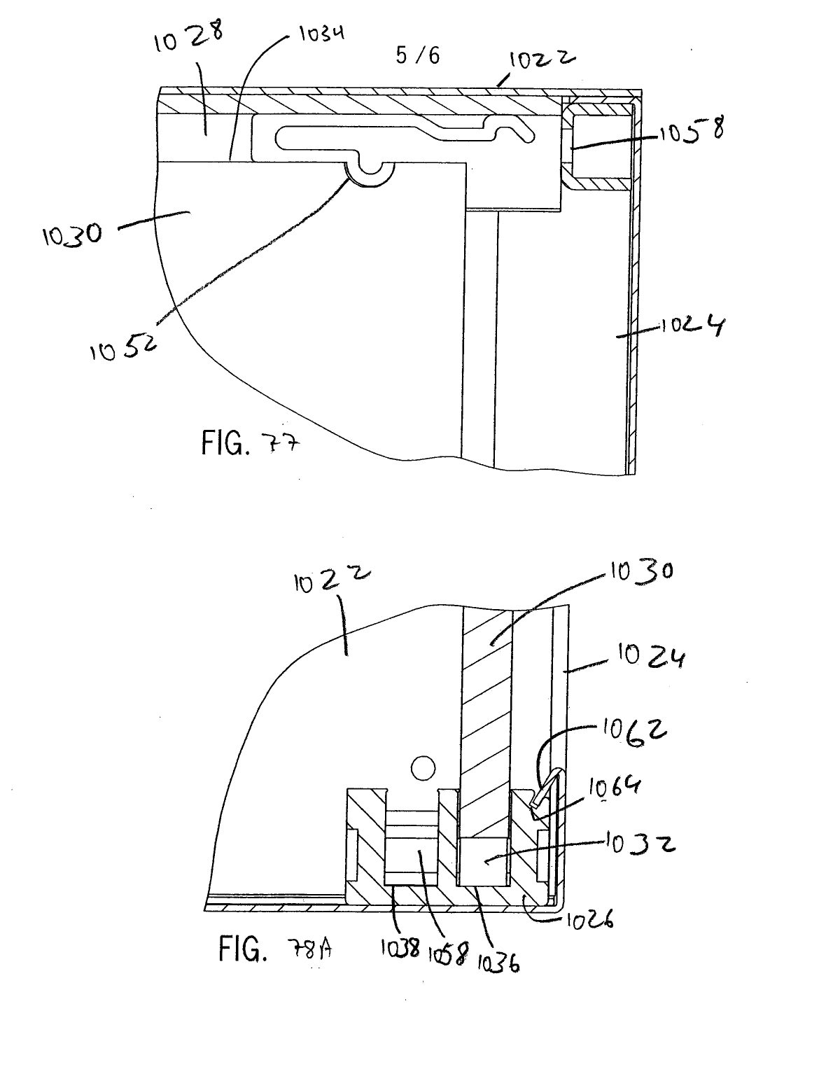

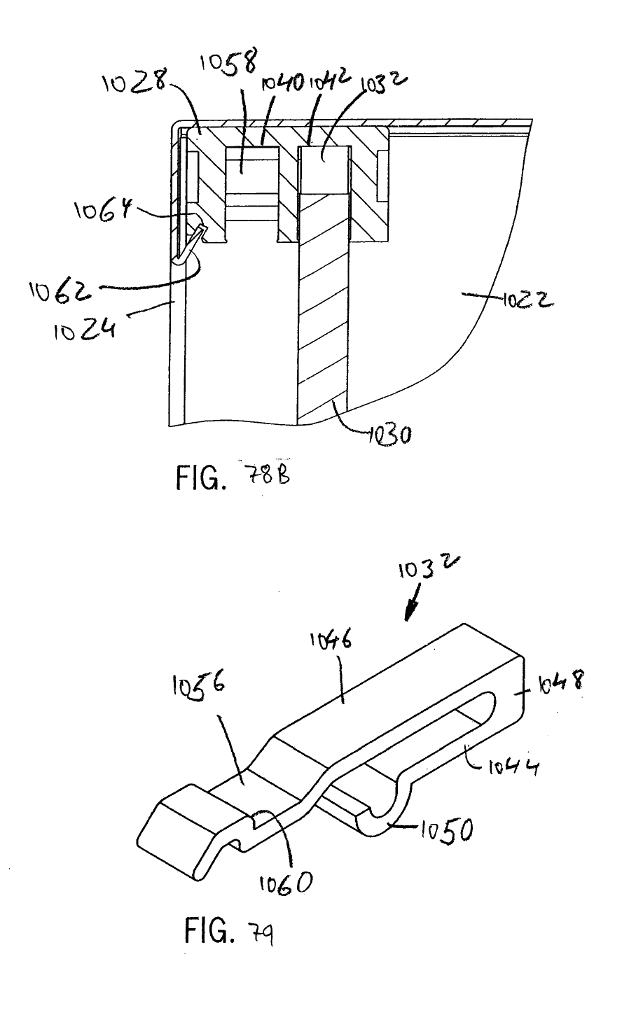

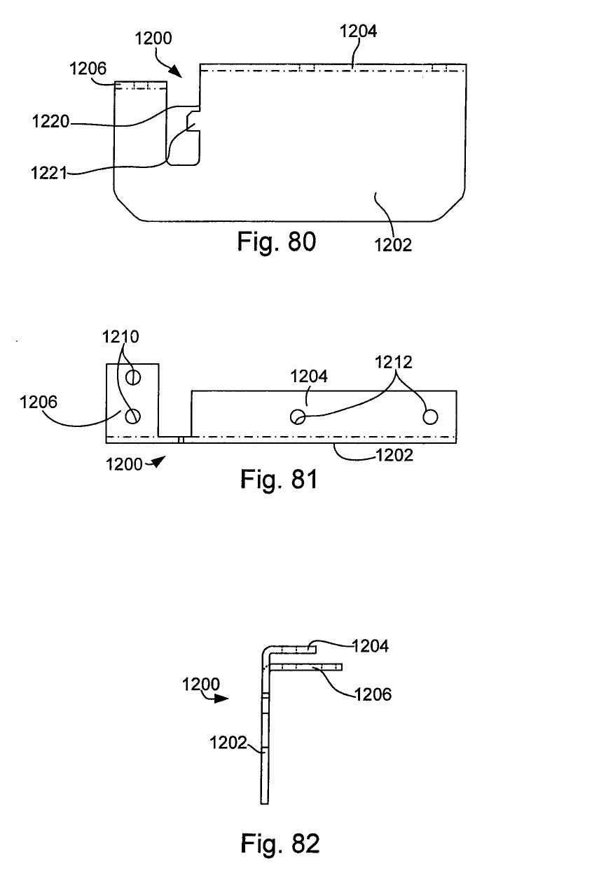

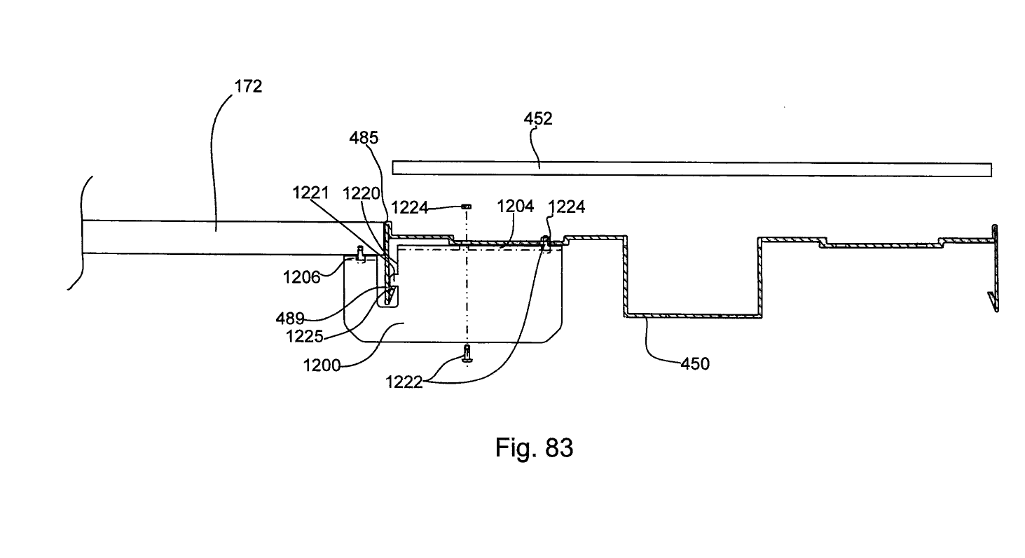

FIG. 50 is a perspective view illustrates an eighth furniture assembly consistent with at least some aspects of the present invention;

FIG. 51 that illustrates a ninth furniture assembly that is consistent with at least some aspects of the present invention;

FIG. 52 is a perspective view of two different height leg members that may be used with other system components to provide sub-structures at different heights;

FIG. 53 is a perspective view of another table assembly;

FIG. 54 is a partially exploded view of the assembly of FIG. 53;

FIG. 55 is a partial cross sectional view taken along the line 55-55 of FIG. 54.

FIG. 56 is a perspective view of another table assembly;

FIG. 57 is a cross sectional view taken along the line 57-57 in FIG. 56;

FIG. 58 is a perspective view of a first embodiment of a clip member that is consistent with at least some aspects of the present invention;

FIG. 59 is a partial perspective view of a power/data module secured within a channel formed by a support structure using two of the clip members shown in Fig. 58;

FIG. 60 is a partially exploded view of the assembly shown in FIG. 59;

FIG. 61 is a top plan view of the support structure shown in FIG. 59;

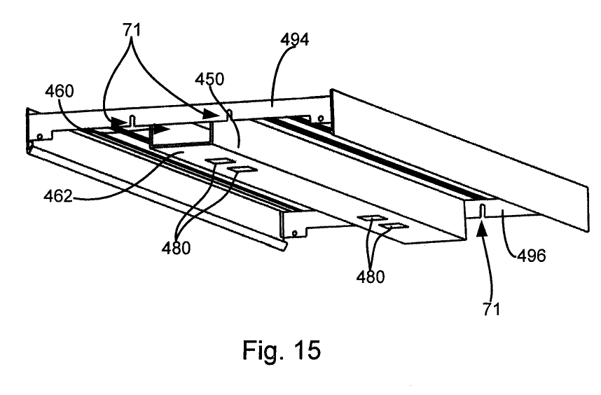

FIG. 15 is a perspective view from a lower vantage point of the support structure shown in FIG. 59;

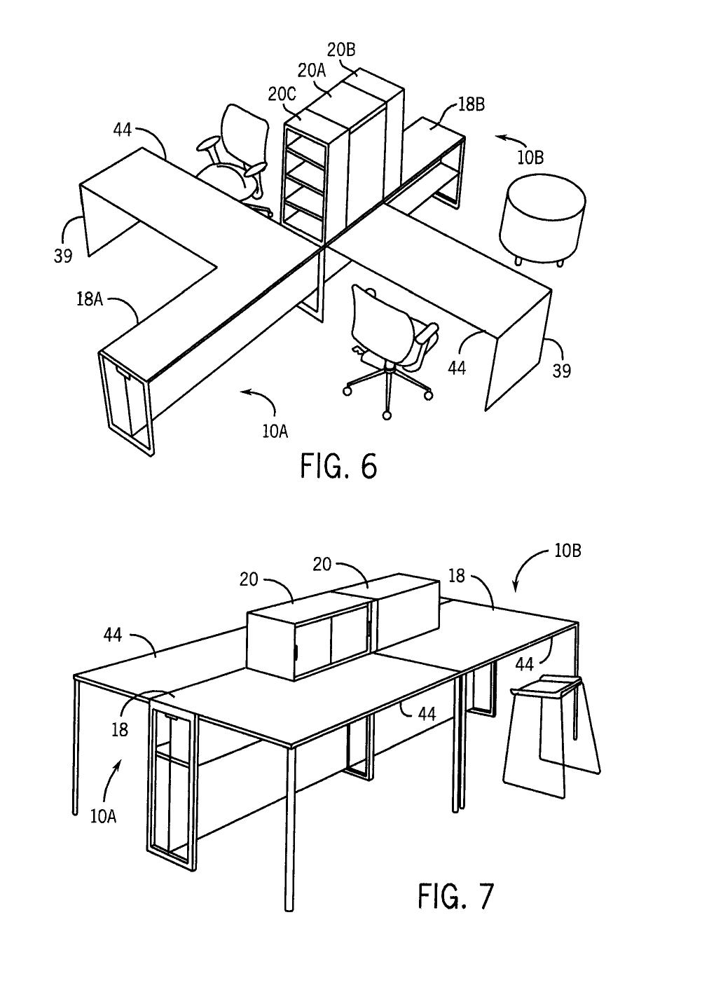

FIG. 62A is a partial cross-sectional view taken along the line 62A-62A in FIG. 6;

FIG. 62B is similar to FIG. 62A, albeit showing a power/data module in an installed position and a clip member in an intermediate installation position;

FIG. 62C is similar to FIG. 62B, albeit showing the clip member in a partially installed position;

FIG. 62D is similar to FIG. 62C, albeit showing the clip member in an installed position;

FIG. 63 is a cross-sectional view similar to the view shown in FIG. 62D, albeit showing a second clip member embodiment as consistent with at least some aspects of the present invention;

FIG. 64 is a cross-sectional view similar to the view shown in FIG. 62D, albeit illustrating yet another clip member;

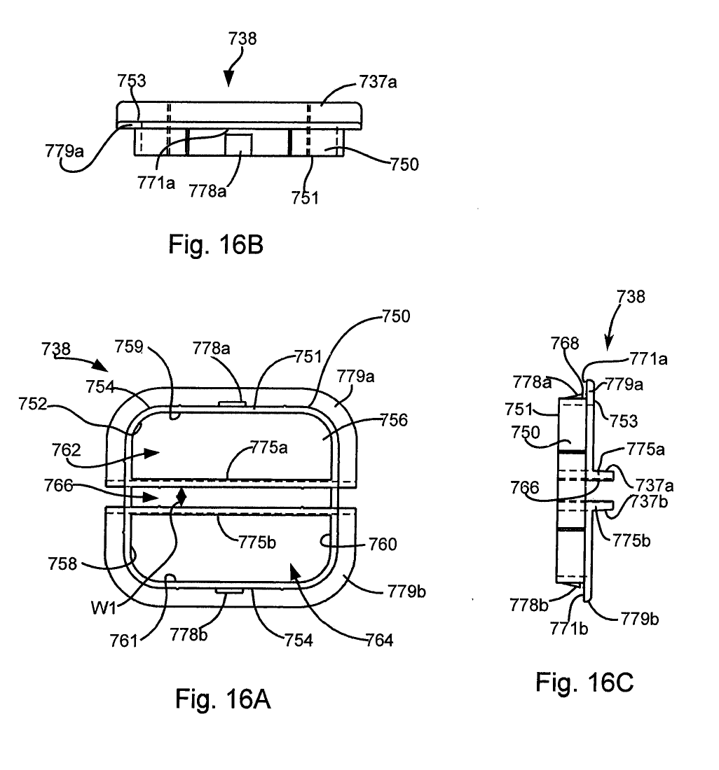

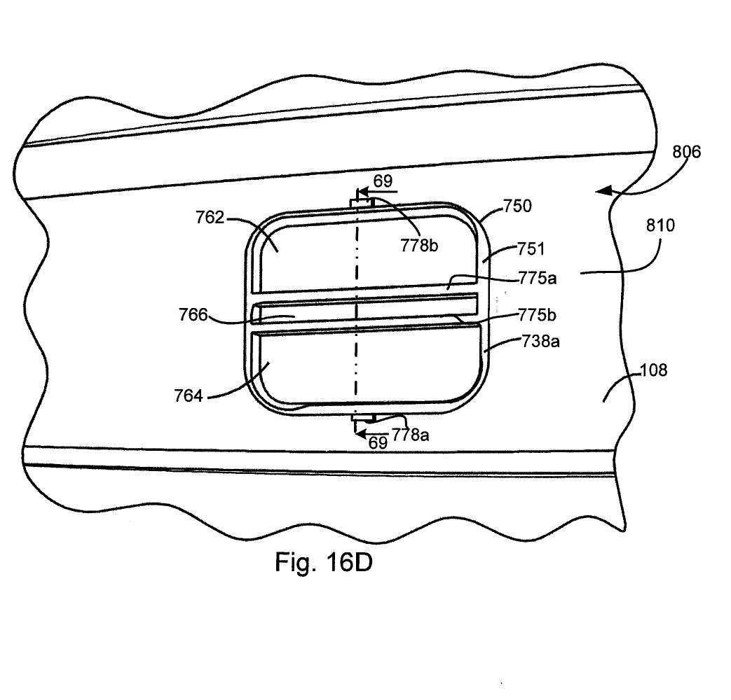

FIG. 65 is a perspective view of a counter/table assembly that the grommet of FIG. 16 may be used with;

FIG. 66 is an exploded view of the counter/table assembly of FIG. 65 without shelf members;

FIG. 67 is a perspective view of a sub-structure that forms a cable channel and that is included as part of the assembly shown in FIG. 66;

FIG. 68 is a side plan view of the assembly of FIG. 65;

FIG. 69 is a cross-sectional view taken along the line 69-69 in FIG. 16D;

FIG. 70 is a cross-sectional view similar to FIG. 69, albeit showing a second grommet that includes a plenum limiting internal rib;

FIG. 71 is a cross-sectional view similar to FIG. 69, albeit showing a third grommet that forms only a single cable passing opening;

FIG. 72 is a cross-sectional view similar to FIG. 69, albeit showing a fourth grommet that is fastened via screws to a first panel and where a second panel is mounted via screws to the grommet;

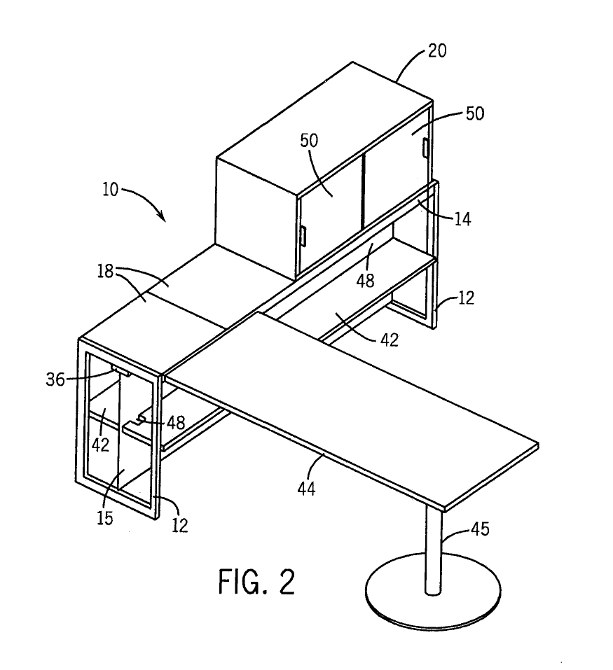

FIG. 73 is a perspective partially exploded view of the workstation furniture unit of FIG. 2;

FIG. 74 is a fragmentary cross-sectional view taken along section line 74-74 in FIG. 73;

FIG. 75 is a fragmentary cross-sectional view taken of detail 75-75 in FIG. 74;

FIG. 76 is a fragmentary cross-sectional view similar to FIG. 75, but showing the spring clip positioned in an opposite corner;

FIG. 77 is a fragmentary cross-sectional view similar to FIG. 75, but showing the spring clip and the corresponding sliding door moved slightly from the edge of the bin enclosure;

FIG. 78A is a fragmentary cross-sectional view taken along section line 78A-78A in FIG. 73;

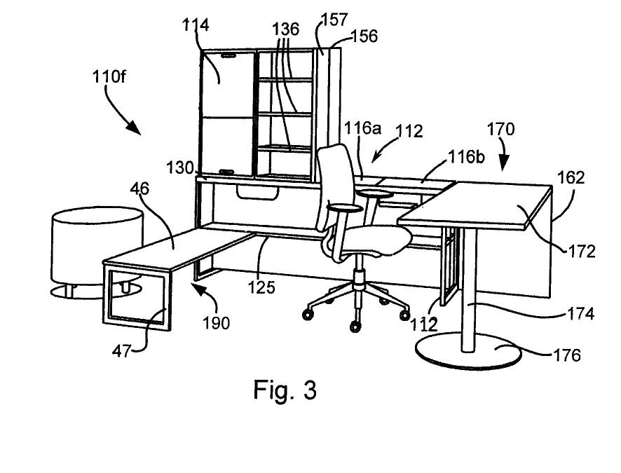

FIG. 78B is a fragmentary cross-sectional view taken along section line 78B-78B in FIG. 3;

FIG. 79 is a perspective view of an embodiment of the spring clip according to the present invention which is used in FIGS. 74 and 75;

FIG. 80 is a side perspective view of an exemplary table-spine bracket that is consistent with at least some embodiments of the present invention;

FIG. 81 is a top plan view of the bracket of FIG. 80;

FIG. 82 is an end view of the bracket of FIG. 80;

FIG. 83 is a view showing the bracket of FIG. 80 installed to secure a table top member to a spine member; and

FIG. 84 is a view similar to the view in FIG. 79, albeit showing a steel spring clip.

### DETAILED DESCRIPTION OF THE INVENTION

A. General Configuration Description

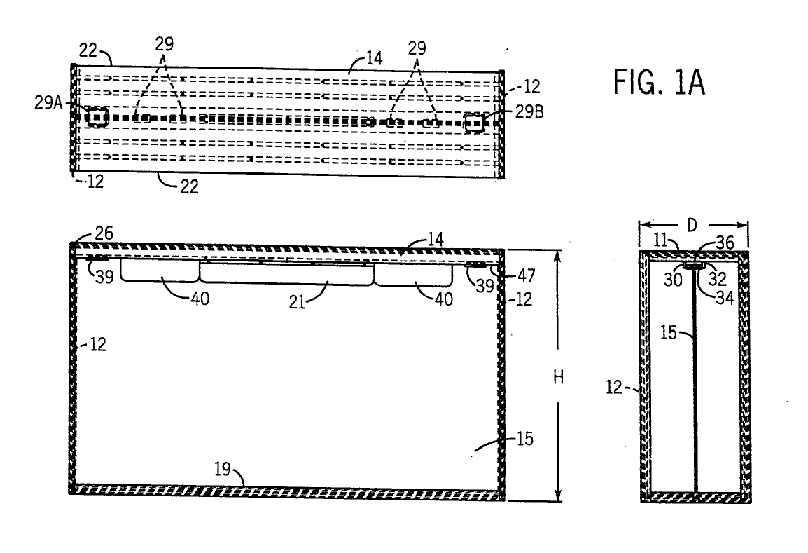

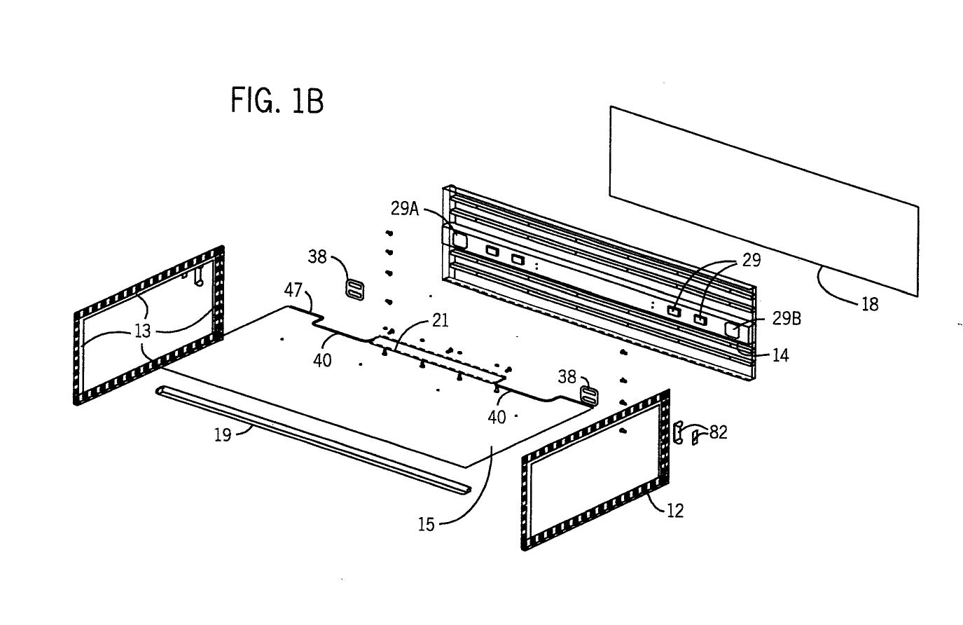

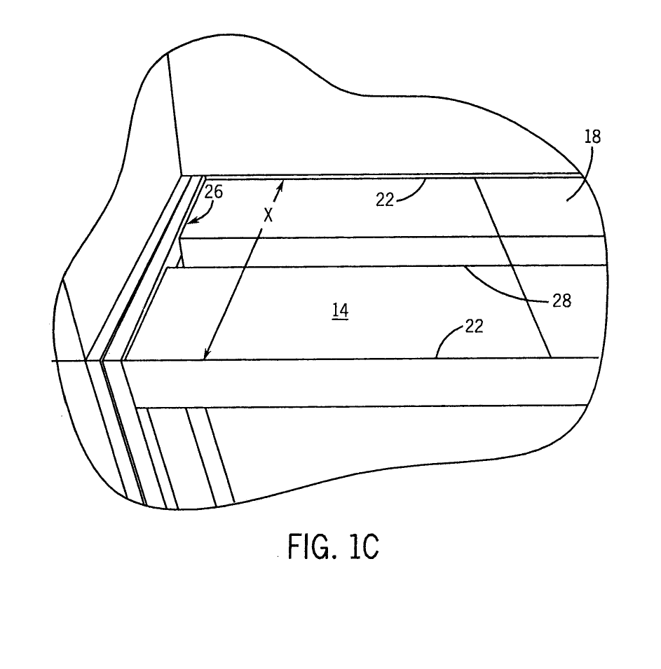

Referring now to the drawings wherein like reference numbers correspond to similar elements throughout the several views and, more specifically, referring to FIGS. 1A-1C, and FIG. 2, an exemplary counter assembly 10 is illustrated. The counter assembly 10 is formed by two upright rectangular frame members 12, a spine member 14 supported by the two frame members 12, and a center privacy panel 15 which is vertically arranged below the spine member 14. As described more fully below, an exemplary embodiment of the frame member 12 is constructed from four extruded pieces 13 that can be cut to desired sizes which allows the size of the frame member 12 and thus the height H and depth D of the counter assembly 10 to be easily varied to desired dimensions. For example, exemplary heights for the counter assembly 10 include standard counter heights and standard desk heights.

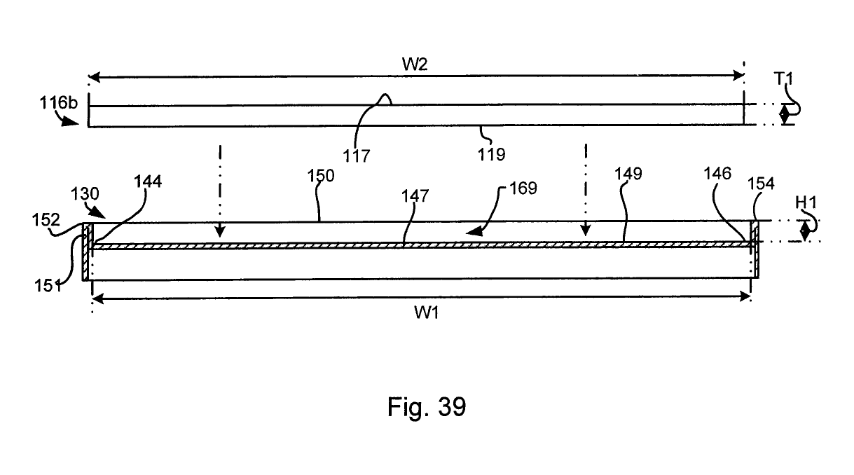

The spine member 14 can be unribbed as shown in FIG. 1C, but is preferably ribbed, as shown in FIGS. 1A and B, and supports one or more counter infill components. The counter infill components can take various forms such as thin panels or tiles 18, storage bins 20 of various forms, paper holders, racks of shelves, magazine racks, etc. The panels or tiles 18 can be shaped as squares or rectangles of various sizes. The storage bins 20 can be of various sizes, can each be arranged in a vertical position or a horizontal position, can have one or two open sides, can include shelves, cubbies, drawers, or sliding doors and can have various surface types such as magnetic surfaces, tackable surfaces, whiteboard surface, etc. Other counter infill components may take the form of a dual sided or architectural element. Different configurations of various counter infill components can thus be provided on the spine member 14. The one or more counter infill components are constrained on the top surface of the spine member by two longitudinally extending lips 22 along the sides 24 of the spine member 14, and on the ends by the upper portions 26 of the frame members 12 which extend above the top surface of the spine member. Each lip 22 has a distal upper edge and has a height dimension H1 (see FIG. 39).

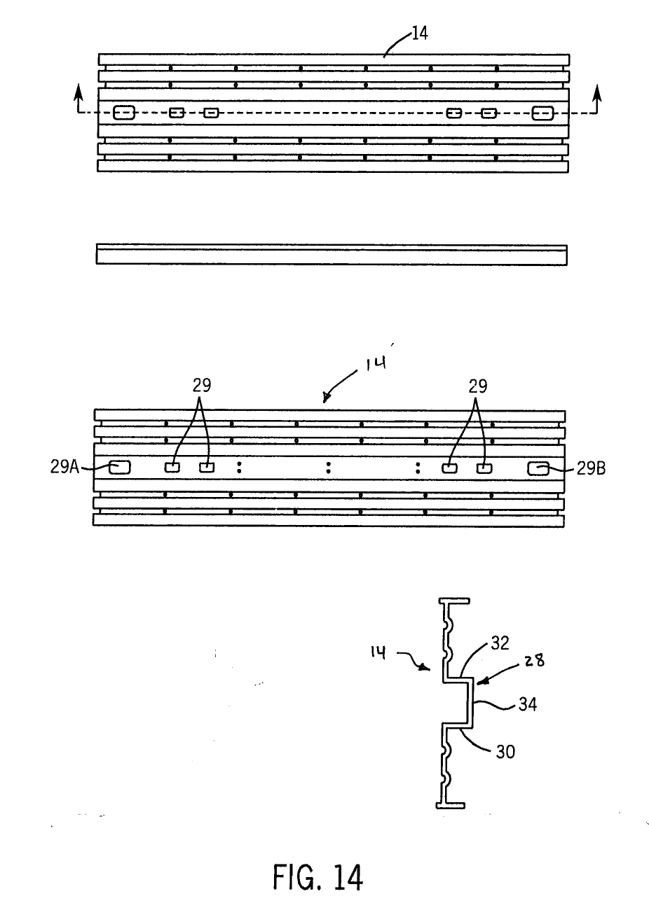

The spine member 14 has a trough portion 28 including side walls 30, 32 and a bottom wall 34 (see also FIG. 14). The trough portion 28 defines a channel 36 which extends longitudinally from one frame member 12 to the other, and opens on each end below a top piece 11 of each frame member 12. Utility lines (power, phone, network, etc.) can be run in this channel 36 as more fully described below from an end thereof or from below. In particular, the bottom wall 34 of the trough portion 28 includes a number of holes 29, 29A, 29B to allow the utility lines to run between an area below the trough portion 28 to the channel 36. In some embodiments, power cords run through the channel 36 from an end of the counter assembly, or from floor level up to the trough portion 28, and include one or more receptacles which are aligned with a hole 29 in the bottom wall 34 of the trough portion 28 and face downwardly.

The bottom wall 34 of the trough portion 28 also supports two grommets 38 with openings and aligned in two outer holes 29A, 29B, with each grommet 38 including two downwardly extending flanges 37 which position and constrain the vertical center panel 15 below the spine member 14. A finishing bar 19 is provided at the bottom of the center panel 15. A tack board 21 is provided on the center panel. Notches 40 in the upper edge 47 of the vertical center panel 15 allow for power lines to extend from these receptacles to either side of the vertical center panel 15.

Work space arrangements are formed by one or more counter assemblies 10 in conjunction with one or more other components. Referring to FIGS. 2-8, various aspects of the invention will be described in the context of different work space arrangements which include the counter assembly 10 and other components such as horizontal shelves 42, vertically arranged privacy panels or screens such as framed privacy screens 43, horizontally arranged work surface panels 44 forming desks or tables or other surfaces at various heights, and one or more legs 45 or frame members 46 for supporting the work surface panels 44. Different configurations of these various components can be provided which allows much flexibility in the work space arrangements that can be formed. Note that depending on the height of the counter assembly 10, the countertop of the counter assembly can be provided at various heights including standard counter heights or standard desk heights, the work surface panels 44 can be provided at various heights including standard counter heights, standard desk heights, and standard coffee table heights, and the shelves 42 can be provided at various heights including standard desk heights and standard coffee table heights. For example, standard coffee table heights include a range of 15-21 inches with 16-18 inches being most common. Standard desk heights include a range of 22-32 inches with 25-30 inches being more common and 29-30 inches being most common. Standing counter work heights include a range of 25-48 inches with 38-42 inches being more common. Other selected heights are also possible.

As shown in FIG. 2, one work space arrangement includes a counter assembly 10 with a work surface panel 44 that is attached near one end of the counter assembly 10 at countertop height and is supported at the other end by a leg 45. A shelf 42 is attached to each side of the vertical center panel 15, preferably using L shaped support brackets (not shown). Front shelf 42 has notches 48 so that utility lines can be run from floor level up to the channel 36, passing though the openings in the grommets 38. Here the counter infill components take the form of two insertable square tiles 18 and a single horizontally arranged storage bin 20 supported by the spine member 14. These tiles 18 and storage bin 20 are kept in place by the lips 22 illustrated in FIG. 1C. The insertable tiles 18 form a countertop surface. In FIG. 2, the work surface panel 44 is supported by a single leg 45, but in other arrangements, the work surface panel 44 can be supported by a frame member 46 similar to that of the frame member 12 of the counter assembly 10 and having appropriate dimensions. Although work surface panels are shown as rectangular in shape, other shapes are also envisioned.

FIG. 3 illustrates another work space arrangement including a counter assembly 112 and several work surface panels 172, 116, etc., attached to the counter assembly 112. As shown, the work surface panels or members can be arranged at various heights, such as the height of a shelf 125 on the center panel or the height of the sitting work surface, to form desks and tables (see 172). These work surface panels can be supported by a frame member 47 or one or multiple legs 174 or another support member. Further, these work surface panels can be located on either or both sides of the counter assembly 112 or can be attached to an end of the counter assembly as shown.

FIG. 3 also shows various forms of storage bins 114, 156, 157 that can provide useful storage for the work space, can help define space, or can provide a privacy barrier around all or a portion of a work area. For example, storage bin 114 includes sliding doors and storage bins 156 and 157, which each have a depth dimension roughly one half of the depth of the counter assembly 112, include shelves 136. The storage bins can be arranged in various ways on the spine member 14 such as in a horizontal position as shown in FIG. 2, or a vertical position, as shown in FIG. 3. Two or more storage bins can be arranged on and supported by spine member 14 that one is in a vertical position and one is in a horizontal position.

In an exemplary embodiment, lips 22 of the spine member and upper portion 26 of the frame members define an insertable area having dimensions slightly greater than a unit measure, denoted by X, measured in a depth direction of the counter assembly and an integer multiple of that unit measure X measured in a width direction of the counter assembly 10. (Note X is slightly less than depth dimension D). For example, in the illustrated embodiment, this insertable area is slightly greater than X by 4X, where X is approximately 18 inches. To provide flexibility in the way the counter infill components can be arranged while still providing coverage of the entire spine member 14, the insertable tiles 18 and storage bins 20 are sized such that they can fit within this insertable area in a number of different combinations. Each counter infill component has an insertable surface that fits within the insertable area using this same unit measure X (or X/2), or multiples thereof. This allows the different mixing of one or more tiles 18 and/or one or more storage bins 20 to provide various configurations in the insertable area, with the tiles and/or storage bins constrained by lips 22 and portion 26. For example, the insertable tiles 18 can have an insertable surface with dimensions of X by X, X by 2X, X by 3X, or X by 4X. A full size storage bin 20A can have dimensions of 2X (height when arranged vertically) by X (width) by X (depth), and a half-depth storage bin 20B can have dimensions of 2X by X by X/2. Thus, the configuration of FIG. 2 includes two insertable square tiles 18 and a single unit depth storage bin 20 arranged in a horizontal position. The configuration of FIGS. 3A and B includes two insertable square tiles 18, a unit depth storage bin 20A arranged in a vertical position and two half depth storage bins 20B, 20C arranged vertically back to back. Note that a storage bin 20, when in a vertical position, can be arranged such that its opening is facing whichever direction is desired. Similarly, when a storage bin 20 is in a horizontal position, its opening can face to either side or upwardly.

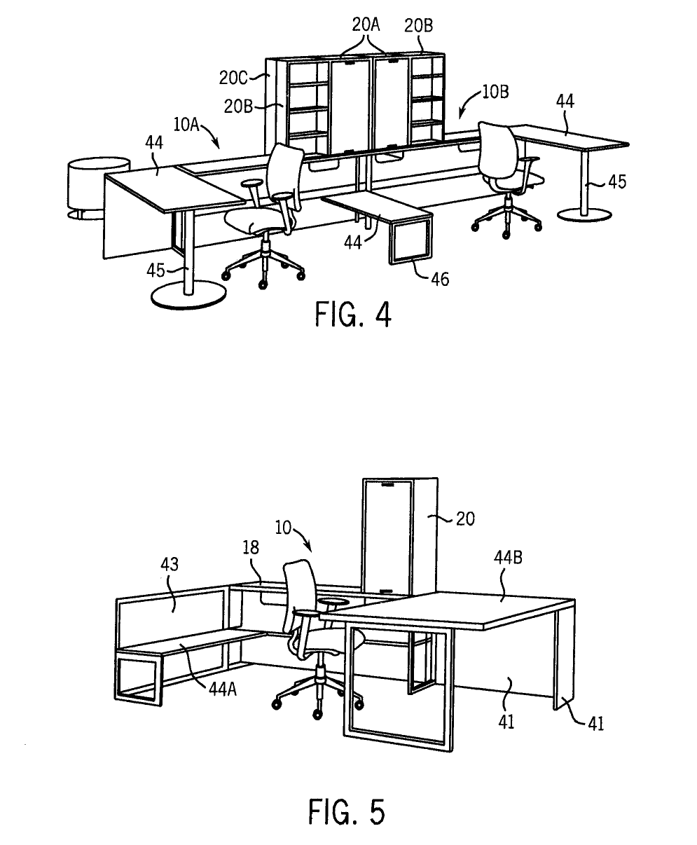

FIG. 4 illustrates another work space arrangement having two counter assemblies 10A, 10B arranged end to end to provide work areas for two workers. The channels 36 of the two counter assemblies 10A, 10B are aligned with one another, such that utility lines can be routed from a channel 36 of one counter assembly to a channel 36 of the other. Various work surface panels 44 provide desk surfaces and lower surfaces as shown, and power can be routed to devices on these lower surfaces requiring power through the receptacles arranged to face downwardly in the channel 36.

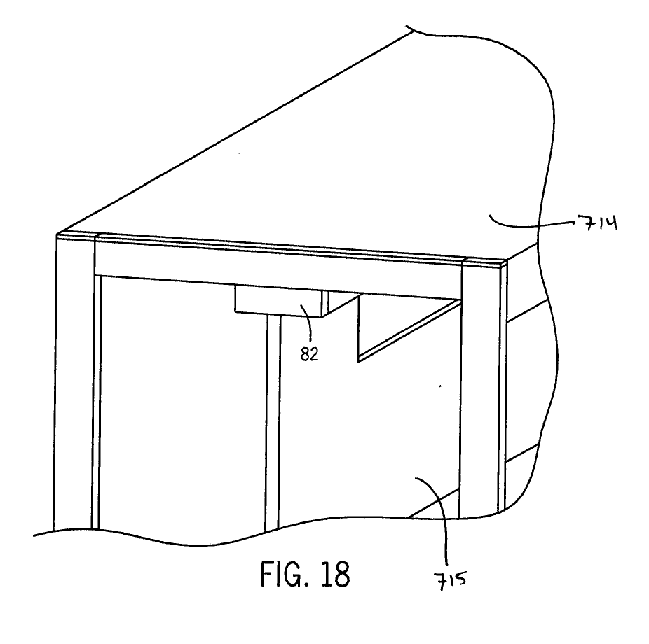

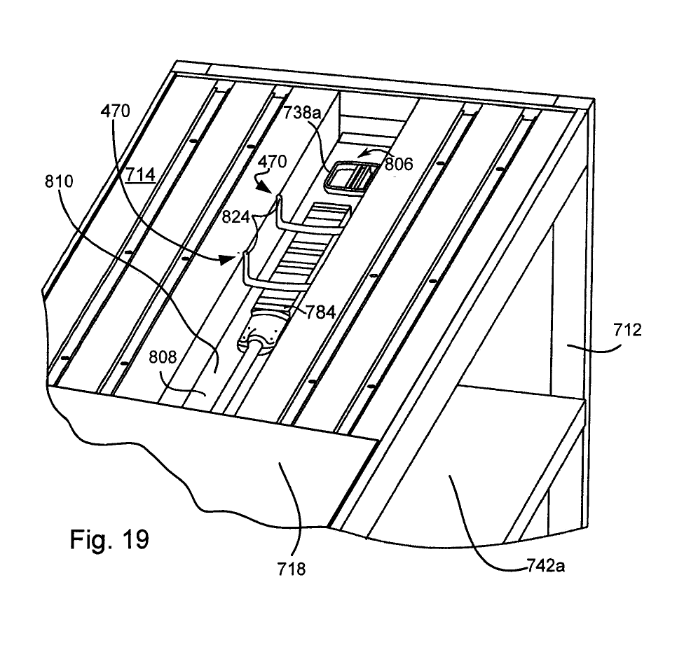

FIG. 5 illustrates yet another work space arrangement including a counter assembly 10 which is shown accommodating three insertable square tiles 18 (or a single ¾ counter length counter infill component), along with a single vertically arranged storage bin 20. Here a work or table surface panel 44A extends outwardly from a shelf 42 on the vertical center panel of the counter assembly. Another work surface panel 44B is attached at an end of the counter assembly 10 at countertop height. Both work surface panels 44A, 44B are supported by a respective frame member 46 of appropriate size. Two privacy panels 41 extend from the work surface panel 44B and another framed privacy screen 43 is attached to the table panel 44A. This privacy panel is formed as a framed screen 43 using a frame member like frame member 12, and with a thin panel inserted within the frame member, as described below. Although not illustrated, an additional privacy panel could be mounted to the counter assembly 18. In addition, an in-vill element (see 18 in FIG. 18) could be provided that includes structure to receive or support an upwardly extending privacy panel or more than one panel.

FIG. 6 illustrates another work space arrangement for two workers including two counter assemblies 10A, 10B arranged end to end. One counter assembly 10A includes a single inserted panel 18A forming a countertop, and the other counter assembly 10B includes three storage bins 20A, 20B, 20C, with the three storage bins including two half depth bins 20B, 20C and a single depth bin 20A all arranged in a vertical position and providing a visual barrier between the work areas, and a panel 18B of half the length of panel 18A. Work surface panels 44 are supported by upright panels 39.

FIG. 7 illustrates a work space arrangement formed by two end to end counter assemblies 10A, 10B and attached work surface panels 44, which together essentially form a large table. One or more storage bins 20 in addition to tiles 18 can be supported by the counter assemblies 10A, 10B.

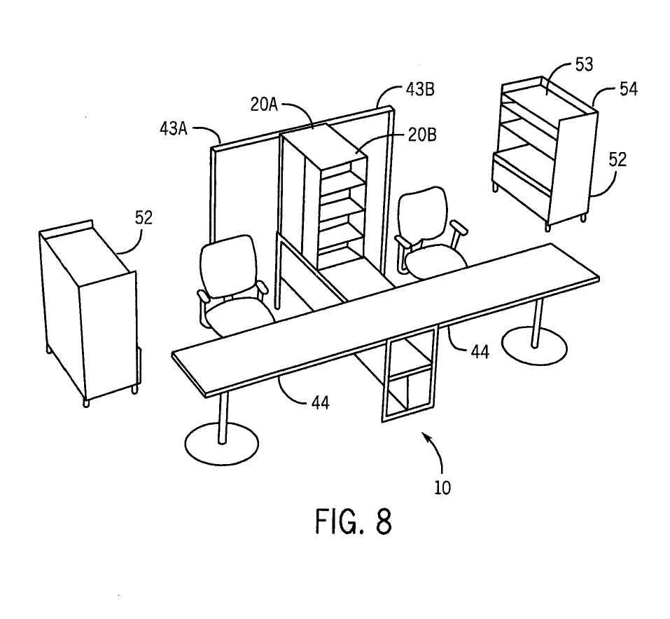

FIG. 8 illustrates a work space arrangement for two workers including a single counter assembly 10 arranged between the separate work areas, with storage bins 20A, 20B supported by the spine member 14, and framed privacy screens 43A, 43B attached to one frame member 12 of the counter assembly 10. Work surface panels 44 extend from the counter assembly at counter top height. Also illustrated in FIG. 8 is a pile file cabinet 52, which also includes an insertable area 53 defined by lips 54, having dimensions slightly greater than X by 2X, to also accommodate a full depth storage bin 20 in a horizontal arrangement or two storage bins in vertical arrangements.

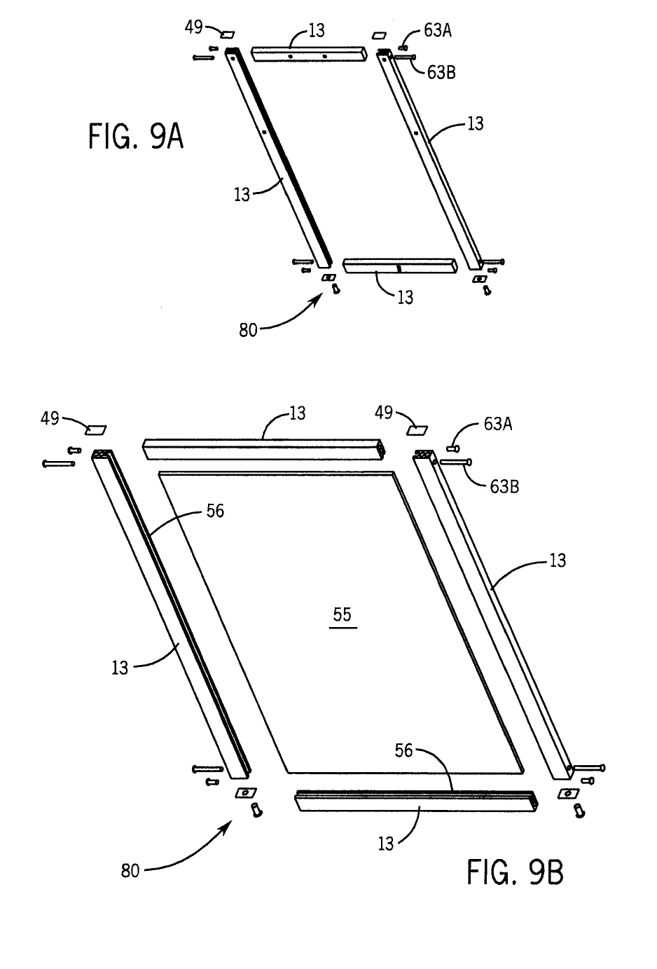

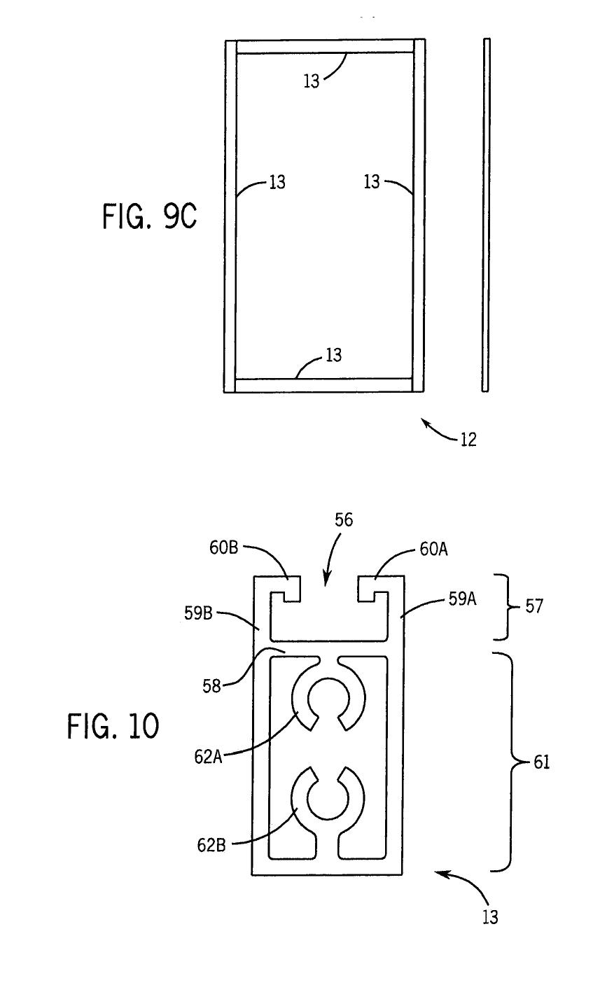

Referring now to FIGS. 9A-13, as mentioned, the frame member 12 is preferably formed by four extruded pieces 13, which are shown separately in the exploded view of FIG. 9A, with a cross sectional view of the extruded pieces shown in FIG. 10, and a view of these pieces assembled together shown in FIG. 9C. Each extruded piece 13 can be cut to a desired length and assembled with others to provide a frame member 12 (or 46) having a desired size. The extruded pieces 13 are preferably attached to one another with two bolts 63 at each joint in a manner to be described. Glides 80 can be attached at the bottom of the frame member. As shown in FIG. 9B, a thin screen infill panel 55 can be inserted within T-shaped channels 56 formed in the extruded pieces 13, which channels open inwardly with respect to the frame member. The thin panel 55 is thus constrained in these channels of a frame member 12 such that a framed privacy screen 43 can be formed. To provide a finished look, a plastic cap 49 can be provided at each corner to fill in the gap area such that the assembled frame member 12 is rectangular (or square) in shape. In an alternative version a fabric screen could be held taught between the members 13.

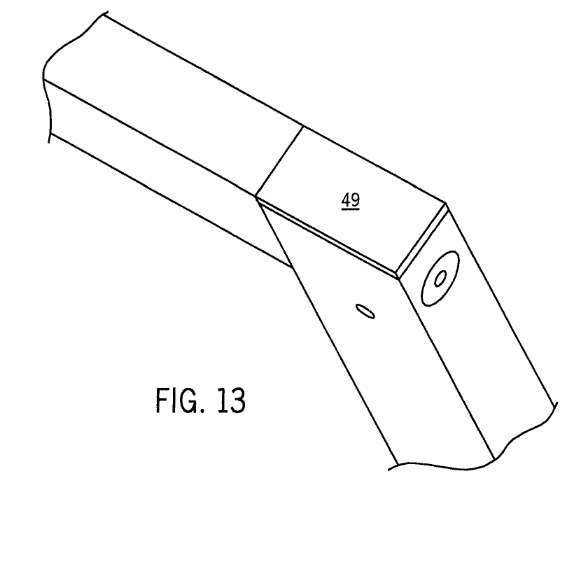

In particular, FIG. 10 shows a cross sectional view of an extruded piece 13. The portion denoted by 57 in FIG. 10 will be facing inwardly when the extruded pieces 13 are assembled to form a frame member 12. This portion includes a wall 58 with two extending flanges 59A, 59B with shoulder portions 60A, 60B which together define T-shaped channel 56. As mentioned above, thin panel 55 is insertable in this channel 56 and will be constrained therein to form a screen 43. Note that thin panel 55 is preferably constructed from the same material as vertical center panel 15, as these panels preferably have the same thickness. Further, the channel 56 can receive a bolt head, as shown in FIG. 12, which can slide along the channel 56 in the length direction of an extruded piece, but is constrained by the shoulder portions 60A, 60B from being removed in a direction perpendicular to those shoulder portions 60A, 60B.

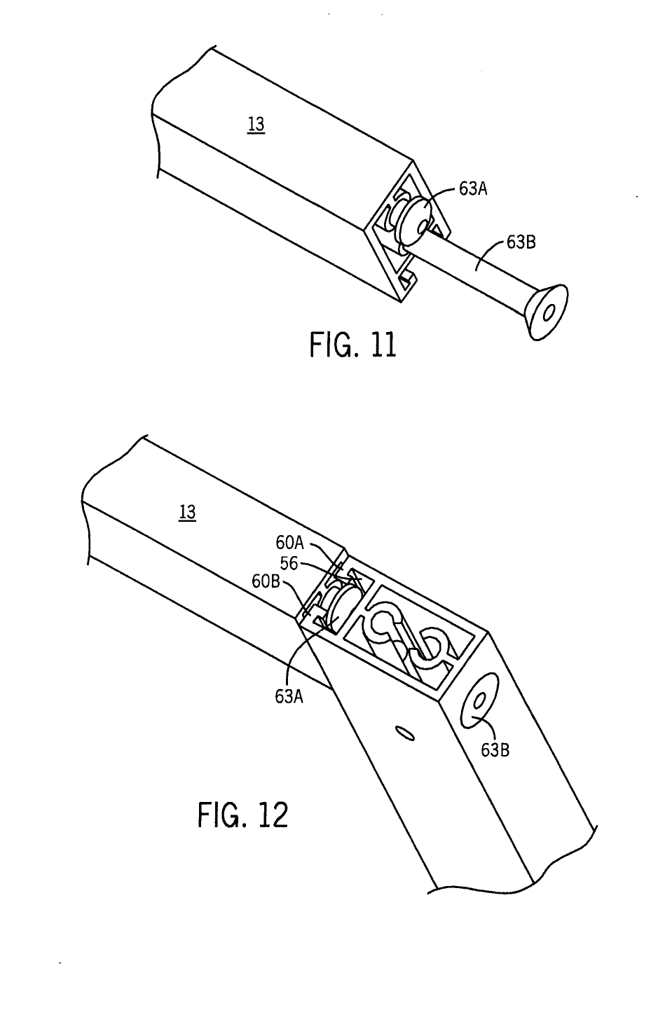

Referring again to FIG. 10, an outer portion 61 of the extruded piece 13 includes two opposing C shaped portions 62A, 62B, each of which can receive a respective bolt 63A, 63B, such as shown in FIG. 11, or other fastener. Thus as illustrated in FIG. 12, to attach one extruded piece to another, at each joint one bolt 63A extends from the channel 56 of an inner portion 57 of a first piece to the outer most C-shaped portion 62B of the second piece, and a second bolt 63B extends through the first piece and into the second C-shaped portion 62A of the second piece. As FIG. 9C makes clear, preferably the horizontal pieces extend between the vertical pieces, such that the vertical pieces have the C-portions accessible on both ends. If the frame member 12 is not to be connected to another frame member (or framed screen 43), then caps 49 at each corner of the frame member 12 can be snapped into place to provide a finished look to each joint, as best seen in FIG. 13. Otherwise, as described in more detail below, the C-shaped portions 62A, 62B of the open ends of the vertical pieces are used as anchors for fasteners for various types of connection pieces to connect a frame member 12 together with another frame member 12 (whether part of a counter assembly or a framed screen 43). Further, three frame members 12 can also be connected together, as can frame members of different heights.

Various views of exemplary spine member 14 are shown in FIG. 14. As mentioned, spine member 14 may be ribbed to increase structural integrity and may include several holes or openings 29, 29A, 29B in trough portion 28, as well as other holes (not illustrated) for attaching work surface panels 44, as described below. FIG. 15 shows a perspective view from the underside of an exemplary spine member 14 and illustrates end support brackets 494 and 496 which fasten to each end of the spine member 14 and which provide vertical surfaces with notches 71 to facilitate attachment to frame members 12.

FIGS. 16A, 16B and 16C show various views of an exemplary grommet 738 which is sized to be inserted in a hole such as 29A or 29B in the bottom wall of the trough portion 28 (labeled 806 in FIG. 16D) of the spine member 14, as shown in FIG. 16D. A top portion of the grommet 738 includes attached back to back D-shaped portions 779a, 779b defining openings 762, 766, with each D-shaped portion including a back portion 775a or 775b and a curved portion 759 or 761. The top portion of grommet 738 also includes two deformable tabs 778a and 778b, each located at the midpoint of a respective curved portion 759 or 761. A bottom portion of the grommet 738 includes two outwardly extending circumferential rim portions 779a and 779b which each extend along a respective curved portion 759 or 761. The bottom portion also includes two parallel flanges 737a and 737b, each extending outwardly from a respective back portion 775a or 775b.

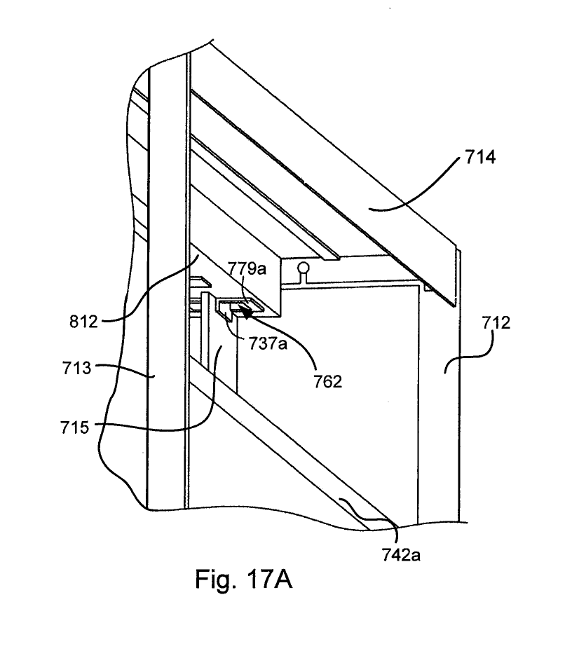

The grommet 738 is inserted in a respective hole 29A, 29B from below the trough portion 806 until the lower edges of the deformable tabs 778a and 778b are snapped into position above the top surface of the bottom wall 34 (810 in FIG. 16D) of the trough portion and prevent the grommet from falling downward (see also FIG. 69). Referring also to FIG. 69, the rim portions 779a and 779b prevent grommet 738 from being pushed completely through the hole 29A or 29B and provide a finished look on the bottom surface of the bottom wall 810 of the trough portion 806. The downwardly extending parallel flanges 737a and 737b then constrain the upper edge of a vertical center panel 715, as best seen in FIGS. 17A. The openings 762 and 764 allow utility lines to extend to and from the channel 806.

In an exemplary embodiment, an extruded piece 19 (shown in FIGS. 1A and 1B), having a cross section such as shown in FIG. 10 and cut to an appropriate size, can be used to provide a finished edge to the lower portion of the counter assembly 10, with the bottom of the center panel 715 being inserted in a T-shaped channel 56 of the extruded piece 19.

FIG. 18 illustrates an end cap 82 which is insertable into the trough portion 806 at an end to close the channel 806 and provide a finished look when the end of the counter assembly 10 is not connected to another component.

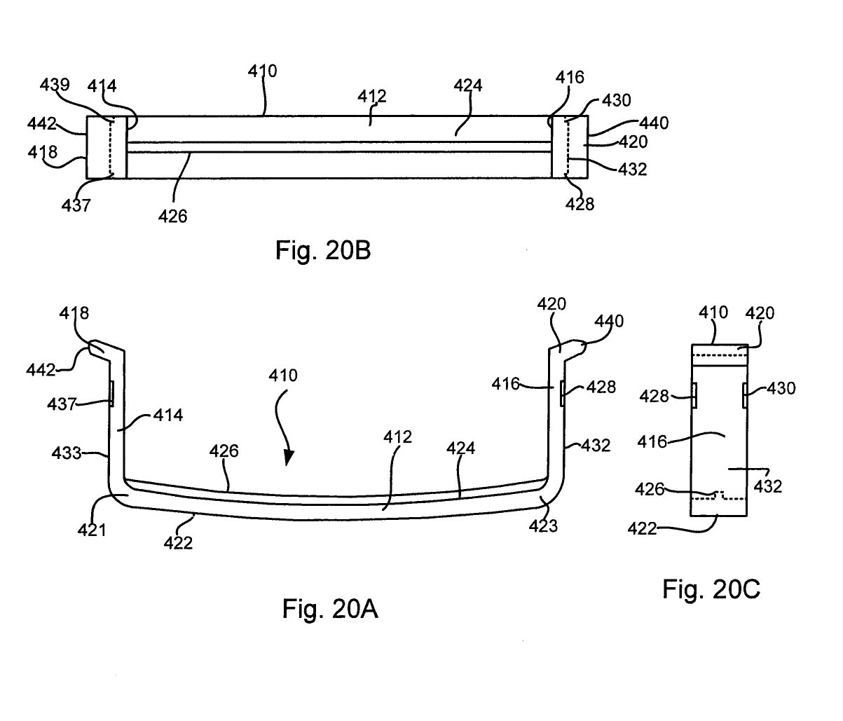

FIG. 19 is a drawing showing an inline electrical connector 784 held in a channel 806 with spring clips 824. The inline electrical connector 784 provides power receptacles that are aligned with holes in a bottom wall 808 of the trough portion 806 and face downwardly such that the receptacles are accessible from underneath exemplary spine member 714. Different views of one embodiment of an appropriate spring clip 410 (also 824 in FIG. 19) are shown in FIGS. 20A through 20C. Exemplary spring clip 410 is U-shaped with outwardly extending fingers 418 and 420 which are insertable in holes 470 formed at top edges of the trough portion 806. A respective finger 418, 420 is inserted in a respective hole 470, and a bottom portion of the U portion of each spring clip 410 makes contact with the inline electrical connector 784, which forces the fingers 410, 420 outwardly and helps constrain the connector 784 in the channel 806. More force exerted on the spring clip results in the fingers more tightly fixed in the holes 470.

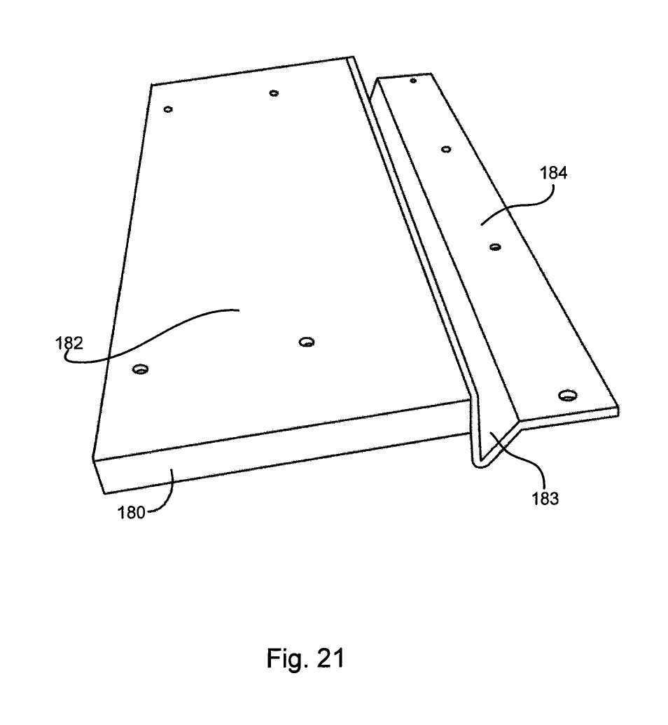

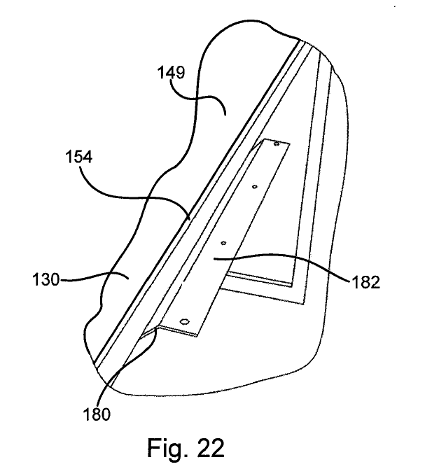

FIG. 21 illustrates a support bracket 108 that may be used to connect a work surface panel (see 44 in FIG. 2) to a spine member (see 14 in FIG. 22) of a counter assembly. Support bracket 180 includes a portion 182 which fastens to the spine member 14 and a portion 184 which fastens to a work surface panel (not shown in FIG. 22). Portion 182 is positioned underneath the spine member as shown in FIG. 22 and is then attached using fasteners that extend through first corresponding holes in the spine member and the bracket, and fasteners that extend through second corresponding holes in the work surface panel and the bracket.

As noted above, various types of connection pieces are used to connect a frame member 12 to one or two other frame members 12. Further, frame members of different heights can also be connected together.

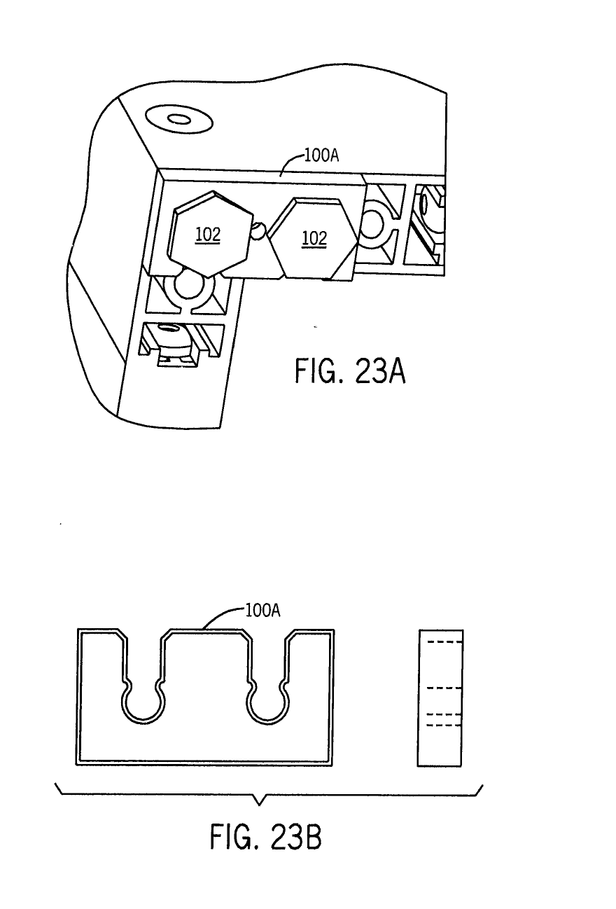

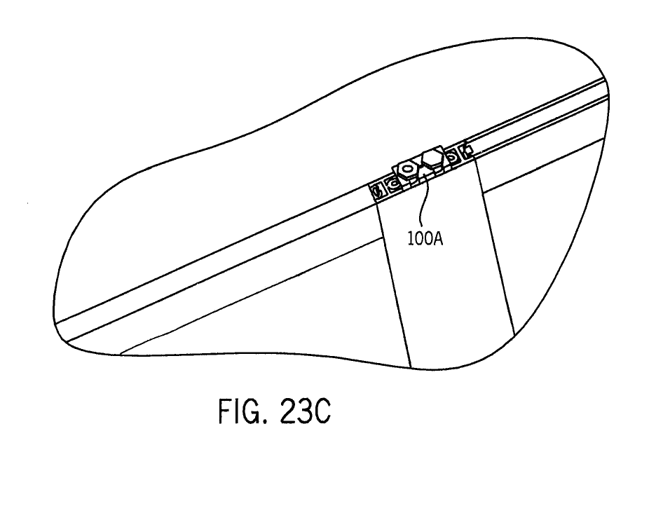

Referring to FIGS. 23A-C, one embodiment of a connection piece 100A is illustrated which is used with two fasteners 102 to connect two frame members together at the lower ends thereof. This connection piece 100A can be used to connect two frame members which are perpendicular to each other, as shown in FIG. 23A, or are in-line with each other, as shown in FIG. 23C. The fasteners 102 extend through a respective C-shaped portion of an extruded piece of a frame member.

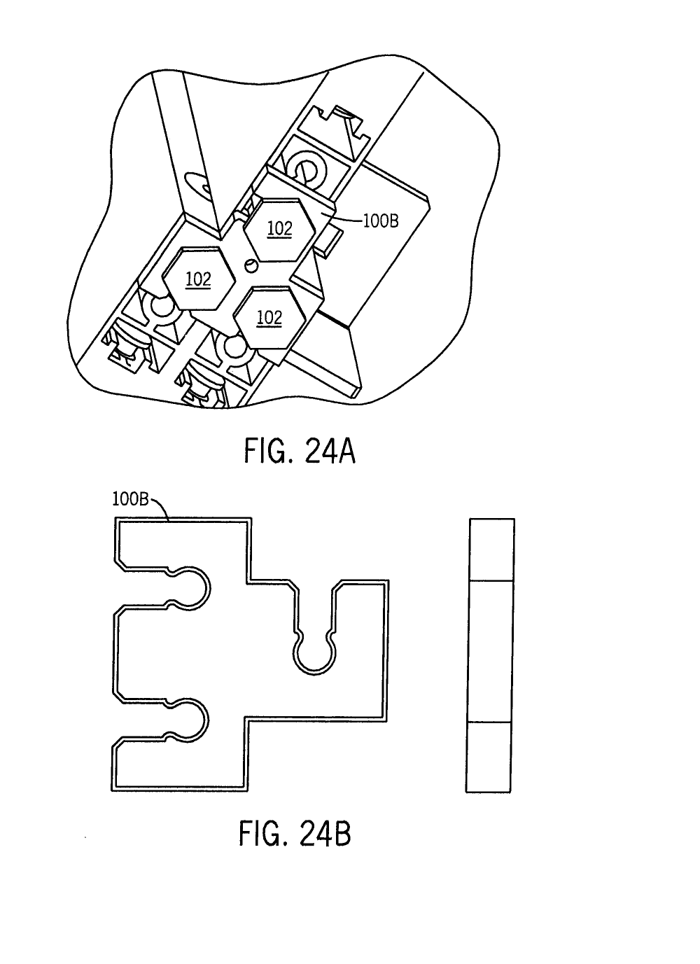

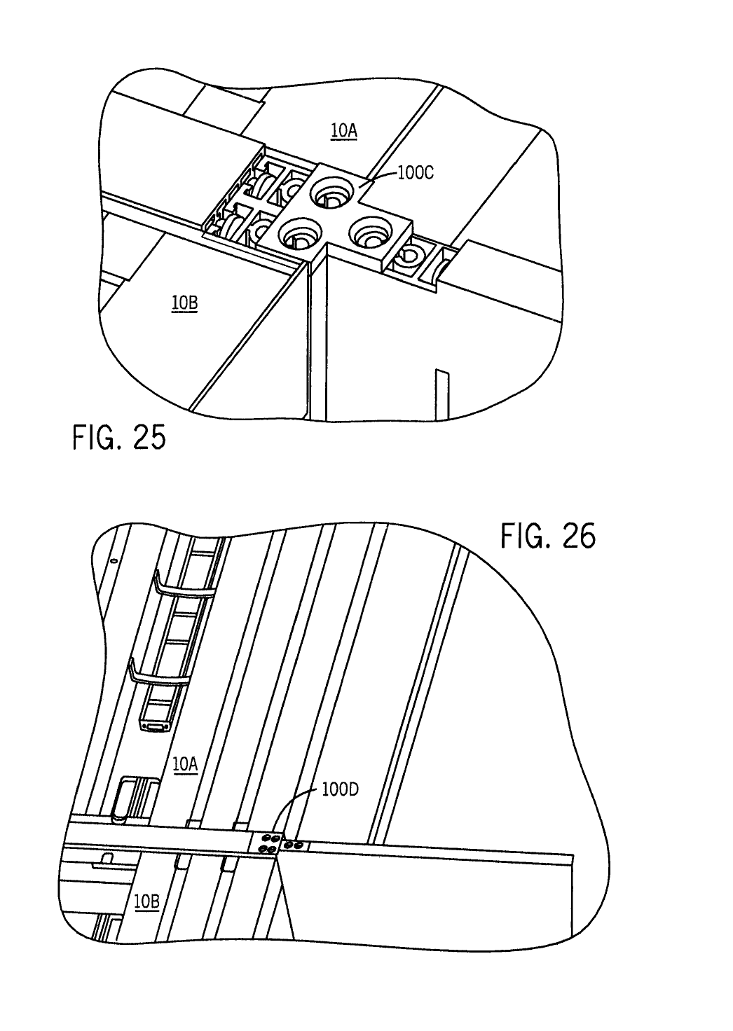

Similarly, with respect to FIGS. 24A-B, a connection piece 100B is illustrated which is used with three fasteners 102 to connect three frame members together at the lower ends thereof. This connection piece 100B can be used to connect two frame members which are side by side with each other (such as two end to end counter assemblies) with another frame member extending outwardly from the counter assemblies. The fasteners 102 extend through a respective C-shaped portions 62A, 62B of a respective extruded piece of each frame member.

As shown in FIG. 25, a three way connection piece 100C is used with fasteners (not shown) to connect together at their upper ends three frame members which have the same height, such as where two of the frame members are end to end counter assemblies 10A, 10B, and the other frame member extends outwardly from the counter assemblies.

As shown in FIG. 26, a three way connection piece 100D is used with fasteners (not shown) to connect together at their upper ends three frame members which have the same height, wherein two of the frame members are adjacent to each other as part of counter assemblies 10A and 10B arranged end to end. The third frame member extends outwardly from the counter assemblies.

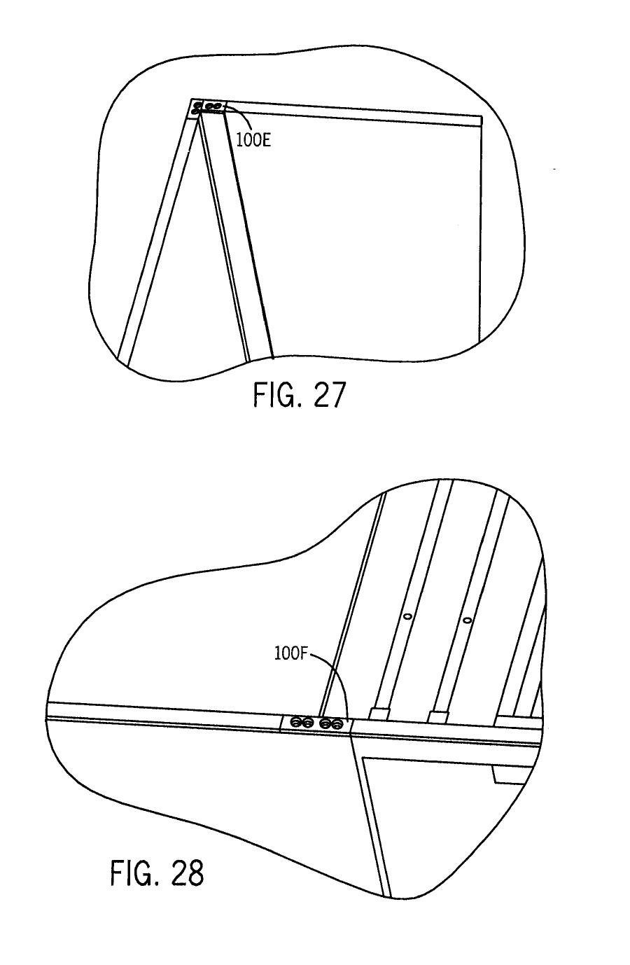

As shown in FIG. 27, an L-shaped two way connection piece 100E is used with fasteners (not shown) to connect together at their upper ends two frame members which have the same height and are at right angles to each other.

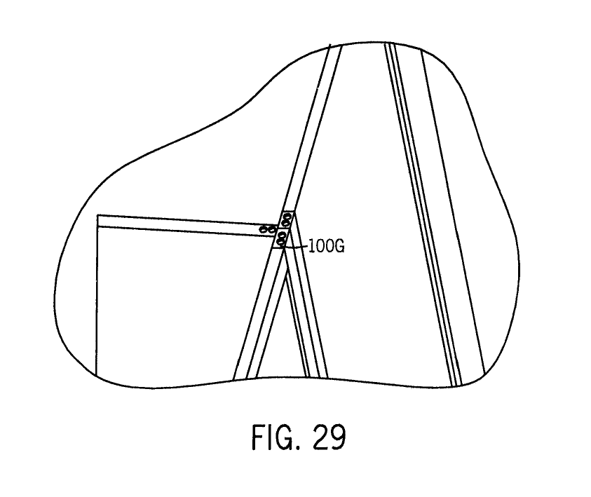

As shown in FIG. 28, an in-line two way connection piece 100F is used with fasteners (not shown) to connect together at their upper ends two frame members which have the same height and are in-line with each other.

As shown in FIG. 29, a T-shaped three way connection piece 100G is used with fasteners (not shown) to connect together at their upper ends three frame members which have the same height, with two of the frame members being in line with each other, and the third frame member being perpendicular to the other two.

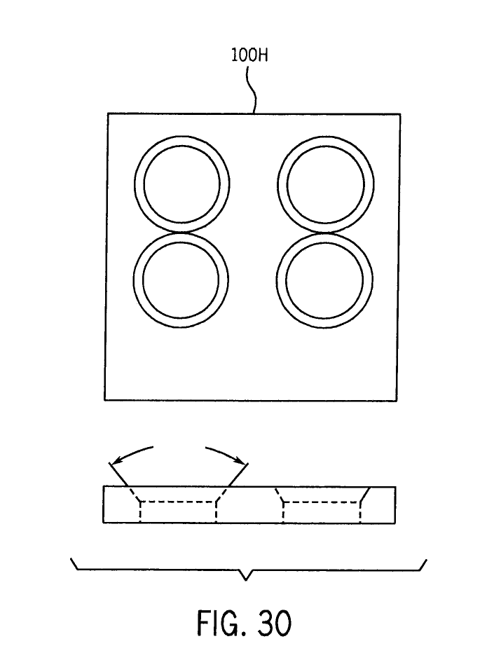

FIG. 30 illustrates a two way connection piece 100H which is similar to the connection piece shown in FIG. 26, but which is used with fasteners to connect together at their upper ends two frame members of respective counter assemblies having the same height and which are arranged end to end.

In other embodiments, connection pieces can take different forms such as an X shape.

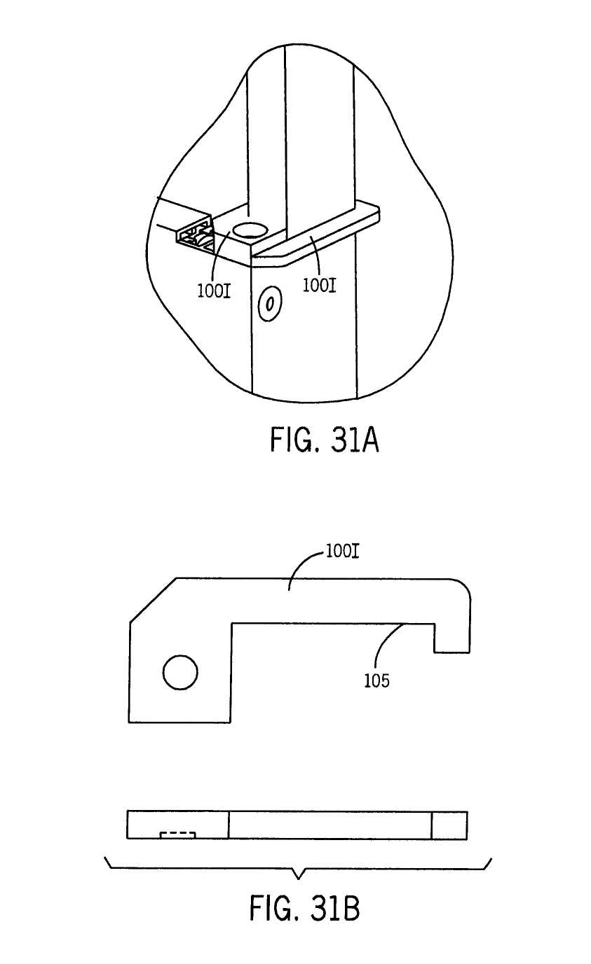

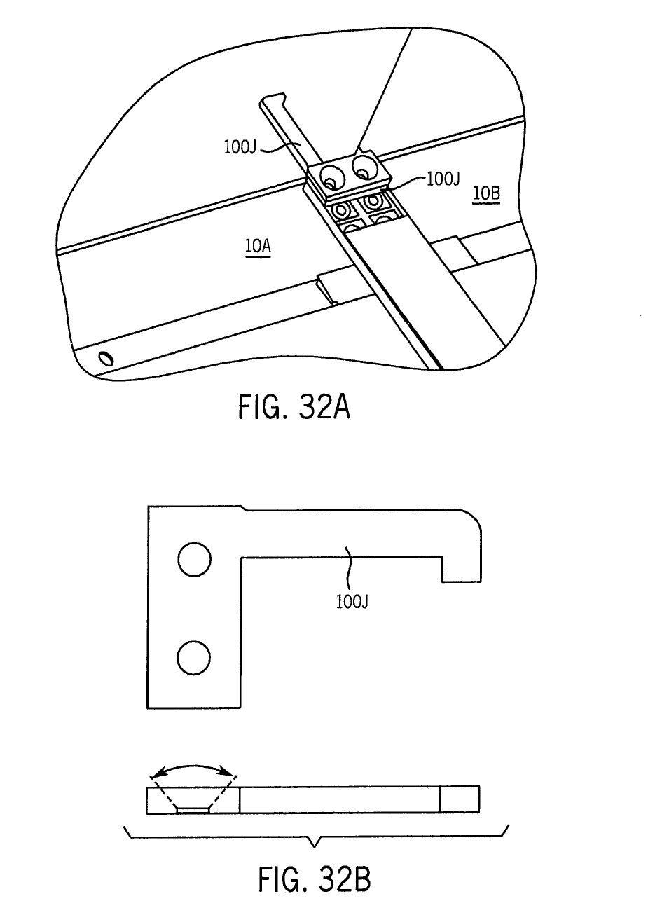

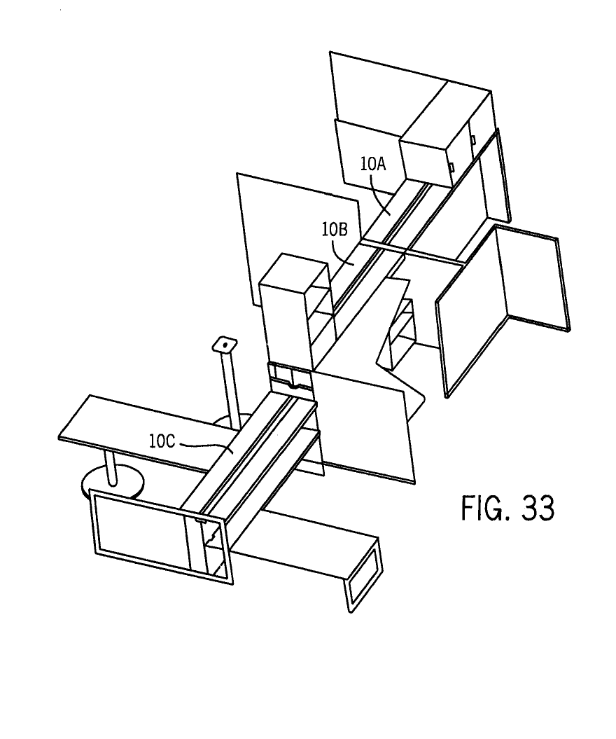

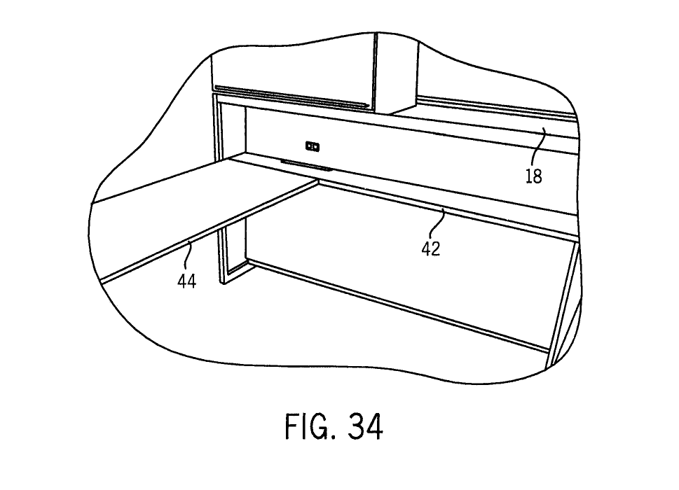

Other connection pieces such as shown in FIGS. 31B and 32B are used when connecting frame members having different heights. For example, as shown in Fig. 31A, a pair of connection pieces 100I are used with a fastener (not shown) to connect one frame member at right angles to another frame member, where these two frame members are of differing heights. Here, a gripping finger 105 of each connection piece 100I wraps partially around the adjacent extruded piece of the taller frame member, such that the two together hold it in place. Using this embodiment with a single fastener allows each connection piece to pivot around the fastener and into position around the adjacent extruded piece.

Similarly, as shown in FIG. 32A, a pair of connection pieces 100J are used with two fasteners (not shown) to connect two adjacent frame members of end to end counter assemblies to a taller frame member. Again, a gripping finger 106 of each connection piece 100J wraps partially around the adjacent extruded piece of the taller frame member, such that the two together hold it in place.

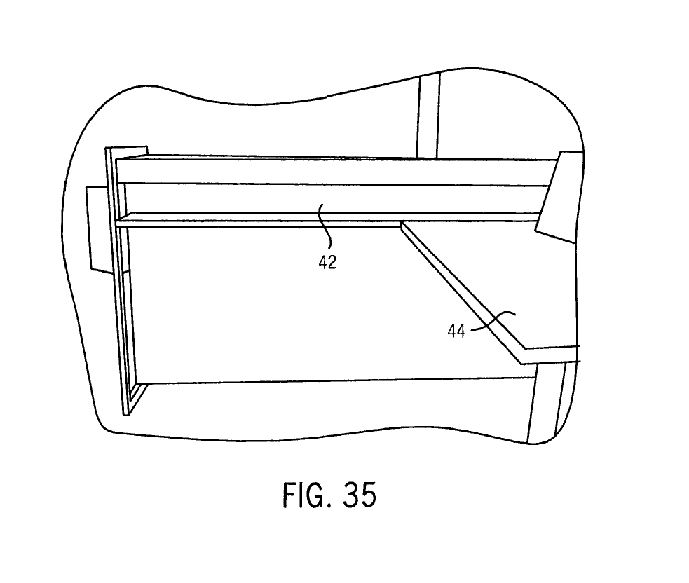

FIGS. 34 and 35 each illustrate a counter assembly along with a work surface panel 44 extending from a shelf 42. In FIG. 34, the countertop or panel formed by tile 18 is at a desk height, and the shelf 42 and work surface panel 44 are at a coffee table height. In FIG. 35, the countertop or surface formed by tile 18 is at a counter height, and the shelf 42 and work surface panel 44 are at a desk height.

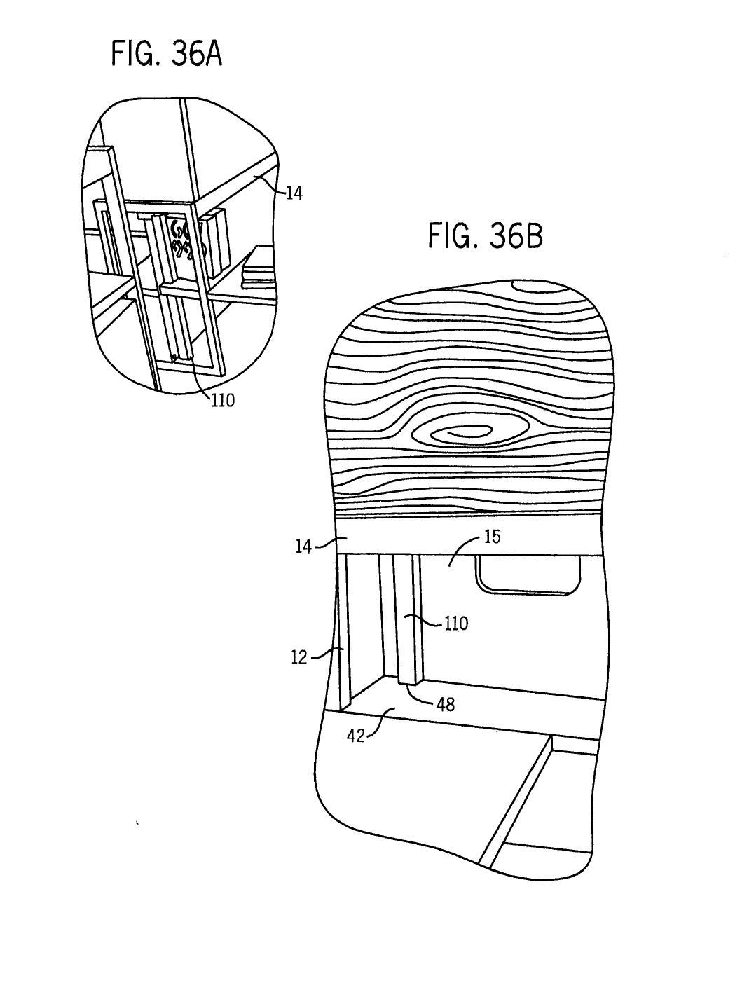

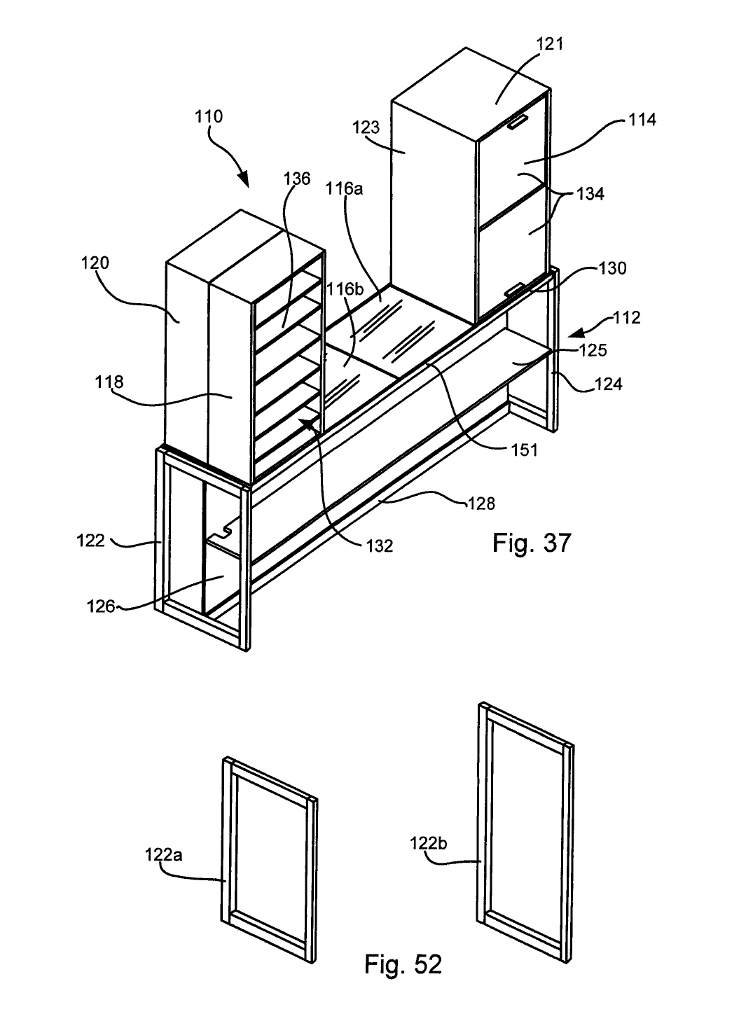

FIGS. 36A and 36B each illustrate a portion of the counter assembly and show a cover piece 110 which extends between the trough portion and the floor for concealment of utility lines extending to or from the floor. The cover piece 111 does not require fasteners, since it is held in place by the notch 48 in shelf 42.

B. More Detailed Description

Hereafter a more detailed description of the above systems and components is provided including separate descriptions of a kit of parts that can be used to assemble various configurations, the work surface substrate shown in FIGS. 14, 15 and 19, the receptacle clip shown above in FIGS. 19 and 20A-20C, the combined cable grommet and panel clip assembly shown in FIGS. 16A, 16B, and 16C and the sliding door cabinet assembly shown in FIGS. 2 and 7.

1. Kit of Parts

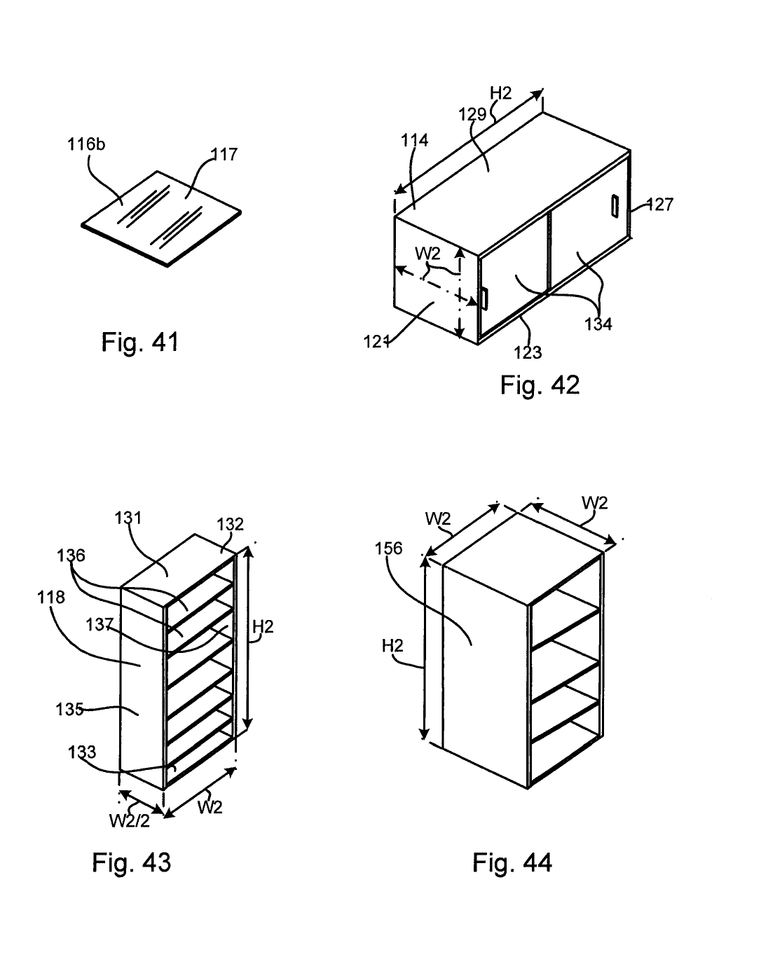

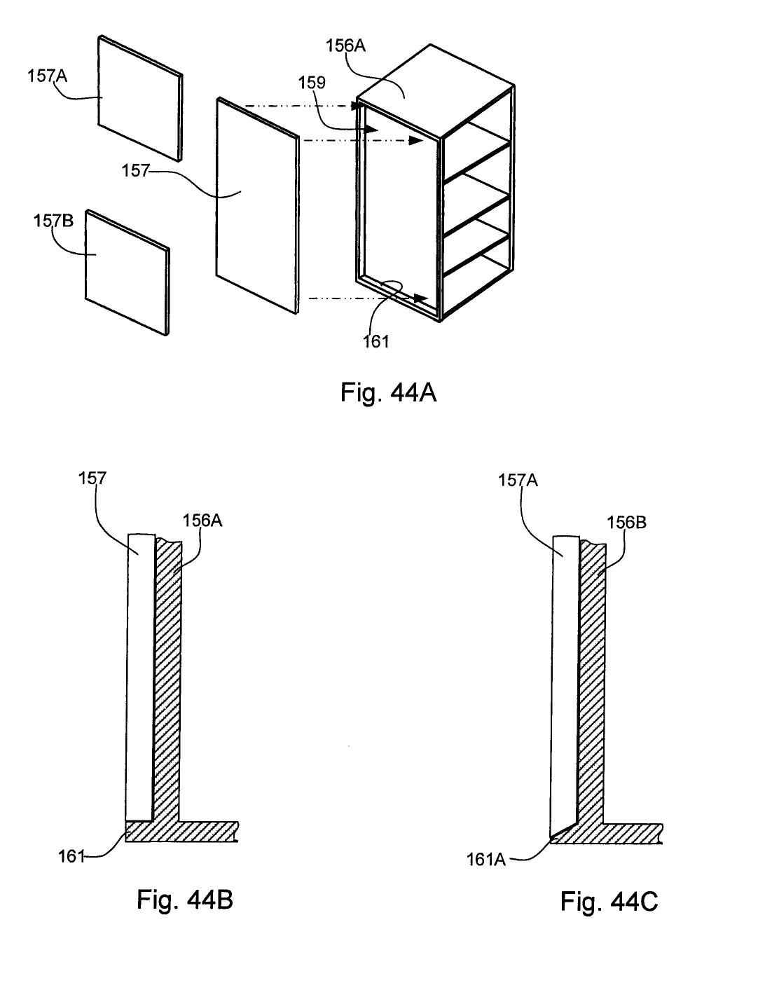

Hereinafter several furniture assemblies are described where each assembly generally includes at least a table/counter assembly 112 (see FIG. 37) that forms a top surface 149 (see FIG. 8) and a different subset of a plurality of furniture components that are supported on top support surface 149. Exemplary furniture components include tile members 116b (see FIG. 41), cabinet units 114 (see FIG. 42), half-depth shelf units 118 (see FIG. 43) and full depth shelf units 156 (see FIG. 44). While each unit and tile member includes at least a bottom wall or member that is received on the support surface 149, it has been recognized that other furniture components that may be used with the inventive system may not include a bottom wall member. For instance, a cabinet unit may include a box-like bottom skirt at a lower end where a bottom edge of the skirt is received on the support surface 149. Similarly, a tile member may include stand off foot members on a lower surface that abut support surface 149 when the tile member is supported thereby. For this reason, where widths and lengths of tiles and storage units are described hereafter, it should be appreciated that those dimensions should be read broadly as referring to dimensions of base structure generally.

Referring now to FIGS. 37-40, the exemplary kit of parts concepts will be described in the context of an exemplary furniture assembly 110 that includes a table/counter assembly 112, a cabinet unit 114, first and second tile members 116a and 116b, respectively, and first and second half-depth shelf units 118 and 120, respectively. Table/counter assembly 112 includes, among other components, first and second frame-type leg members 120 and 122, respectively, a sub-structure or spine member 130, a shelf member 125, a center privacy panel 126 and a finishing or panel support bar 128. Each frame member 122 and 124 is similarly constructed and operates in a similar fashion and therefore, in the interest of simplifying this explanation, only member 122 will be described here in any detail. Member 122 includes rigid and extruded top and bottom members and rigid and extruded first and second lateral members that are secured at their ends to form a rectilinear frame member.

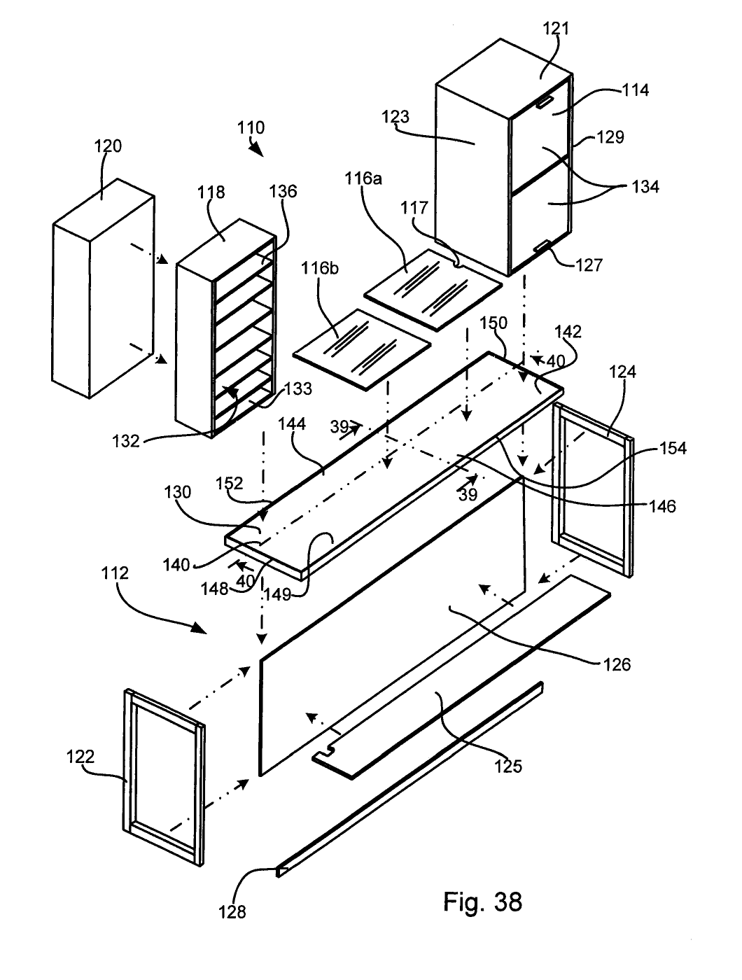

Referring still to FIGS. 37 and 38, privacy panel 126 is a flat and substantially planar, rigid and rectangular member that includes oppositely facing first and second sides surfaces, top and bottom edges and first and second lateral edges, none of which are labeled in the figures. Panel support bar 128 is an extruded member similar to the members that are used to form frame members 122 and 124 and forms a slot (not illustrated) along the top surface for receiving a bottom edge of panel member 126. Opposite ends of bar 128 include screws receiving openings (not labeled or illustrated) for mounting bar 128 to frame members 122 and 124.

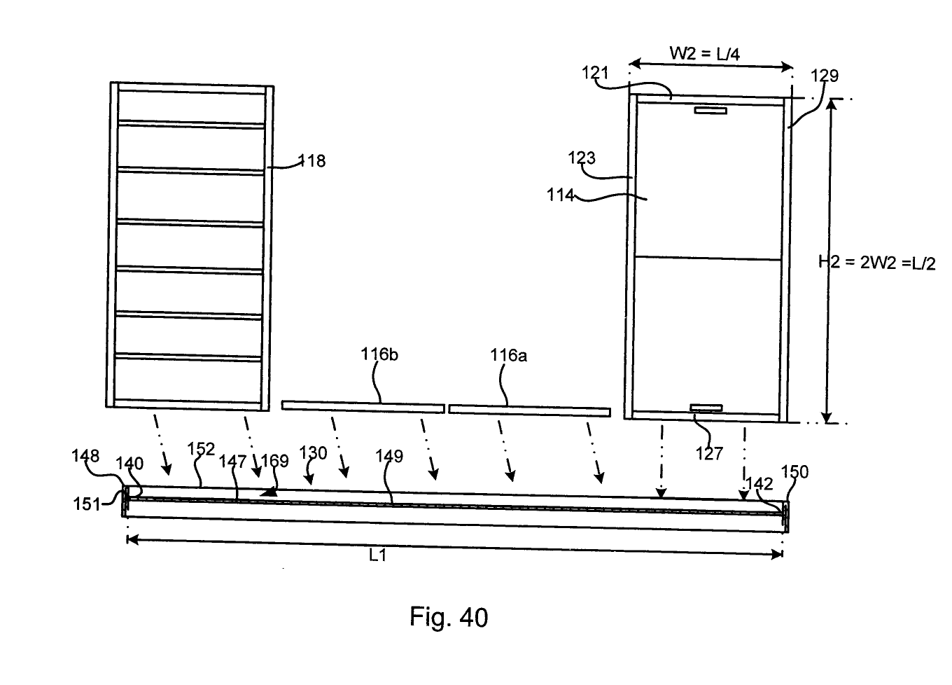

Referring to FIGS. 38 and 40, sub-structure 130 includes a rigid, planar and substantially rectilinear plate member 147 and a circumferential lip 151 that circumscribes the outer edge of plate member 147. Thus, plate member 147 includes first and second ends or edges 140 and 142, respectively, and first and second lateral edges 144 and 146, respectively. Plate member 147 has a structure length dimension L1 between edges 140 and 142 and has a structure width dimension W1 between lateral edges 144 and 146 and forms a top support surface identified by numeral 149 throughout the figures.

Referring still to FIGS. 38 through 40, circumferential lip 151 includes a lip portion 148 extending along first end edge 140, a lip portion 150 that extends along the second end edge 142, a lip portion 152 that extends along the first lateral edge 144 and a lip portion 154 that extends along second lateral edge 146. Lip 151 has a height dimension H1 (see FIG. 39). In at least some embodiments, lip height H1 is between ¼ inch and one inch. Thus, sub-structure 130 forms a receiving space 169 adjacent surface 149 and defined by lip 151.

Referring to FIG. 38, shelf member 125 is a rigid, elongated rectilinear member that has a length dimension (not labeled) substantially equal to the length L1 of sub-structure 130 and has a width (not labeled) that is substantially equal to one half the width W1 of sub-structure 130. When one of the storage units (e.g., 118, 121, etc.) is supported on surface 149, the unit forms a storage space (e.g., 132) that resides at least in part above the furniture receiving space 169.

To assemble table/counter assembly 112, referring to FIG. 38, bar 128 is mounted to members 122 and 124 with the slot formed thereby facing upward. A bottom edge of panel 126 is received in the upward facing slot formed by member 128. Although not shown, some type of bracket may be mounted to an undersurface of sub-structure 130 for receiving the top edge of privacy panel 126. Sub-structure 130 is secured to the top edge of privacy panel 126 and between first and second support structures or leg members 122 and 124. For example, although not shown, screws may be used to secure sub-structure 130 to facing surfaces and at the top ends of leg members 122 and 124.

Referring again to FIG. 38, tile members 116a and 116b are similarly constructed and operate in a similar fashion and therefore, an interest of simplifying this explanation, only tile member 116b will be described here in any detail. Referring also to FIGS. 39-41, tile member 116b is a square, rigid and flat member that has a width dimension W2 (see FIG. 39) that is substantially equal to (e.g., slightly smaller than) width dimension W1 formed by lip member 151 and a length dimension (not labeled) that is equal to width dimension W2. Tile member 116b forms a top surface 117 and an oppositely facing bottom surface 119. Here, top surface 117 may serve as a work surface and, to that end, in some embodiments, will have a finished appearance. For example, top surface 117 may be formed by a laminated piece of wood. In other embodiments, member 116b may be formed of Corian, glass or some other type of material, such as tile or the like. Tile member 116b has a thickness dimension T1 where, in several embodiments, thickness T1 is substantially equal to the height dimension H1 of lip member 151 (see again FIG. 39). Thus, it should be appreciated that, when tile member 116b is positioned within receiving space 169 adjacent support surface 149 so that bottom surface 119 of tile member 116b abuts surface 149, top surface 117 will be substantially flush with the distal or top edge of lip member 151. In addition, it should be appreciated that, after tile member 116b is placed within the receiving space adjacent support surface 149, lateral lip members or portions 152 and 154 restrict lateral movement of tile member 116b such that member 116b will be retained within the receiving space unless affirmatively removed.

Referring once again to FIGS. 37, 38, and 40 and also FIG. 42, exemplary cabinet unit 114 is a rectilinear cabinet structure that includes a top wall member 121, a bottom wall member 127, first and second lateral side wall members 123 and 129, a rear wall member (not illustrated/labeled) and first and second door members collectively identified by numeral 134. The wall members including members 121, 123, 127 and 129 as well as the rear wall member form a rectilinear cavity (not labeled) that is open to one side. Door members 134 are mounted for sliding motion within the open side of a cavity for optionally opening and closing that side to allow and block access to the cavity.

Referring specifically to FIGS. 40 and 42, top and bottom wall members 121 and 127 are square and have edge dimensions that are equal to the width dimension W2 of tile 116b. Side wall members 123 and 129 have height dimensions H2 that are equal to twice the width dimension W2. Thus, the surface area of the external surface formed by lateral side wall 129 is twice the surface area of the top surface 117 of tile member 116b.

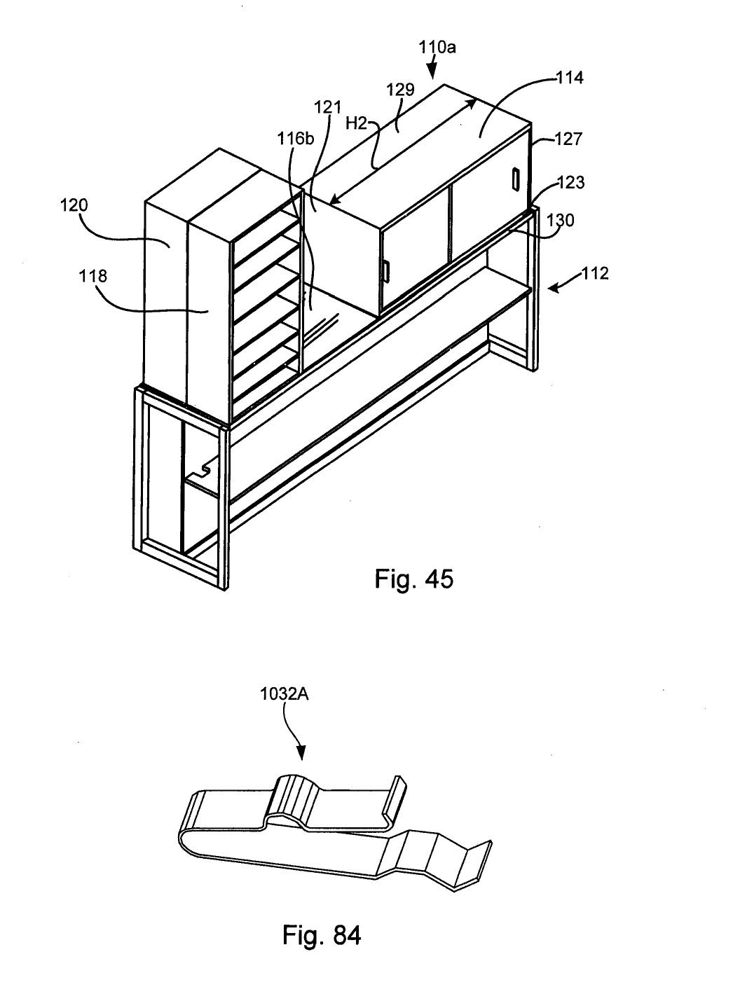

Referring once again to FIGS. 43 and 45, exemplary half-depth shelf units 118 and 120 are similarly constructed and operate in a similar fashion and therefore, in the interest of simplifying this explanation, only half-depth shelf unit 118 will be described here in detail. Referring to also FIG. 40, half-depth shelf unit 118 includes top wall member 131, bottom wall member 133, first and second lateral side wall members 135 and 137, respectively, a rear-wall (not illustrated or labeled) and a plurality of shelf members collectively identified by numeral 136. Wall members 131, 133, 135, 137 and the rear wall member together form a rectilinear cavity 132 that is opened to one side. Shelf members 136 are mounted within the cavity 132 and are generally equi-spaced along a height dimension thereof. Unit 118 has a length dimension defined by the oppositely facing surfaces of lateral side wall members 135 and 137 that is equal to width dimension W2 of tile 116b and has a width dimension along the short edge of wall member 135 substantially equal to one-half the width dimension W2 of tile member 116b. Unit 118 has a height dimension that is equal to the height dimension H2 of cabinet unit 114 described above and therefore, has a height that is substantially equal to twice the width dimension W2.

An exemplary full depth shelf unit 156 is shown in FIG. 44 and includes width and depth dimensions that are each W2 and a height dimension H2. Unit 156 is open to one side and includes a plurality of shelf members. In some embodiments other versions of unit 156 may be open on two opposite sides or on two adjacent sides.

Referring to FIG. 44A, a full depth shelf unit 156A is illustrated that includes a recessed external side surface 159 where a lip 161 circumscribes the recessed surface 159. In at least some embodiments lip 161 may protrude from surface 159 by two inches although other protruding depths (e.g., ¼ inch to 2 inches) are contemplated. Here it is contemplated that a plurality of insert components (only one 157 shown) may be provided where the insert components may be functional, decorative or both. For instance, one insert component 157 may be a slat wall type insert that includes horizontal rails for mounting office accessories (e.g., paper holder, a pencil holder, a phone shelf, a monitor arm, etc.). Other insert components may include a whiteboard surface forming member, a cork board member, a magnetic board, a decorative facia panel, etc. Inserts have dimensions similar to the dimensions of recessed surface 159 and may be attached within the recess in any manner including, but not limited to, magnetically (e.g., where surface 159 is metal), mechanically, adhesively, etc. Once inserted, in at least some embodiments, the first surface of the insert will be flush with or substantially flush with a surface plane formed in the distal edge of lip member 161 as shown in FIG. 44B so that the side of unit 156A will have a generally finished appearance. Referring to FIG. 44C, in some embodiments a unit 156B will include a chamfered lip 161A and inserts 157A will include matching chamfered edges that mirror the lip chamfer so that an even clearer appearance results.

While only one lateral surface is shown recessed in FIG. 44A, it should be appreciated that any side, back, top or bottom surface of unit 156A may be recessed to receive an insert and that two or more surfaces may be recessed on one unit 156A. In addition, referring to FIGS. 42 and 43, other units including a sliding door cabinet and a half-depth shelf unit may also be recessed.

Referring again to FIG. 44A, in some cases it is contemplated that two or more inserts 157A, 157B may be dimensioned so that the combination thereof will fill the recessed space 159. Here, two differently appearing or functioning inserts 157A, 157B may be combined as desired. For instance, insert 157A may include a slat wall surface while insert 157B includes a whiteboard surface.

Referring once again to FIGS. 37, 38 and 40, after table/counter assembly 112 has been assembled, other assembly 110 components (e.g., furniture units) including cabinet unit 114, tile members 116a and 116b and half-depth shelf units 118 and 120 can be installed as follows. First, cabinet unit 114 can be placed above support surface 149 near second end edge 142 and can be lowered until an undersurface of bottom wall member 127 abuts support surface 149 and with an outer surface of side wall member 129 abutting an adjacent surface formed by lip portion or member 150. At this point, front and rear edges of bottom wall member 127 should be immediately adjacent facing surfaces of lip portions for members 152 and 154, respectively.

Continuing, tile member 116a can be aligned above support surface 149 and lowered until the bottom surface 119 thereof abuts support surface 149. Tile member 116a can be slid toward cabinet unit 121 until an edge thereof abuts the exterior surface of wall member 123. Tile member 116b is next aligned above support surface 149, is lowered until a bottom surface 119 thereof abuts support surface 149 and is then slid toward tile member 116a until facing edges abut.

Referring still to FIGS. 38 and 40, half-depth shelf unit 118 is aligned above the exposed portion of support surface 149 with the cavity 132 opening toward lip portion 154. Unit 118 is lowered until an undersurface thereof contacts support surface 149 and so that bottom wall member 133 resides generally in the space between tile member 116b and lip portion 148. Next, half depth shelf unit 120 is aligned with the remaining exposed portion of support surface 149 and is lowered into place.

At this point it should be appreciated that the assembly 110 shown in FIG. 37 has been completely configured. Here, after placement of units 114, 118 and 120 and tile members 116a and 116b, each of the units and tile members should be retained within the space defined by the circumferential lip 151 unless affirmatively lifted from the support surface.

While the assembly shown in FIG. 37 may be useful, one of the primary advantages of the inventive furniture system is that tile members and storage units may be configured quickly in several different ways to accommodate specific needs of system users and easily and without the need for special tools or skills. To this end, referring now to FIG. 45, a second exemplary furniture assembly 110a is shown that includes all of the components described above with respect to FIGS. 37 through 43 except for tile member 116a. To this end, assembly 110a includes table/counter assembly 112, cabinet unit 114, tile member 116b and half-depth shelf units 118 and 120. The only difference between assemblies 110 and 110a is that cabinet unit 114 has been tipped over on its side 123 so that its height dimension H2 is arranged horizontally as opposed to vertically and so that side wall member 123 occupies the space that was occupied by bottom wall member 127 and tile member 116a in FIG. 37. Thus, assembly 110a has a smaller work surface formed by tile member 116b and a horizontally arranged cabinet 114.

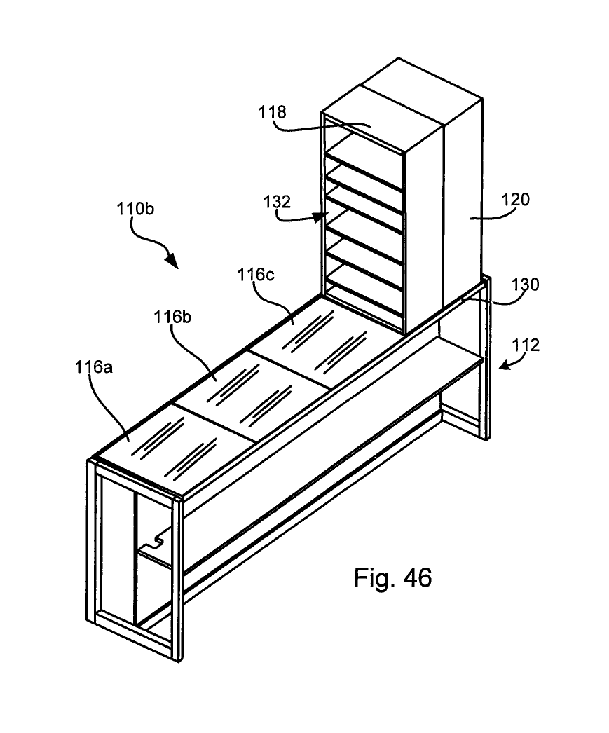

Referring now to FIG. 46, another furniture assembly 110b is shown that includes a table/counter assembly 112, first and second half-depth shelf units 118 and 120, respectively, and first, second and third tile members 116a, 116b and 116c, respectively. Here, units 118 and 120 are arranged so that rear surfaces thereof extend between the lateral edges of sub-structure 130 and therefore the cavities (132 formed by units 118 and 120 face the end edges of member 130. Together, units 118 and 120 and tile members 116a, 116b and 116c completely cover the support surface of sub-structure member 130.

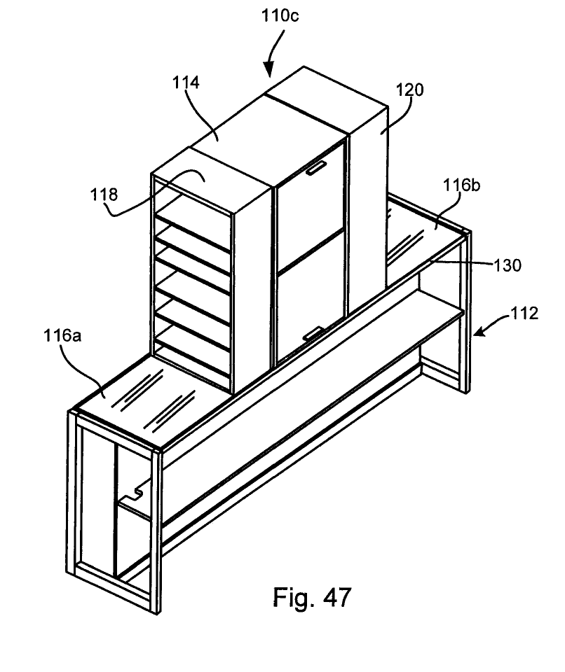

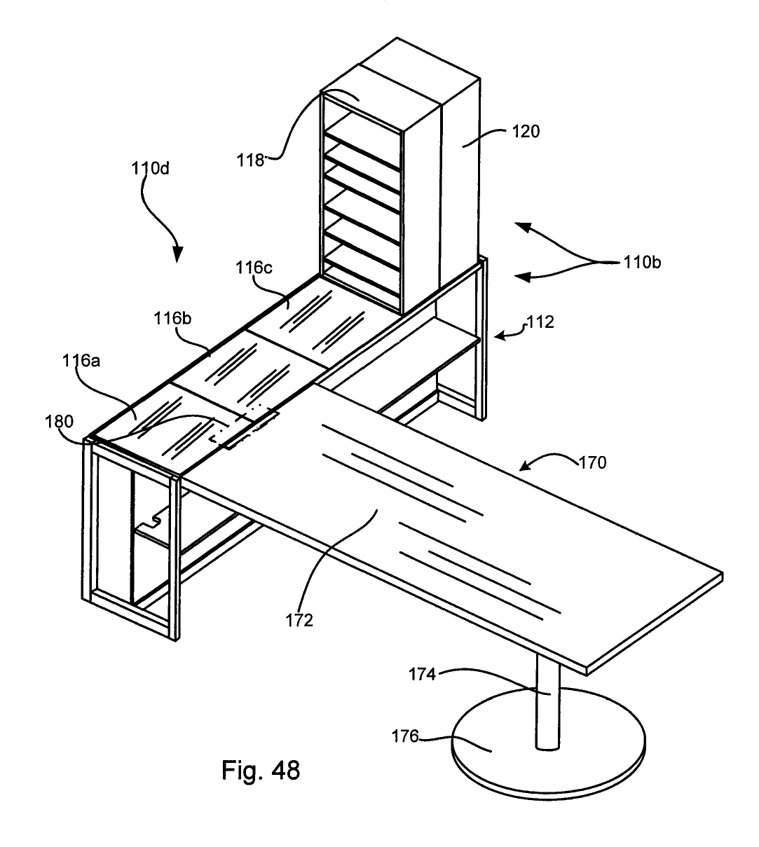

Referring now to FIG. 47, another furniture assembly 110c constructed using the components shown in FIG. 37 is illustrated. Here, cabinet unit 114 is centrally located within the receiving space formed by sub-structure member 130 with half depth shelf units 118 and 120 on opposite sides thereof and tile members 116a and 116b received at opposite ends of the receiving space. While four different configurations are shown in FIGS. 37, 45, 46 and 47, it should be appreciated that the storage units and tiles described above and other instances of those units and tiles can be combined in different subsets and supported by sub-structure member 130 in different configurations to accommodate various needs of system users. Moreover, it should be appreciated that changing from one configuration to another is extremely easy as storage units and tiles simply have to be lifted out of the receiving space and repositioned in different orders. For instance, referring again to FIG. 37, if more cabinet space is desired, shelf units 118 and 120 and file members 116a and 116b may be removed and replaced by second, third and fourth instances of cabinet unit 114. Where deeper shelves are needed to one side of assembly 110, units 118 and 120 may be replaced by a full depth shelf unit (see 156 in FIG. 44).

It should also be appreciated that none of the storage units (e.g., 118, 120, 114) described above includes special mounting fasteners and instead, gravity and lip 151 are relied upon to retain the units on top of the support surface 149. This is an important feature because it means that when a storage unit is removed from surface 149, the unit can be used independent of other system structure. For instance, if cabinet unit 114 in FIG. 37 were no longer needed at an office, unit 114 could be taken home and used for personal use by an employee and hence unit is easily recyclable for other uses independent of the overall system.

The assemblies described above can be combined with other components to provide even more functional configurations. To this end, referring to FIG. 48, another furniture assembly 110d is illustrated that includes a table assembly 170 in addition to the furniture assembly 110b shown in FIG. 46. Here, table assembly 170 includes a rectilinear tabletop member 172, a bracket 180, a leg member 174 and a foot member 176. Referring also to FIG. 49, exemplary bracket member 180 includes first and second plate members 182 and 184 that are linked via an elbow member 183. Here, referring also to FIG. 50, plate 182 can be mounted to an underside of sub-structure member 130 with elbow member 183 wrapping around the bottom skirt portion of sub-structure 130 and plate member 184 facing upward along the edge of sub-structure 130. The undersurface of tabletop member 172 is mounted to plate member 184 at one end and leg member 174 and foot member 176 support the opposite end of tabletop member 172. Thus, configuration 110d provides a convenient assembly for hosting a small meeting or to serve as a work station for one person.

Referring now to FIG. 49, yet another exemplary furniture assembly 110e is illustrated that includes the assembly 110b shown in FIG. 46 as well as a table assembly 170 and a lower table assembly 190. Table assembly 170 includes components similar to those described above with respect to FIG. 48 including a top member 172, a leg member 174 and a foot member 176. Not shown is a leg or support structure that supports the end of top member 172 opposite leg member 174. Lower table assembly 190 includes a top member 192, a frame type leg structure 192 similar to the leg structures 122 and 124 described above and a bracket 193. Bracket 193 mounts one end of top member 192 to shelf member 125 while leg structure 192 supports the opposite end of top member 190.

Referring now to FIG. 3, yet another assembly 110f is shown that includes a table/counter assembly 112, an add on assembly 170, a lower table assembly 190, a cabinet unit 114 and a full-depth shelf unit 156 (see also FIG. 44). Here, the full depth shelf unit 156 has a width dimension W2 that is identical to the width W2 of tile member 116b described above, has a length dimension equal to its width dimension W2 and has a height dimension H2 equal to the height dimensions of units 114 and 118 described above. Table assembly 170 in addition to including top member 172, leg member 174 and foot member 176, also includes a privacy panel/leg member 162 at the end of top member 172 opposite leg member 174 for holding the opposite end of top member 172 in a raised position.

Referring now to FIG. 50, yet one more furniture assembly 110g is illustrated that is designed to provide two separate work stations in a back to back relationship. To this end, assembly 110g includes first and second table/counter assemblies 112a and 112b, first and second table assemblies 170a and 170b, a lower table assembly 190, first and second cabinet units 114a and 114b and first and second full depth shelf units 156a and 156b, respectively. Here, table/counter assemblies 112a and 112b are arranged in an end to end fashion with table assemblies 170a and 170b arranged at opposite ends of the combined assemblies 112a and 112b. Here, table assemblies 170a and 170b are akin to assembly 170 in FIG. 3 described above and provide separate primary workstation work surfaces. Lower table assembly 190 is mounted to a shelf member (not labeled) that forms part of table/counter assembly 112a and is generally arranged between primary work station table assemblies 170a and 170b. Unit 114a is positioned at one end of the sub-structure member 130a that comprises part of assembly 112a adjacent table/counter assembly 112b. Shelf unit 156a is positioned on sub-structure member 130a adjacent cabinet unit 114a. Two tiles (not labeled) are provided on sub-structure member 130a to cover the remaining portion of the support surface thereof. Similarly, cabinet unit 114b is positioned at the end of sub-structure 130b adjacent table/counter assembly 112a, shelf unit 156b is positioned on sub-structure member 130b adjacent unit 114b and two tiles (not labeled) are used to cover the remaining portion of the support surface of sub-structure 130b.

Referring to FIG. 51, one more assembly configuration 110h is illustrated that includes table/counter assemblies 112a and 112b, table assemblies 170a and 170b, cabinet unit 114 and first and second half depth shelf units 118 and 120, respectively. Here, table/counter assemblies 112a and 112b are arranged end to end. Four tile members 116a, 116b, 116c and 116D are arranged within the sub-structure member 130a of assembly 112a. Cabinet unit 114, shelf units 118 and 120 and fifth and sixth tile member 116e and 116f are arranged within the receiving space formed by sub-structure member 130b of assembly 112b. One end of table assembly 170a is mounted via a bracket (not labeled) to the undersurface of sub-structure 130a. Similarly, one end of table assembly 170b is mounted via bracket (not labeled) to the undersurface of sub-structure member 130b. Assembly 10h may be useful as a dual workstation configuration.

Referring now to FIG. 52, two different leg members 122a and 122b are illustrated that have different height dimensions. Hence, depending on the desired height of sub-structure 130 described above, different leg member pairs can be selected. For sub-structure 130 height at a height approximately at a work surface height (see FIG. 52), a leg member pair including legs 122a may be employed. For a sub-structure 130 height at a counter height (see FIG. 52), a leg member pair including legs 122b may be employed. Here, two differently dimensioned privacy panels are also contemplated.

Referring to FIGS. 53 and 54, another furniture assembly 310 is illustrated that includes a table/workstation assembly 312, a cabinet unit 314, a full depth shelf unit 356 and six tile members 316a through 316f. Assembly 312 includes leg members or support structure 322 and 324 and a sub-structure 330. Sub-structure 330 includes a plate member 347 that forms a receiving space 349 and a circumferential lip along lateral edges. Sub-structure 330 also forms downwardly extending skirt members 355 (only one illustrated) along end edges. Tile members 316a-316f and units 314 and 356 are similar to those described above. Here, support surface 349 has a width dimension W3 that is twice the width dimension W2 of each of the tiles and units and a length dimension L3 that is four times dimension W2. Here, referring also to FIG. 55, to secure leg members 322 and 324 to sub-structure 330, leg members 322 and 324 are aligned with the ends of sub-structure 330 with top edges of the leg members flush with top edges of lip member 351 and so that skirt member 355 abuts adjacent surfaces of the leg members. Screws 359 pass through holes in the skirt members 355 to secure the leg members to the sub-structure 330. Referring to FIG. 55, a portion of leg member 322 at the top end thereof forms a receiving space defining surface 361 that operates as an end lip member to restrict movement of components on surface 359 to locations within receiving space 349.

Referring again to FIG. 53, tiles 316a-316f and units 314 and 356 cover the entire support surface 349 after installation. For a more finished look, tile members 316a-316d may be replaced by a single long tile member (not illustrated).

Referring to FIGS. 56 and 57, one other furniture assembly 350 is illustrated that includes a table assembly 352, units 354 and 358 and tile members 376a and 376b. Units 354 and 358, the tile members and leg members 322 and 324 are similar to the units, tiles and leg members described above. Sub-structure 280, however, is different. Sub-structure 380 includes a reclinear rigid member having a length dimension L4 that is a multiple of the tile and unit width dimension W2 and a width dimension W4 that is approximately twice the width dimension W2. Here, sub-structure 380 includes a work surface 382 along a first lateral edge and a receiving channel 284 along a second lateral edge. Work surface 382 takes up approximately the front half of sub-structure 380 and channel 384 occupies the rear half. Channel 384 has a width dimension W5 (see FIG. 57) substantially equal to width dimension W2. Thus, units 354 and 356 and tiles 376a and 376b or other unit/tile combinations are receivable within channel 384 to meet user needs. Here, work surface 382 is permanent and components within channel 384 can be easily reconfigured.

2. Work Surface Substrate

Referring again to FIG. 38, the substrate or spine member 130, in at least some embodiments, may be replaced by a channel forming substrate 450 (see FIGS. 15, 61, 62A, etc.) where the formed channel 462 can be used to run power/data/communication cables, to house power/communication receptacles, etc. To this end, an exemplary work surface substrate 450 is a single, integral and elongated sub-structure member that has length and width dimensions that are similar to the length L1 (see again FIG. 40) and width W1 (see again FIG. 39) dimension described above with respect to spine member 130.

In at least some embodiments substrate 450 is formed by bending a single flat piece of component of sheet metal into the form shown to form first and second lateral support members 451 and 453 on opposite sides of the elongated wire management channel 468 where channel 468 extends substantially along the entire length of substrate 450 and includes first and second channel edges (near 470 and 471 in FIG. 62A). The support members 451 and 453 form first and second top support surfaces (also referred to herein via numerals 451 and 453) for supporting furniture components placed thereon. As shown, in at least some embodiments the support surfaces 451 and 453 are substantially coplanar.

Referring again to FIG. 62A, the substrate 450 is also bent along lateral edges to form lip members 485 and 487 that are generally parallel to the first and second channel edges and that extend from surface 451 and 453 and that are perpendicular to surfaces 451 and 453. Skirt members 489 and 491 (see again FIG. 62A) extend down from the lip members 485 and 487 to provide a finished appearance as well as to increase the structural rigidity of the substrate 450. In the illustrated embodiment, support members 451 and 453 are substantially rectilinear. In at least some embodiments each support member 451 and 453 forms shallow lateral channels (see exemplary shallow channels 493 and 495 in FIGS. 67 and 69a) that extend along the length of member 450 and substantially parallel to lip members 485 and 487. Channels 493 and 495 further increase substrate rigidity and also provide channels in which portions of fasteners may be located for fastening components below the substrate so that the fasteners remain below the space in which tiles or furniture units reside after installation (see FIGS. 62C-62D described below).

Referring to FIG. 61, substrate 450 includes oppositely facing and parallel first and second end edges 490 and 492 that traverse the distance between the lateral edges (i.e., between the lip members 485 and 487 in FIG. 62A). First and second tabs 494 and 496 (see FIG. 15) extend in a direction opposite the extending direction of the lip members 485 and 487. Tabs 494 and 496 are provided for mounting to the leg support structures (see 122 and 124 in FIG. 38) and also increase rigidity of substrate 450 as a whole.

In at least some embodiments tabs 494 and 496 may include smaller tab members (not illustrated) that extend from distal ends of the support members 451, 453 and separate mounting plates 494 and 496 that fasten to the smaller tab members. Here, the plates 494 and 496 would then mount to leg structures.

Referring again to FIGS. 15, 61 and 62A, substrate 450 forms a plurality of openings 480 in channel 460 for mounting power/data/communication receptacles 476 that can be accessed from outside the channel. In the illustrated embodiment the openings are formed in a bottom wall 468 of the channel. In other embodiments the openings may be formed in side channel walls 482 and 484.

Referring again to FIGS. 38, 61 and 62A, substrate 450 can simply replace member 130 in the illustrated configuration where lip members 485 and 487 can cooperate with top edges of leg structures 122 and 124 to form receiving spaces/recesses for receiving furniture components. Thereafter furniture components including any assortment of tiles 116a, 116b, shelf units 118 and sliding cabinets 121 may be supported on the support surfaces 451 and 453 and retained therein via the lip members and top edges of leg support structures 122 and 124.

3. Receptacle Clip

Referring now to FIGS. 58 and 20A-20C, an exemplary clip member 410 that is consistent with at least some aspects of the present invention includes a shoulder member 412, first and second arm members 414, 416, respectively, and first and second couplers or finger members 418 and 420, respectively. Shoulder member 412 is an elongated rigid member having first and second oppositely extending ends 421 and 423, respectively. In at least some embodiments, as illustrated, member 412 is slightly concave having a bearing surface 422 that bows slightly outward and another surface 424 that is slightly concave and facing generally in the direction opposite the direction in which bearing surface 422 faces. In at least some embodiments a reinforcing rib member 426 is formed on surface 424 and generally extends along the length thereof between first and second ends 421 and 423, respectively.

Referring still to FIGS. 58 and 20A-20C, arm member 416 is integrally formed with shoulder member 412 and extends substantially perpendicularly therefrom to a distal end 436. Arm member 416 includes an outer surface 432 that faces in a direction opposite the direction from which shoulder member 412 extends from arm member 16. Approximately two-thirds of the way along arm member 416 moving from second end 423 of shoulder member 412 to distal end 436, surface 432 forms first and second notches 428 and 430, respectively, along opposite edges thereof. Notches 428 and 430 are provided to aid a person when an installed clip member 410 is to be removed via a regular head screw driver or the like as described in more detail below.

Finger member 420 extends from distal end 436 of arm member 416 to a distal finger member end 440 and extends in a direction generally opposite the direction in which shoulder member 412 extends from arm member 416. More specifically, finger member 420 and arm member 416 form an obtuse angle β. Angle β, in at least some embodiments, is between 95° and 140°.

Referring still to FIGS. 58 and 20A-20C, arm member 414 extends from first end 421 of shoulder member 412 and generally in the same direction as arm member 416 and terminates at distal end 434. Arm member 414 forms notches 37 and 39 (see FIG. 20C) akin to notches 428 and 430 in arm member 416 (see again FIGS. 58 and 20C). Finger member 418 extends at an obtuse angle like angle β in FIG. 20A from distal end 434 of arm member 414 and terminates at a distal finger member end 442. Outer surface 432 of arm member 416 and similar outer surface 433 of arm member 414 form a width dimension W1.

Clip member 410, in at least some embodiments, is formed of molded plastic. Shoulder member 412 is relatively rigid and rib 426 helps member 412 maintain its shape. Arm members 414 and 416 are resilient and slightly flexible toward each other so that distal ends 434 and 436 can flex slightly inward toward each other when force is applied thereto. When arm members 414 and 416 are released, arm members 414 and 416 spring back toward their unloaded positions. Arm members 414 and 416 are relatively rigid along their length dimensions and finger members 418 and 420 are rigidly connected to arm members 414 and 416 so angles β are generally maintained.

Referring now to FIG. 59, first and second clip members 410a and 410b that are akin to clip member 410 described above with respect to FIGS. 58 and 20A-20C are shown in an installed position where the clip members 410a and 410b retain a power/data module 476 within channel 460 formed by a panel or support structure 450. Referring also to FIGS. 38, 61 and 62A, panel or support structure 450 includes first and second lateral wall members 451 and 453, respectively, and, first, second, and third channel wall members 462, 464, and 466, respectively, that, as the label implies, form channel 460. As best seen in FIG. 62A, first and second lateral wall members 451 and 453, respectively, are co-planar, define a first plane P1 and are disposed on opposite sides of channel 460.

First channel wall member 462 is a flat, rigid and elongated member that is substantially parallel to lateral wall members 451 and 453 but that is located within a different plane space apart from plane P1. Second channel wall member 464 is substantially perpendicular to first channel wall member 462 and extends from a first edge of first wall member 462 to an edge of lateral wall member 451. Similarly, third channel wall member 466 is substantially perpendicular to first wall member 462 and extends from a second edge thereof up to second lateral wall member 453. First channel wall member 462 forms a first channel wall surface 468. Similarly, second and third channel wall members 464 and 466 form second and third channel wall surfaces 482 and 484, respectively, where surfaces 482 and 484 face each other and face in opposite directions.

Referring still to FIGS. 61 and 62A and also to FIG. 15, channel wall member 20A forms at least one and, in the illustrated embodiment, two access openings 480 to accommodate receptacles 477 that extend from power/data module 476. Additional access openings 480 may also be provided (see FIG. 15) within wall 462 to accommodate one or more additional power/data modules 476 (not illustrated). In the illustrated embodiment openings 480 are rectangular however, in other embodiments, other opening shapes are contemplated.

Referring yet again to FIGS. 60 and 62A, at an edge of second channel wall member 464 opposite first channel wall member 462, second channel wall member 464 forms first and second coupling holes 470 and 472, respectively. Similarly, at an edge of third channel wall member 466 opposite first channel wall member 462, third channel wall member 466 forms first and second coupler holes 471 and 473, respectively. As seen in FIG. 62A, holes 470 and 471 are formed at locations that are aligned along the length of channel 460. Similarly, as best seen in FIG. 60, openings 472 and 473 are aligned with each other on opposite sides of channel 460. Channel 460 has a width dimension W2 that is substantially identically to width dimension W1 formed by clip 410 (see also FIG. 62A).

Referring now to FIGS. 60 and 62A, power/data module 476 includes a module housing also referred to by numeral 476, a first module surface 475, a power/data receptacle 477 formed in the first module surface 475 and a module bearing surface 481 that faces in a direction opposite the first module surface 475. In the illustrated embodiment, although only one receptacle 477 is shown, it should be appreciated that module 476 includes two receptacles 477 to be separately received within the access openings shown in FIG. 61.

Referring now to FIG. 62D, channel 60 has a depth dimension D1 which is selected such that, when receptacles 477 are received within access openings 480 with first module surface 475 bearing against first channel wall surface 468, clip 410a can be coupled within channel 460 with distal finger member ends 440 and 42 received within coupling openings 470 and 471, respectively, and bearing surface 422 bearing against module bearing surface 479. As shown in FIG. 62D, when module 476 and clip 410a are installed, the entire module 476 and clip 410a are located within channel 460 and no part of clip 410a extends past first plane P1 formed by the planar surfaces of first and second lateral wall members 451 and 453.

Referring now to FIGS. 60 and 62A, to install a power/data module 476 using two of the exemplary clips 410a and 410b described above, module 476 is positioned with receptacles 477 aligned with access openings 480 and is then moved into channel 460 until the receptacles 477 extend through access openings 480 and first module surface 475 abuts first channel wall surface 468 (see also FIG. 62B). Next, bracket 10a is placed above channel 460 and distal ends 440 and 442 are pressed inward toward each other. Clip 410a is pushed down into channel 60 until bearing surface 422 abuts or bears against module bearing surface 479 (see FIG. 62C). Once bearing surface 422 bears against surface 479, the distal ends 440 and 42 of the clip finger members are aligned with coupling openings 470 and 471. When the distal ends of the finger members are released, the arm members of clip 410a spring back to their normal positions and thereby force distal finger member ends 440 and 442 into openings 471 and 470, respectively, thereby effectively locking clip 410a and module 476 into channel 460. Clip 410b is installed within channel 460 in a similar fashion. Tile members 452 are placed on the top surfaces of lateral wall members 451 and 453 after modules 476 and associated clips 410a and 410b have been installed.

Referring still to FIG. 62D, because arm members 414 and 416 are only slightly flexible toward each other and are relatively rigid along their lengths, module 476 is firmly held in position against surface 468 and, even when force is applied upward to receptacles 477 as depicted in FIG. 62D, module movement within channel 460 should be minimal.

Referring still to FIG. 62D and also to FIG. 58, to remove an installed clip member 410, 410a, the head end of a regular head screw driver can be slid into notch 428 adjacent wall member 466 and can be forced outward away from wall 66 thereby removing end 440 from opening 471. Similarly, a screw driver can be used to remove end 42 from opening 470 after which clip 410a can be slid up and out of channel 460.

Referring now to FIG. 63, a cross-sectional view similar to the view shown in FIG. 62D is provided. Albeit showing a support structure panel 550 including a channel through 460 that forms a different coupling hole configuration and a second embodiment of a clip member 510. In FIG. 63, power/data module 476 is similar to the module described above and therefore will not be described here in detail. Here, it should suffice to say that module 746 includes a housing also identified by numeral 476, a first module surface 475 and one or more receptacles 477 that are formed within surface 475 as well as a module bearing surface 479. Support structure 550 includes first and second lateral wall members 551 and 553 and first, second and third channel wall members 562, 564 and 566, respectively. Where first channel wall member 562 includes a first channel wall surface 568 and third channel wall member 166 forms first and second coupling holes or openings 570 and 571. Opening 570 is formed at an edge of third wall member 566 opposite wall member 562. Second coupling opening 571 is formed approximately midway between wall member 562 and opening 570.

Referring still to FIG. 63, second clip member 510 includes a shoulder member 512, first and second arm members 514 and 516, and first and second finger members 518 and 520. Shoulder member 512 forms a clip bearing surface 522. Arm member 514 extends at an acute angle from shoulder member 512 while second arm member 516 is coplanar with shoulder member 512 and extends generally in the same direction as arm member 514. Finger members 518 and 520 are disposed at distal ends of arm members 514 and 516, respectively, and, are dimensioned and shaped to be receivable within openings 570 and 571, respectively.

Referring yet again to FIG. 63, with module 76 disposed within channel 160 with receptacles 477 extending from the access openings, clip member 510 can be installed with finger members 518 and 520 received within openings 570 and 571 and bearing surface 512 bearing against module bearing surface 479 to thereby retain module 476 within channel 560.

Referring now to FIG. 64, a third exemplary clip and channel assembly 650, 610 and 476 is illustrated that is consistent with at least some aspects of the present invention. In FIG. 64, module 476 is similar to the modules described above and therefore will not be described again here in detail.

Referring now to FIG. 62D and FIG. 64, there are two primary differences between the configuration shown in FIG. 64 and the configuration shown in FIG. 62D. First, coupling hole or opening 470 in FIG. 62B has been moved downward so that it is about midway between a first channel wall member 662 and an edge of second channel wall member 664 opposite first wall member 662. Second, clip member 610 does not include an arm member 414 and instead a finger member 620 extends generally from a first end of a clip shoulder member 612. Clip 610 includes arm member 616 at the end opposite finger member 620 and a finger member 618 at the distal end of arm member 616. Here, finger members 620 and 618 are received in coupling openings 670 and 671 with a bearing surface 622 of shoulder member 612 bearing against module 476 to retain module 476 within a channel 660 and receptacles 477 aligned with access openings 280.

Referring again to FIGS. 62C and 62D, in at least some embodiments, substrate 450 forms one or two channels 493, 495 along its length on each side of the deep channel 460 that, in addition to increasing rigidity of the substrate 450, also provide a space for locating portions of fasteners used to fasten accessories below the substrate structure. For instance, as shown in FIGS. 62C and 62D, bolts 457 and nuts 455 may be used to mount an elongated light 451 (shown in end view) to an undersurface of substrate 450 where distal bolt ends extend through holes 453 in channels 493 and 495 and the nuts 455 are received on the distal ends and are located in channels 493 and 495. Channels 493 and 495 should be deep enough so that no part of the bolt or nut extends past plane P1, so that tiles or furniture units receive on top of substrate 450 are unobstructed by the nut and bolt. Other accessories may mount to the substrate undersurface in a similar fashion (e.g., see bracket 1200 in FIG. 83).

4. Combined Cable Grommet and Panel Clip Assembly

Referring now to FIGS. 16A through 16C, an exemplary embodiment of a cable grommet and panel clip assembly 738 that is consistent with at least some aspects of the present invention is illustrated. Grommet member 738 includes a circumferential neck or bushing member 750, first and second rim, shoulder or bezel members 779a and 779b, first and second deformable tabs, head members or ramp members 778a and 778b and a retainer that includes first and second central grommet dividing/retaining members also referred to herein as arm members 775a and 775b.

Bushing or neck member 750 includes interior and exterior surfaces 752 and 754, respectively, and, first and second oppositely facing edges 751 and 753, respectively, at first and second ends, that reside in substantially parallel planes. Interior surface 752 forms an opening 756 for passing cables. In the illustrated embodiment opening 756 is generally square or rectangular having first and second oppositely facing and parallel internal end surfaces 758 and 760, respectively, and first and second oppositely facing and parallel internal side surfaces 759 and 761, respectively, with four rounded corners.

Referring still to FIGS. 16A through 16C, as well as FIG. 69, dividing retaining arm member 775a is integrally formed with bushing member 750 and extends substantially parallel to side surface 759 and between first and second end surfaces 758 and 760. Similarly, dividing retaining arm member 775b is integrally formed with bushing member 750 and extends substantially parallel to side surface 761 and between first and second end surfaces 758 and 760. Member 775a is spaced apart from surfaces 759 and 761 but is closer to surface 759 than to surface 761. Similarly, member 775b is spaced apart from surfaces 759 and 760 but is closer to surface 761 than to surface 759. Members 775a and 775b together divide space 756 into three separate spaces including a first cable passing space 762, a second cable passing space 764 and an intermediate retaining space 766. Space 766 has a width dimension W1. In the illustrated embodiment each of the first and second cable passing spaces 762 and 764 is essentially D-shaped because of the rounded corners of opening 756 generally and spaces 762 and 764 are similarly shaped and dimensioned.

As best seen in FIG. 16C and FIG. 69, arm members 775a and 775b extend past a plane P1 formed by second edge 753 and to one side of bushing member 750 to distal ends 737a and 737b. In at least some embodiments arm members 775a and 775b extend between one half an inch and two inches past the planar second edge 753 to distal ends 737a and 737b. In some embodiments the arm members 775a and 775b extend one-half to two inches past a lower surface 812 of a member to which grommet 738 is mounted (see FIG. 69 in this regard).

Referring once again to FIGS. 16A through 16C, ramp members 778a and 778b are formed on the external surface 754 of bushing member 750 opposite first and second interior side wall surfaces 759 and 761, respectively. Each ramp member 778a and 778b has a similar construction and operates in a similar fashion and therefore, in the interest of simplifying this explanation, only member 778a is described in detail. As the label implies, ramp member 778a is ramp shaped and forms a ramp surface 768a that extends from external surface 754 where surface 768a is close to (e.g., blends into) surface 754 adjacent first bushing edge 751 and extends away from surface 754 to a greater degree along the length of surface 768a moving from edge 751 toward second edge 753. Ramp member 778a stops short of second edge 753 as best seen in FIG. 16C and FIG. 69. Member 778a is resiliently deformable in the embodiment illustrated in FIGS. 72a through 72c and forms a head bearing surface 769a (see FIG. 69) disposed between ramp surface 768 and second edge 753. Ramp member 778b forms a ramp surface 768b and a head or ramp bearing surface 769b akin to surfaces 768a and 769b, respectively.

Referring once again to FIGS. 16A through 16C, and FIG. 17A bezel or shoulder member 779a extends laterally from the second edge 753 of the bushing member 750 substantially perpendicular to external surface 754 and from the portions of external surface 754 opposite internal surface 759 and opposite internal end surfaces 758 and 760 that are to the same side of first arm member 775a as surface 759. Similarly, bezel member 779b extends laterally from bushing member second edge 753 substantially perpendicular to external surface 754 and from the portions of external surface 754 opposite internal surface 761 and opposite internal end surfaces 758 and 760 that are to the same side of second arm member 775b as surface 761. Bezel members 779a and 779b each form a shoulder or bezel bearing surface 771a and 771b, respectively, that faces in a direction opposite the direction in which head bearing surface 768 faces. Referring also to FIG. 69, bearing surfaces 771a and 771b are spaced apart from adjacent portions of ramp members 778a and 778b by a thickness dimension T1.

Grommet 777 may be formed of several different material types but, in a particularly advantageous embodiment, will be formed of a molded plastic material where all of the components described above are integrally formed.

Referring now to FIGS. 65 and 66, the grommet described above with respect to FIGS. 16A through 16C and FIG. 17A will be described in the context of an exemplary space dividing table or counter assembly 710. Assembly 710 includes first and second frame member 712 and 713, a privacy panel 715, a spine sub-structure or member 714, a finishing bar 19, and counter infill components that can take various forms such as thin panels or tiles collectively identified by numeral 718. In addition, in FIGS. 73 and 76, the assembly 710 is shown including first and second shelf members 742a and 742b, respectively. Each frame member 712 and 713 is similarly constructed and operates in a similar fashion and therefore, in order to simplify this explanation, only member 712 will be described in any detail. Member 712 includes extruded rigid top and bottom members and extruded rigid first and second lateral members that are secured at their ends to form a rectilinear frame member that includes, among other surfaces, an interior surface 717 (see FIG. 65).

Referring to FIGS. 65 and 66 and also to FIG. 70, privacy panel 715 is a flat and substantially planar, rigid and rectilinear member that includes first and second oppositely facing side surfaces 788 and 789, top a bottom edges 790 and 792, respectively, and first and second lateral edges 794 and 796, respectively.

Finishing bar 719 is an extruded member similar to the members that are used to form frame members 712 and 713 and forms a slot (not illustrated) along a top surface for receiving the bottom edge 792 of panel 715 upon assembly. Opposite ends of bar 19 include screw receiving openings for mounting to frame members 712 and 713.

Referring to FIG. 66 and also to FIG. 67, spine member 714 includes a sub-structure formed from a single piece of sheet metal (e.g., steel) that is bent into the illustrated shape. To this end, member 714 has length and width dimensions L1 and W2 where the length dimension L1 is substantially similar to the length of top edge 790 of panel 715 and the width dimension W2 is similar to the width dimension of the tile members 718 that are receivable on top thereof as shown in FIG. 66. Member 714 forms mounting tabs 800 and 802 (Or the tabs may be separate components) at opposite ends of length dimension L1 usable to mount member 714 to first and second frame members 712 and 713, respectively, via screws (see again FIG. 66). Importantly, for the purposes of the present invention, member 714 forms a central channel 806 approximately midway along width dimension W2 that extends the entire length L1 of member 714. Channel 806 includes a flat bottom wall member 808 that has interior and exterior or first and second surfaces 810 and 812, respectively. Herein wall member 808 is also referred to as a first panel member.

In the illustrated embodiment first and second grommet openings 729a and 729b are formed in bottom wall member or first panel 808 proximate the first and second tabs 802 and 804, respectively. Here, referring again to FIGS. 721a through 72c, openings 729a and 729b are formed to passing bushing member 750 but have dimensions such that ramp members 778a and 778b have to be resiliently deformed to pass through. Bottom wall member 808 has a thickness dimension that is similar to thickness T1 (see also FIG. 69) between ramp member 778a and bearing surface 771a.

Tiles 718 are simply square tiles that have width dimensions that are similar to width W2 and that have a combined length dimension that is similar to length L1 so that when the tiles 718 are received on top of substrate 714, the tiles substantially conceal channel 806 and other parts of the top surface of member 714.

To assemble assembly 710, referring to FIGS. 16A through 16C and also to FIGS. 65, 67 and 69, first and second grommets 738a and 738b, like grommet 738 described above, are aligned with openings 729a and 729b so that first edges 751 of each grommet are adjacent the bottom surface 810. Grommet 738a is forced into opening 729a until the edge of bottom wall member 808 adjacent opening 729a is received within the gaps (e.g., T1) between the bearing surfaces 768a and 768b and bearing surfaces 771a and 771b (i.e., so that bearing surfaces 771a and 771b bear against the bottom surface 812 of bottom wall 808). Similarly, grommet 738b is forced into opening 729b until the edge of bottom wall member 808 adjacent opening 729b is received within bearing surface gaps. At this point grommets 738a and 738b are secured to sub-structure 714.

Referring still to FIG. 68, bar 719 is mounted to members 712 and 713 with the lengthwise slot formed thereby facing upward. Bottom edge 792 of panel 715 is received in the upwardly facing slot formed by member 719. The subassembly including substrate 714 and grommets 738a and 738b is next positioned above the subassembly including frame members 712 and 713 and bar 719 and is positioned so that the intermediate retaining spaces 766 (see again FIGS. 16A through 16C) formed by grommets 738a and 738b are aligned with top edge 790 of panel 715. Substrate 714 is lowered until edge 790 is received within spaces 66 at which point screws are used to secure tabs 802 and 804 to frame members 712 and 713. Shelves 742a and 742b may be mounted as shown after the above assembly processes are completed. In addition, power and/or data receptacles 784 (see 784 in FIG. 66) may be mounted via clips 824 or the like in channel 806.

Once installed, grommets 738a and 738b operate to retain the top edge 790 of panel 715. In addition, bezel members 779a and 779b prevent the grommets from being pushed completely through holes 729a or 729b and provides a finished look on the bottom surface of wall 808. Cables can be strung into channel 806 through open ends thereof (see FIG. 67) and to power and data outlets (see exemplary outlet 784 in FIG. 19). Power and data cables may also be run into channel 806 through one or both of grommets 738a and 738b. Where cables are run up through a grommet, openings may be provided within shelf members there below (see 816 in FIG. 65) that are aligned with the grommet openings to allow passage of cables through the shelf members.

In at least some embodiments the grommets may be used with vertical cable plenums 830 (see FIGS. 66 and 68) for stringing cables from a floor level up to the channel 806. In the illustrated embodiment the vertical plenum includes a cover that is U-shaped in cross section and that includes a top edge 828 where the cross section of the plenum is sized and shaped to mirror the D-shape of one of the cable passing openings (see 764 in FIG. 16A) so that the top of the plenum is frictionally receivable within the opening 64 to secure the top of the plenum to the grommet. See also FIG. 70 that shows another grommet embodiment that includes a rib member 826 formed on the internal surface 752 of bushing member 750 where, when the top of the plenum is received within opening 764, the top edge 828 thereof abuts the rib 826 so that the plenum can only be pushed up into the grommet to an optimal position.

Referring to FIG. 69, it should be appreciated at this point that, after grommet 738 has been installed, grommet 738 serves the dual purpose of facilitating cable passage into/out of channel 806 and retaining an edge of second panel 715. It should also be appreciated that single grommet 738 operates like two separate grommets to enable cables to be strung into channel 806 from either side of second panel 715 (i.e., cables may pass through either of openings 762 or 764 into the channel 806) (see FIG. 69). Moreover, grommet 738 is installed without requiring use of tools.

Referring now to FIG. 71, a cross-sectional view of another grommet is shown where the grommet 938 includes only a single cable passing opening 964 and a retainer including arm members 975a and 975b disposed to one side of the opening 964. Here, grommet 938 still includes ramp or head members 978a and 978b as well as shoulder members 979a and 979b and first and second edges 951 and 953. In this case cables can only be routed into the channel above bottom wall member 808 on one side through opening 964. One other difference shown in FIG. 71 is that ramp or head members 978a and 978b are shown as including portions spaced from an exterior surface 954 of bushing 950 to clearly indicate flexibility.

Referring to FIG. 72, a cross-sectional view of yet another grommet 1038 is shown. Grommet 1038 includes a bushing 1050 having first and second oppositely facing edges 1051 and 1053, respectively, and exterior and interior surfaces 1054 and 1052, respectively. Grommet 1038 also includes a shoulder member 1079a, 1079b, that extends laterally from second edge 1053. Shoulder member 1079a, 1079b forms holes for passing mounting screws.

Referring still to FIG. 72, grommet 1038 includes a single retainer arm member 1075 that divides the grommet opening formed by interior surface 1052 into first and second cable passing openings 1062 and 1064. Arm 1075 extends past the plane defined by second bushing edge 1053 and forms screw passing holes. Screws 1081 are used to mount grommet 1038 to panel or wall member 808. Screws 1083 are also used to mount second panel 715 to the distal end of arm member 1075. Here while tools are needed to mount the assembly components, the grommet still serves the dual purpose of cable passing and panel retaining. Moreover, this design still has the advantage that a single grommet can be used to pass cables into a channel form either side of a panel member (see again FIG. 72).

5. Storage Unit With Sliding Door

Referring again to FIG. 2, exemplary storage cabinet 20 will now be described in greater detail. Referring also to FIG. 73, cabinet 20 includes a wall structure 1022 that is open to one side and door members 1030 mounted to tracks for sliding motion to optionally open or close the open side of structure 1022.

Referring more particularly to FIGS. 74, 75 and 76, structure 1022 forms a door frame 1024 in which are mounted a first track 1026 and an opposing second track 1028. Tracks 1026, 1028 can be essentially identical except that they are mounted at different positions on door frame 1024. At least one door 1030 is slidably engaged within upper track 1028 and lower track 1026, where each door 1030 includes a plurality of constraints 1032 connected to at least one edge 1034 of the door 1030. The plurality of constraints are shown in the form of spring clips 1032 fixedly connected to door edge 1034, and more particularly in the embodiment shown, at each corner of each door 1030. Although only one door 1030 is shown in FIG. 74, both doors 1030 of unit 1014 include clips 1032 as shown at each corner.

Referring to FIG. 78A, first track 1026 includes a first channel 1036 and an adjacent second channel 1038. Referring to FIG. 78B, second track 1028 includes a third channel 1040 and an adjacent fourth channel 1042 similar to channels 1036, 1038 in first track 1026. A first door 1030 can be slidingly engaged with first channel 1036 and third channel 1040, and a second door 1030 can be slidingly engaged with second channel 1038 and fourth channel 1042. Each track can include one or more channels and each pair of channels can support one or more doors. It is only necessary to have one pair of channels (upper and lower) and one door.

Referring particularly to FIG. 79, exemplary spring clip 1032 includes a first arm 1044 resiliently connected to a second arm 1046 via a web 1048. The first arm 1044 can be approximately parallel with second arm 1046 when they are in an installed position, although this is not required. In one embodiment, and when spring clip 1032 is manufactured using plastic for example, in a freebody orientation (i.e., prior to installation) first arm 1044 can be at an angle of approximately 70 to second arm 1046 so that when clip 1021 is in an installed position this provides a biasing force on the door within the channel. In other embodiments, and depending on the material used for spring clip 1032 (metal material being able to sustain larger angles for example), the angle between first arm 1044 and second arm 1046 can be approximately from 0° to 60° and, more preferably can be approximately from 0° to 15°. Further, each first arm 1044 includes a key 1050 at a distal end of the first arm 1044, where key 1050 is insertable in a notch 1052 (see FIG. 77) on a corresponding edge 1034 of one of the sliding doors. Each second arm 1046 includes a detent 1056 at a distal end of second arm 1046. Resilient members 1032 bias a corresponding door 1030 within the door track, and more specifically a channel of the door track, and glide with the door, and helps the door also glide within the channel, when the door is moved within the track.

Referring to FIGS. 77-80, door frame 1024 include apertures 1058, and a detent 1056 at least partially projects into an adjacent aperture 1058 when a corresponding door 1030 is in a closed position (see specifically FIG. 76). Second arm 1046 resiliently deflects as a door 1030 is pushed towards the door frame 1024 and clip 1032 contacts an edge of aperture 1058. As ridge 1060 clears the edge of aperture 1058, second arm 1046 resiliently deflects and door 1030 is held in a closed position until sufficient force is applied to open the door, wherein second arm 1046 resiliently deflects to allow ridge 1060 to clear aperture 1058. When the doors slide vertically, such as when a storage bin is used in the vertical position, when ridge 1060 is received in aperture 1058, the door can be maintained in a desired position and will not slide down due to gravity. Spring clips 1032 additionally bias and/or position a corresponding door 1030 within door frame 1024.

Referring to FIGS. 78A and 78B, in another aspect of the present invention, storage unit 1014 includes angled legs 1062 which fits within slots 1064 of tracks 1026, 1028 to hold the tracks to enclosure 1022. The tracks can be pivoted within the door frame to engage the angled legs 1062 within receiving aperture/slots 1064. Consequently, and in concert with doors 1030 and door frame 1024 structure, tracks 1026, 1028 can be held within storage unit 1014 without the need for other fasteners such as screws, nuts and bolts, etc., that often deface the exterior surface of a storage unit.

Other embodiments may include one, three or more doors and/or one, three or more channels within a track. These alternative embodiments can include angled legs 1062, slots 64 and spring clips 1032 as have been already described. When the cabinet is vertically oriented, the doors can be held in up positions using spring clips 1032 within corresponding apertures 1058 of door frame 1024.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, the skirt mounting embodiment where the leg members form part of the receiving space defining lip may be employed in any of the above assemblies. In addition, receiving spaces that have length dimensions that are other multiples of the furniture component width dimensions are contemplated (e.g., twice, three times, five times, etc., the width dimension). In addition, referring to FIG. 38, in at least some embodiments tile members (e.g., 116a) may include one or more finger holes 117 formed along one or more edges to help a user remove a tile member from an installed position. Here, when a tile with a finger hole 117 is installed, the hole can be used to pass a power or data cable from above the tile down into a cable trough therealong if desired.

Moreover, in at least some embodiments, instead of using a large single bracket 180 as shown in FIGS. 21 and 22 to mount a table or work surface member to a spine member 450, two smaller brackets 1200 (see FIG. 51) as shown in FIGS. 80-83 may be employed. Bracket 1200 includes a vertical plate member 1202 that has an upper edge and forms a channel 1220 that extends into the upper edge. Channel 1220 is formed to receive lower lip 489 of substrate 450. First and second mounting plates 1204 and 1206 extend in the same direction from the upper edge of member 1202 and form mounting holes 1212 and 1210, respectively. Holes 1212 are arranged to simultaneously align with mounting holes formed in a substrate channel 1211. member 1206 extends from a portion of plate 1202 that is shorter than the portion from which member 1204 extends to accommodate different thicknesses between a table member 172 and the combined thickness of tile 452 and the spine material. Bolt/nuts 1222, 1224 are used to mount plate 1204 to an undersurface of substrate 450 with lip 489 received in channel 1220 and screws 1230 mounting plate 1206 to an undersurface of table member 172. Once assembled, the top surfaces of table member 172 and tile 452 and the distal end of lip 485 should be substantially flush.

In at least some embodiments spine member 450 will include angled return lip members 1225 that increase member rigidity. Bracket 1200 may include a finger member 1221 that extends from an edge of channel 1220 toward a facing edge of channel 1220. Finger member 1221 may be positioned to reside immediately above return lip 1225 after installation. Here, when substantial weight is applied proximate the joint between members 172 and 450, finger member 1221 contacts lip member 1225 and together members 1221 and 1225 increase structural integrity of the joint. As shown in FIG. 51, in some cases two brackets 1200 are employed to secure a table member to a spine.

As another example the plastic door retaining clip 1032 shown in FIG. 79 may be replaced by a spring steel clip 1032A shown in FIG. 84 that has a similar shape in side perspective view.

To apprise the public of the scope of this invention, the following claims are made:

What is claimed is:

1. A furniture assembly kit comprising:
at least a first support structure having top and bottom ends;
a plurality of furniture components, each component including a base structure having a component width dimension and a component length dimension; and
a sub-structure supported by the support structure and having a substantially flat support surface defined by a circumferential edge including first and second lateral edges and first and second oppositely facing end edges, the sub-structure also forming a lip member along at least a portion of the first lateral edge and at least a portion of the second lateral edge, the lip member having a distal upper edge, the space adjacent the support surface and between the lip members being a furniture receiving space; and
wherein, different subsets of the plurality of components can optionally be positioned with the base structures of the component subsets supported by the support surface and with the base structures of the component subsets substantially covering the sub-structure support surface, each different subset including at least two of the plurality of components where at least one of the furniture components includes a storage unit that defines a storage space where the storage space resides at least in part above the furniture receiving space when the storage unit is supported on the support surface.

2. The assembly of claim 1 wherein the support surface is substantially rectilinear, each of the base structures has a first component width dimension and a first component length dimension, the receiving space has a structure width dimension between the first and second lateral edges and a structure length dimension between the first and second end edges, the structure width dimension being a multiple of the first component width dimension and the structure length dimension being a multiple of the first component length dimension.

3. The assembly of claim 2 wherein the first component width dimension is substantially equal to the first component length dimension.

4. The assembly of claim 3 wherein the structure width dimension is substantially equal to the first component width dimension.

5. The assembly of claim 1 wherein the plurality of components includes at least a subset of counter top tiles, each counter top tile including a top work surface.

6. The assembly of claim 5 wherein each of the storage units includes at least one side wall surface having a storage unit height dimension that is a multiple of the component length dimension and, wherein, each of the storage units is positionable with the side wall surface supported by the support surface and at least one subset of the plurality of components positioned with the base structures of the at least one subset of components simultaneously supported by the support surface so that the support surface is substantially covered.

7. The assembly of claim 6 wherein the first component width dimension is substantially equal to the first component length dimension and wherein the storage unit height dimension is substantially twice the first component width dimension.

8. The assembly of claim 7 wherein the plurality of components further includes at least a first component that includes a first base structure, the first base structure having the first component length dimension and a second component width dimension that is substantially half the first component width dimension, the first component positionable with the first base structure supported by the support surface and at least one subset of the plurality of components positioned with the base structures of the at least one subset of components simultaneously supported by the support surface so that the support surface is substantially covered.

9. The assembly of claim 8 further including at least a second component that includes a second base structure, the second base structure having the first component length dimension and the second component width dimension, the first and second components positionable with the first and second base structures supported by the support surface and another subset of the plurality of components positioned with the base structures of components simultaneously supported by the support surface so that the support surface is substantially covered.

10. The assembly of claim 9 wherein the first and second components each include a rear wall and wherein the first and second components are positionable with the rear walls adjacent each other and traversing the distance between the first and second lateral edges.

11. The assembly of claim 1 wherein the lip members extend from the support surface along a lip length dimension to the distal ends, the lip length dimension between one quarter inch and one inch.

12. The assembly of claim 1 wherein the lip members extend along substantially the entire lengths of the lateral edges of the sub-structure and along the end edges of the sub-structure.

13. The assembly of claim 1 wherein the support structure includes first and second leg members linked to the sub-structure adjacent the first and second end edges, respectively, and, wherein, facing surfaces of the first and second leg members form end boundaries of the receiving space.

14. The assembly of claim 1 further including at least first and second pairs of leg members that have first and second heights, respectively, the support structure optionally including at least one of the first and second pairs of leg members such that the sub-structure member is supported at one of the first and second heights.

15. The assembly of claim 1 wherein the sub-structure forms a channel that is recessed from the support surface and that extends between the first and second end edges.

16. The assembly of claim 15 wherein the sub-structure is formed of bent sheet metal.

17. The assembly of claim 15 wherein the sub-structure forms at least one opening from the channel to a space below the sub-structure for passing cables from the channel to the space below the sub-structure.

18. The assembly of claim 15 wherein the sub-structure forms at least one opening from the channel to a space below the sub-structure and wherein at least one of a power and a data receptacle is mounted in the at least one opening.

19. The assembly of claim 18 wherein the receptacle is accessible from below the sub-structure.

20. The assembly of claim 1 wherein the sub-structure is formed of bent sheet metal.

21. The assembly of claim 1 wherein the first support structure has a first height dimension, the assembly further including at least a second support structure that has a second height dimension that is different than the first height dimension where the sub-structure is supportable by the either of the first and second support structures.

22. A furniture assembly comprising:
a support structure having top and bottom ends;
a sub-structure supported adjacent the top ends of the support structure and having a substantially flat rectilinear support surface defined by a circumferential edge including first and second lateral edges and first and second oppositely facing end edges, the sub-structure also forming a lip member along at least a portion of the first lateral edge and at least a portion of the second lateral edge, the space adjacent the support surface being a furniture receiving space and having a structure width dimension between the first and second lateral edges and a structure length dimension between the first and second end edges; and
a plurality of furniture components, each component including a base structure having a component width dimension and a component length dimension wherein the component width dimension and length dimension are substantially equal and the component width dimension is substantially equal to the structure width dimension, at least a first of the furniture components further including a side wall member that has a component height dimension that is a multiple of the component width dimension;
wherein:
(a) at least a first subset of the plurality of furniture components including the first furniture component is simultaneously positionable with the base structures on and supported by the support surface and so that the base structures substantially cover the support surface; and
(b) at least a second subset of the plurality of furniture components including the first furniture component is simultaneously positionable with the side surface of the first component and other components on and supported by the support surface and so that the side surface and the other components substantially cover the support surface

23. The assembly of claim 22 wherein the first furniture component is a storage unit that opens to one side and is positionable as part of the first plurality of components so that the first component optionally opens to face one of the first lateral edge, the second lateral edge, the first end edge and the second end edge.

24. The assembly of claim 22 wherein the structure length dimension is a multiple of the component length dimension.

25. The assembly of claim 22 wherein at least a subset of the plurality of components includes counter top tiles that form top surfaces, the top tiles having a tile thickness dimension, the lip members having a lip height dimension that is substantially similar to the tile thickness dimension such that when the tiles are placed in the receiving space, the top surfaces of the tiles are substantially flush with distal edges of the lip members.

26. The assembly of claim 22 wherein the sub-structure forms a channel that is recessed from the support surface and that extends between the first and second end edges.

27. The assembly of claim 22 wherein the sub-structure forms at least one opening from the channel to a space below the sub-structure for passing cables from the channel to the space below the sub-structure.

28. The assembly of claim 22 wherein the sub-structure forms at least one opening from the channel to a space below the sub-structure and wherein at least one of a power and a data receptacle is mounted in the at least one opening.

29. The assembly of claim 22 wherein the sub-structure is formed of bent sheet metal.

30. A furniture assembly comprising:
a support structure having top and bottom ends;
a sub-structure supported by the support structure and having a substantially flat rectilinear support surface defined by a circumferential edge including first and second lateral edges and first and second oppositely facing end edges, the sub-structure also forming a lip member along at least a portion of the first lateral edge and at least a portion of the second lateral edge, the space adjacent the support surface being a furniture receiving space and having a structure width dimension between the first and second lateral edges and a structure length dimension between the first and second end edges; and
a first plurality of furniture components, each component in the first plurality including a base structure having a first component width dimension and a first component length dimension, the first component width dimension substantially equal to the first component length dimension and substantially equal to the structure width dimension;
a second plurality of furniture components, each component in the second plurality including a base structure having a second component length dimension substantially equal to the first component length dimension and a second component width dimension that is substantially half the first component width dimension;
wherein, different subsets of the first and second pluralities of components can optionally be positioned with the base structures of the component subsets supported by the support surface and with the base structures of the component subsets substantially covering the sub-structure support surface, each different subset including at least two components.

31. The assembly of claim 30 wherein the structure length dimension is a multiple of the first component length dimension.

32. The assembly of claim 30 wherein the second plurality of components include storage units that open to one side and wherein the storage components are each positionable on the support surface so that the unit opening faces one of a lateral edge and an end edge of the sub-structure.

33. The assembly of claim 30 wherein the lip members extend along the entire lengths of the first and second lateral edges and at least portions of the first and second end edges.

34. A furniture assembly comprising:
first and second leg members, each of the first and second leg members having top and bottom ends and forming at least one side surface;
a sub-structure having a substantially flat support surface defined by a circumferential edge including first and second lateral edges and first and second oppositely facing end edges, the sub-structure forming a lip member along the first lateral edge and the second lateral edge, the space adjacent the support surface and between the lip members being a furniture receiving space; and
wherein, the first end edge of the sub-structure is mounted to the one side surface of the first leg member and the second end edge of the sub-structure is mounted to the one side surface of the second leg member so that the leg members support the sub-structure in an elevated position and so that the facing side surfaces of the first and second leg members form end boundaries of the receiving space.

35. The assembly of claim 34 further including a plurality of furniture components, each component including a base structure having a component width dimension and a component length dimension wherein the component width dimension is substantially similar to a structure width dimension between the lip members and the component length dimensions are multiples of the component width dimension.
